(19) United States
(12) Patent Application Publication
(10) Pub. No.: US 2023/0354331 A1
(43) Pub. Date: Nov. 2, 2023

(54) PDCCH FOR MULTI-CELL SCHEDULING

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 18/301,848

(22) Filed: Apr. 17, 2023

Related U.S. Application Data
(60) Provisional application No. 63/336,857, filed on Apr. 29, 2022.
(60) Provisional application No. 63/394,490, filed on Aug. 2, 2022.
(60) Provisional application No. 63/416,816, filed on Oct. 17, 2022.

(51) Int. Cl. H04W 72/1273; H04W 72/232

(52) U.S. Cl. CPC H04W 72/1273; H04W 72/232

(57) ABSTRACT

Apparatuses and methods for physical downlink control channel (PDCCH) monitoring for multi-cell scheduling. A method includes receiving information for a number of sets of cells and information for a user equipment (UE)-specific search space (USS) set for receptions of PDCCH candidates on a scheduling cell. The USS set has a USS set identity and is associated with a downlink control information (DCI) format for scheduling on more than one cell. The method further includes determining a set of cells, from the number of sets of cells, that is associated with the USS set and a reference cell from the set of cells. A size of the DCI format is counted in a number of sizes of DCI formats for scheduling on the reference cell and is not counted in a number of sizes of DCI formats for scheduling on cells, other than the reference cell, from the set of cells.

### CROSS-REFERENCE TO RELATED APPLICATION AND CLAIM OF PRIORITY

This application claims priority under 35 U.S.C. § 119(e) to U.S. Provisional Patent Application No. 63/336,857 filed on Apr. 29, 2022, U.S. Provisional Patent Application No. 63/394,490 filed on Aug. 2, 2022, and U.S. Provisional Patent Application No. 63/416,816 filed on Oct. 17, 2022. The above-identified provisional patent applications are hereby incorporated by reference in their entirety.

### TECHNICAL FIELD

The present disclosure relates generally to wireless communication systems and, more specifically, to physical downlink control channel (PDCCH) monitoring for multi-cell scheduling.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for PDCCH monitoring for multi-cell scheduling.

In one embodiment, a method includes receiving first information for a number of sets of cells and second information for a first user equipment (UE)-specific search space (USS) set for receptions of first PDCCH candidates on a scheduling cell. The first USS set has a first USS set identity and is associated with a first downlink control information (DCI) format for scheduling on more than one cell. The method further includes determining a first set of cells, from the number of sets of cells, that is associated with the first USS set and a first reference cell from the first set of cells. A first size of the first DCI format is counted in a number of sizes of DCI formats for scheduling on the first reference cell and is not counted in a number of sizes of DCI formats for scheduling on cells, other than the first reference cell, from the first set of cells. The first reference cell is the scheduling cell, when the scheduling cell is included in the first set of cells, and the first USS set is the only USS set with the first USS identity among USS sets on cells in the first set of cells.

In another embodiment, a user equipment (UE) is provided. The UE includes a transceiver configured to receive first information for a number of sets of cells and second information for a first USS set for receptions of first PDCCH candidates on a scheduling cell. The first USS set has a first USS set identity and is associated with a first DCI format for scheduling on more than one cell. The UE further includes a processor operably connected to the transceiver. The processor is configured to determine a first set of cells, from the number of sets of cells, that is associated with the first USS set and a first reference cell from the first set of cells. A first size of the first DCI format is counted in a number of sizes of DCI formats for scheduling on the first reference cell and is not counted in a number of sizes of DCI formats for scheduling on cells, other than the first reference cell, from the first set of cells. The first reference cell is the scheduling cell, when the scheduling cell is included in the first set of cells and the first USS set is the only USS set with the first USS identity among USS sets on cells in the first set of cells.

In yet another embodiment, a base station is provided. The BS includes a transceiver configured to transmit first information for a number of sets of cells and second information for a first USS set for transmissions of first PDCCHs on a scheduling cell. The first USS set has a first USS set identity, and is associated with a first DCI format for scheduling on more than one cell. The BS includes a processor operably connected to the transceiver. The processor configured to determine a first set of cells, from the number of sets of cells, that is associated with the first USS set and a reference cell from the first set of cells. A first size of the first DCI format is counted in a number of sizes of DCI formats for scheduling on the reference cell and is not counted in a number of sizes of DCI formats for scheduling on cells, other than the reference cell, from the first set of cells. The reference cell is the scheduling cell, when the scheduling cell is included in the first set of cells and the first USS set is the only USS set with the first USS identity among USS sets on cells in the first set of cells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates an example transmitter structure using orthogonal frequency-division multiplexing (OFDM) according to embodiments of the present disclosure;

FIG. 7 illustrates an example receiver structure using OFDM according to embodiments of the present disclosure;

FIG. 8 illustrates an example encoding process for a downlink control information (DCI) format according to embodiments of the present disclosure;

FIG. 9 illustrates an example decoding process for a DCI format according to embodiments of the present disclosure;

FIG. 10 illustrates an example method for distinguishing a multi-cell scheduling DCI format from a single-cell scheduling DCI format according to embodiments of the present disclosure;

FIG. 11 illustrates an example method for monitoring PDCCH in a search space set for multi-cell scheduling according to embodiments of the present disclosure;

FIG. 12 illustrates an example method for search space linking for multi-cell scheduling according to embodiments of the present disclosure;

FIG. 13 illustrates an example method for counting PDCCH candidates for multi-cell scheduling operation when a search space set is associated with multi-cell scheduling DCI formats according to embodiments of the present disclosure;

FIG. 14 illustrates an example method for counting PDCCH candidates for multi-cell scheduling operation when a search space set is configured for both single-cell scheduling and multi-cell scheduling DCI formats according to embodiments of the present disclosure;

FIG. 15 illustrates an example method for search space set overbooking and dropping for multi-cell scheduling operation according to embodiments of the present disclosure; and

FIG. 16 illustrates an example method for search space set overbooking and dropping for multi-cell scheduling operation when a search space set is additionally configured with a priority level parameter according to embodiments of the present disclosure.

### DETAILED DESCRIPTION

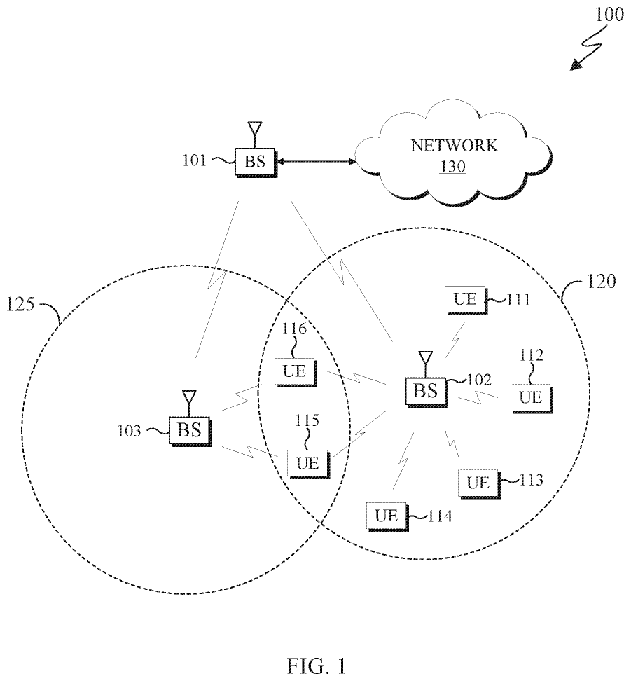

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.2.0, “NR; Physical channels and modulation;” 3GPP TS 38.212 v17.2.0, “E-UTRA, NR, Multiplexing and Channel coding”; 3GPP TS 38.213 v17.2.0; “NR, Physical Layer Procedures for Control”; 3GPP TS 38.214 v17.2.0; “NR, Physical Layer Procedures for Data”; 3GPP TS 38.321 v17.1.0, “NR; Medium Access Control (MAC) protocol specification”; 3GPP TS 38.331 v17.1.0, “NR; Radio Resource Control (RRC) Protocol Specification;” 3GPP TS 38.300 v17.1.0, “NR; NR and NG-RAN Overall Description; Stage 2;” 3GPP TR 38.306 v17.1.0, “NR; User Equipment (UE) radio access capabilities.”

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, other well-known terms may be used instead of “gNodeB” or “gNB,” such as “base station” or “access point.” For the sake of convenience, the terms “gNodeB” and “gNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine). The UE may also be a car, a truck, a van, a drone, or any similar machine or a device in such machines.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115, the UE 116, UE 117 and UE 118. In some embodiments, one or more of the gNBs 101-103 may communicate with each other and with the UEs 111-118 using 5G, long-term evolution (LTE), LTE-A, WiMAX, or other advanced wireless communication techniques. In some embodiments, multiple UEs, e.g., UE 117, UE 118 and UE 119 may communicate directly with each other through device-2-device communication. In some embodiments, a UE, e.g., UE 119, is outside the coverage area of the network, but can communicate with other UEs inside the coverage area of the network, e.g., UE 118, or outside the coverage area of the network.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

As described in more detail below, one or more of the UEs 111-116 include circuitry, programing, or a combination thereof for supporting PDCCH monitoring for multi-cell scheduling. In certain embodiments, one or more of the gNBs 101-103 include circuitry, programing, or a combination thereof for supporting PDCCH monitoring for multi-cell scheduling.

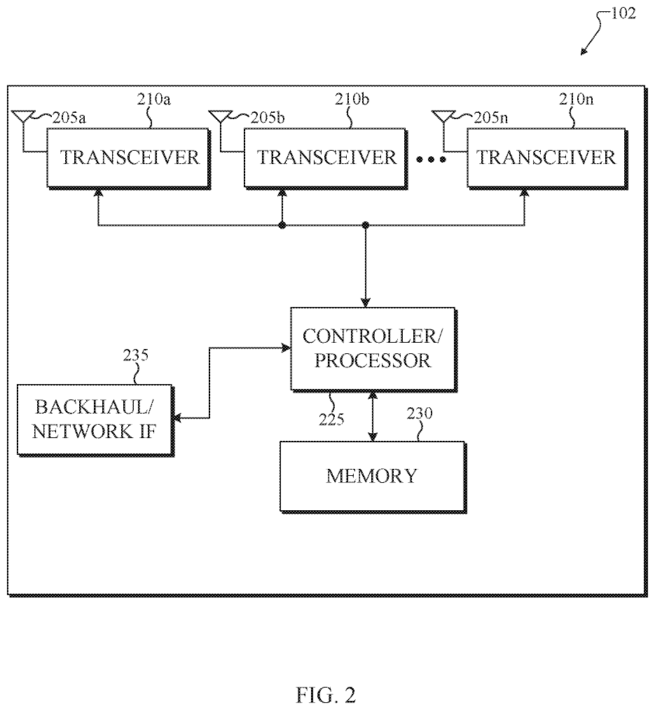

FIG. 2 illustrates an example gNB 102 according to this disclosure. The embodiment of the gNB 102 shown in FIG. 2 is for illustration only, and other gNBs of FIG. 1 can have the same or similar configuration. However, gNBs come in a wide variety of configurations, and FIG. 2 does not limit the scope of this disclosure to any particular implementation of an gNB. It is noted that gNB 101 and gNB 103 can include the same or similar structure as gNB 102.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting PDCCH monitoring for multi-cell scheduling. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

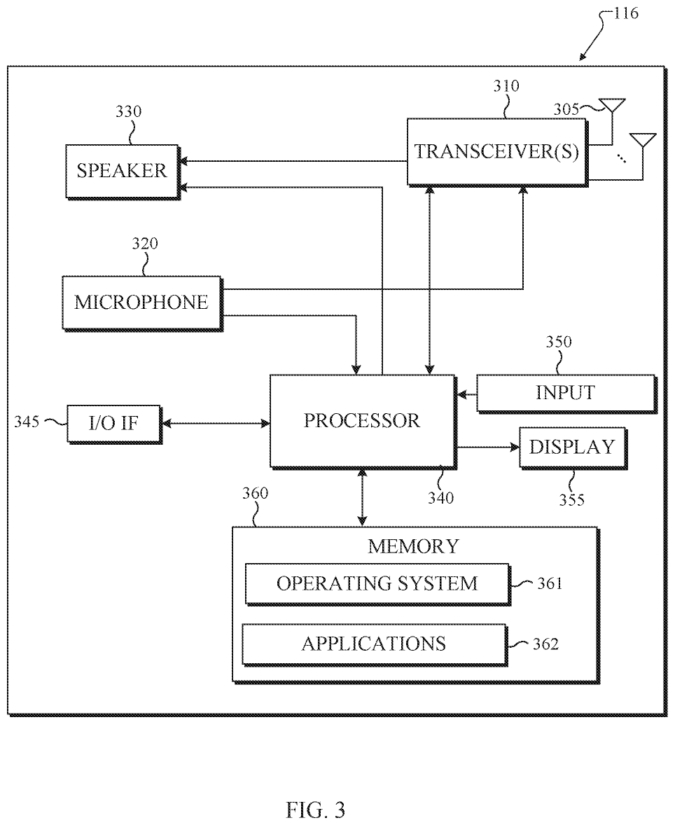

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as process for supporting PDCCH monitoring for multi-cell scheduling. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

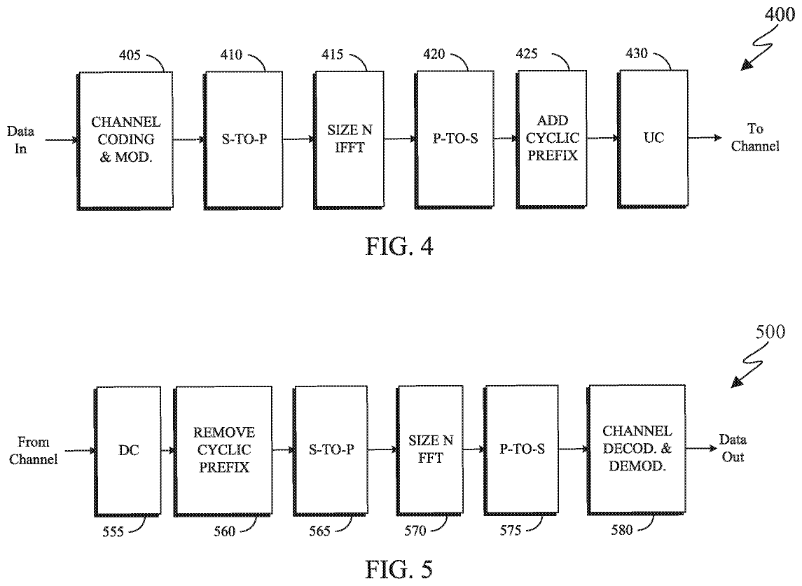

FIG. 4 and FIG. 5 illustrate example wireless transmit and receive paths according to this disclosure. In the following description, a transmit path 400, of FIG. 4, may be described as being implemented in a gNB (such as the gNB 102), while a receive path 500, of FIG. 5, may be described as being implemented in a UE (such as a UE 116). However, it may be understood that the receive path 500 can be implemented in a gNB and that the transmit path 400 can be implemented in a UE. Furthermore, it will be understood that the receive path 500 can be implemented in one UE, and that the transmit path 400 can be implemented in another UE in case of device-2-device communication. In some embodiments, the receive path 500 is configured to support the PDCCH monitoring for multi-cell scheduling as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the gNBs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

DL transmissions or UL transmissions can be based on an OFDM waveform including a variant using DFT preceding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments consider a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remainder of the present disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 v17.1.0, “NR; Physical channels and modulation”, and 3GPP TS 38.213 v17.1.0 “NR; Physical Layer procedures for control”.

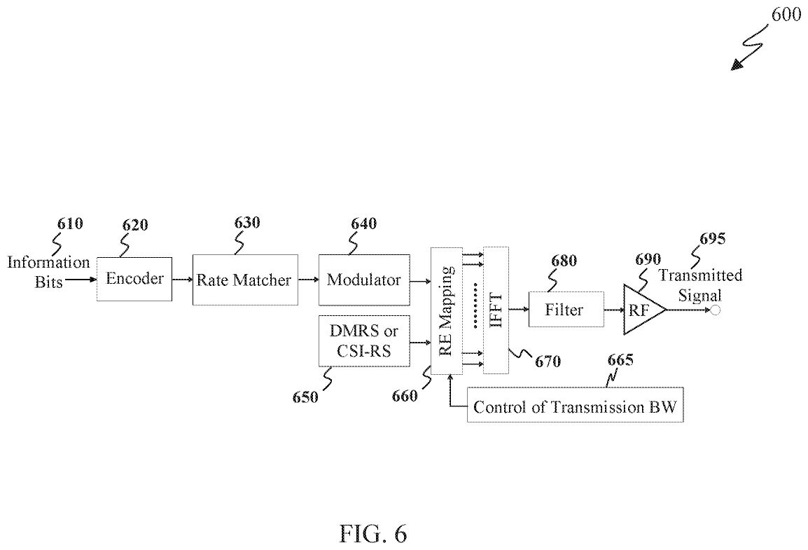

FIG. 6 illustrates an example transmitter structure using OFDM 600 according to embodiments of the present disclosure. The embodiment of the transmitter structure using OFDM 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter structure using OFDM 600.

As shown in FIG. 6, information bits, such as DCI bits or data bits 610, are encoded by encoder 620, rate matched to assigned time/frequency resources by rate matcher 630, and modulated by modulator 640. Subsequently, modulated encoded symbols and DMRS or CSI-RS 650 are mapped to SCs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

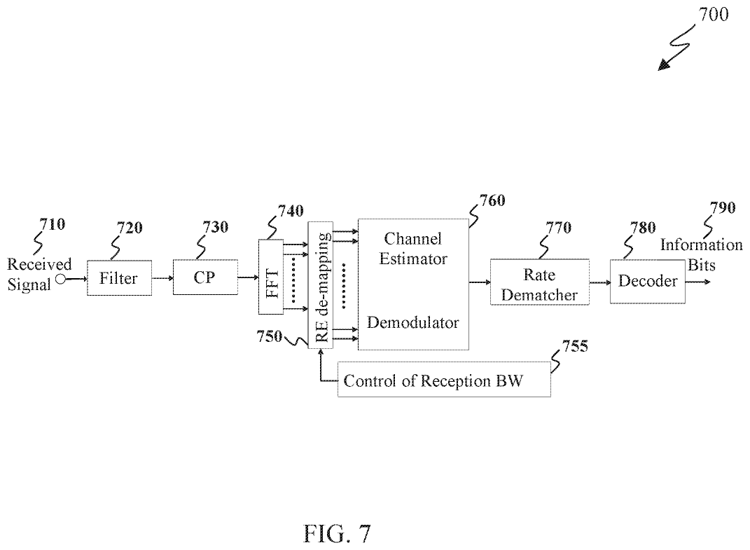

FIG. 7 illustrates an example receiver structure using OFDM 700 according to embodiments of the present disclosure. The embodiment of the receiver structure using OFDM 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the receiver structure using OFDM 700.

As shown in FIG. 7, a received signal 710 is filtered by filter 720, a CP removal unit removes a CP 730, a filter 740 applies a fast Fourier transform (FFT), REs de-mapping unit 750 de-maps REs selected by BW selector unit 755, received symbols are demodulated by a channel estimator and a demodulator unit 760, a rate de-matcher 770 restores a rate matching, and a decoder 780 decodes the resulting bits to provide information bits 790.

DCI can serve several purposes. A DCI format includes information elements (IEs) and is typically used for scheduling a PDSCH (DL DCI format) or a PUSCH (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to an eNB, the RNTI is a cell RNTI (C-RNTI) or another RNTI type such as a MCS-C-RNTI. For a DCI format scheduling a PDSCH conveying system information (SI) to a group of UEs, the RNTI is a SI-RNTI. For a DCI format scheduling a PDSCH providing a response to a random access (RA) from a group of UEs, the RNTI is a RA-RNTI. For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a P-RNTI. For a DCI format providing transmission power control (TPC) commands to a group of UEs, the RNTI is a TPC-RNTI, and so on. Each RNTI type is configured to a UE through higher layer signaling. A UE typically decodes at multiple candidate locations for potential PDCCH transmissions.

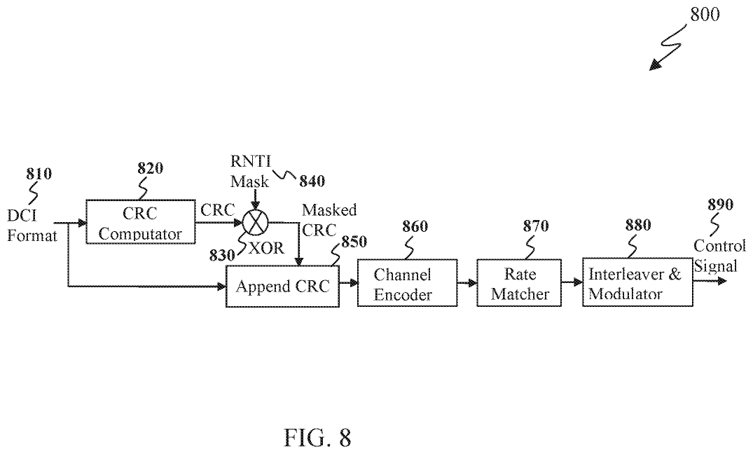

FIG. 8 illustrates an example encoding process 800 for a DCI format according to embodiments of the present disclosure. The embodiment of the encoding process 800 for a DCI format illustrated in FIG. 8 is for illustration only. FIG. 8 does not limit the scope of this disclosure to any particular implementation of the encoding process 800 for a DCI format.

A gNB separately encodes and transmits each DCI format in a respective PDCCH. When applicable, an RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 810 is determined using a CRC computation unit 820, and the CRC is masked using an exclusive OR (XOR) operation unit 830 between CRC bits and RNTI bits 840. The XOR operation is defined as XOR(0,0)=0, XOR(0,1)=1, XOR(1,0)=1, XOR(1,1)=0. The masked CRC bits are appended to DCI format information bits using a CRC append unit 850. An encoder 860 performs channel coding, such as polar coding, followed by rate matching to allocated resources by rate matcher 870. Interleaving and modulation units 880 apply interleaving and modulation, such as QPSK, and the output control signal 890 is transmitted.

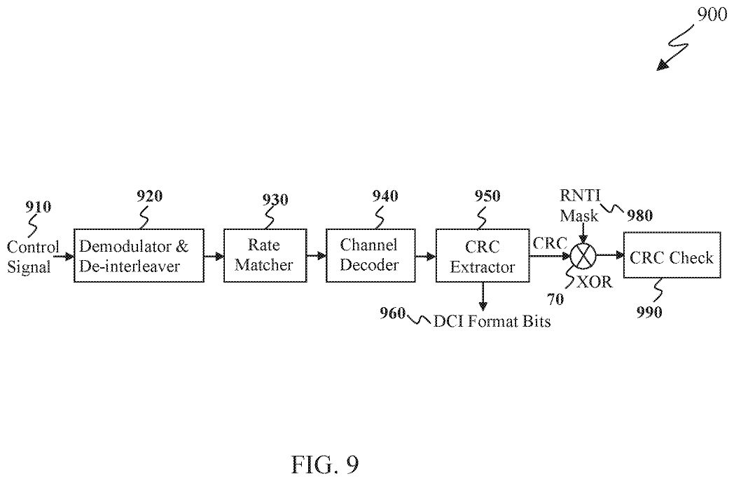

FIG. 9 illustrates an example decoding process 900 for a DCI format according to embodiments of the present disclosure. The embodiment of the decoding process 900 for a DCI format illustrated in FIG. 9 is for illustration only. FIG. 9 does not limit the scope of this disclosure to any particular implementation of the decoding process 900 for a DCI format.

A received control signal 910 is demodulated and de-interleaved by a demodulator and a de-interleaver 920. A rate matching applied at a gNB transmitter is restored by rate matcher 930, and resulting bits are decoded by decoder 940. After decoding, a CRC extractor 950 extracts CRC bits and provides DCI format information bits 960. The DCI format information bits are de-masked 970 by an XOR operation with a RNTI 980 (when applicable) and a CRC check is performed by unit 990. When the CRC check succeeds (check-sum is zero), the DCI format information bits are considered to be valid. When the CRC check does not succeed, the DCI format information bits are considered to be invalid.

When an NR RAT is introduced in an existing LTE network, both LTE and NR need to co-exist in a same or in an overlapping spectrum. Spectrum sharing is then required to support LTE and NR coexistence. Spectrum sharing mechanisms can depend on several factors including whether or not an LTE scheduler and an NR scheduler can perform coordinated scheduling and whether or not a UE capable for operating with an NR RAT can also operate with an LTE RAT. Coordinated scheduling is typically possible when an eNB scheduler for LTE and a gNB scheduler for NR are collocated, in such case even a same scheduler for LTE and NR can be possible, or connected via a backhaul with materially negligible latency in order to exchange dynamic configurations over respective interfaces. Non-coordinated scheduling is typically required when conditions for coordinated scheduling cannot be fulfilled.

Various embodiments of the present disclosure consider PDCCH monitoring aspects for an enhanced cross-carrier scheduling operation in a carrier aggregation (CA) framework that supports joint scheduling of multiple cells.

In legacy 5G NR systems, a downlink or uplink data transmission can be scheduled only on a single serving cell. In other words, a DCI format provides scheduling information parameters for a PDSCH or a PUSCH on a single serving cell. If the serving cell is a scheduled cell, the UE receives a DCI format for the PDSCH/PUSCH in a PDCCH that the UE receives on a corresponding scheduling cell. In case of cross-carrier scheduling, based on a carrier indication field (CIF) in the DCI format, the UE can determine a serving cell on which the UE can receive the PDSCH or transmit the PUSCH.

A legacy NR system does not support joint scheduling of multiple PDSCHs or multiple PUSCH on multiple cells by using single/common control signaling, such as by using a single DCI format. For such operation, the UE receives multiple DCI formats, wherein each DCI format can schedule one of the multiple PDSCHs or PUSCHs. Such operation achieves the intended outcome, but introduces signaling overhead that is proportional to the number of scheduled PDSCHs or PUSCHs. In various scenarios, it is possible that several scheduling parameters or corresponding UE operations are shared/common among the multiple PDSCHs or PUSCHs on the “co-scheduled” cells.

For example, the UE may use a same PUCCH resource to transmit a PUCCH providing HARQ-ACK feedback corresponding to the multiple PDSCHs. Therefore, an indication for the same PUCCH resource (and corresponding operations for PUCCH transmission) in DCI formats scheduling PDSCH receptions on multiple cells at a same time may be unnecessarily repeated multiple times. In addition, in some scenarios, such as intra-band CA, it is likely that physical channel conditions are correlated, so various scheduling parameters such as for link adaptation, MIMO/beamforming operation, and possibly even resource allocation can be common and repeated among the co-scheduled cells. Such unnecessary overhead in control signaling can be significant, especially when the number of co-scheduled cells are large, such as 4-8 cells. Also, CRC bits need to be repeated in each of the DCI formats scheduling PDSCHs or PUSCHs on multiple cells which incurs significant signaling overhead, especially for a large number of scheduled cells/DCI formats.

Similarly, PDCCH monitoring aspects in the legacy 5G NR system are based on single-cell scheduling mechanisms, with either self-carrier or cross-carrier scheduling procedures. In order to detect a single-cell scheduling DCI format, a UE needs to monitor PDCCH according to search space sets associated with one or more control resource sets (CORESETs) to receive and decode DCI formats for a number of PDCCH candidates. There are predetermined limits on the number of PDCCH candidates and a number of non-overlapping control channel elements (CCEs) that the UE can monitor in a slot, wherein the latter refers to channel estimation for the resources associated with the PDCCH candidates in the slot. In addition, the specifications support search space set overbooking procedures, wherein the UE can drop certain US-specific search space sets on a primary cell (with lowest priority, namely, with largest index) when the predetermined limits on the number of PDCCH candidates or the number of non-overlapping CCEs is/are exceeded.

For a UE that supports multi-cell scheduling, a DCI format received in a PDCCH provides (partially or completely) scheduling information for multiple serving cells, and may additionally point to another PDSCH or PDCCH that includes the remaining scheduling information.

Various embodiments of the present disclosure recognize that there is a need for multi-cell scheduling, wherein multiple cells can be jointly scheduled using reduced signaling overhead, such as by using only a single DCI format with a reasonable DCI format size, possibly same as a legacy DCI format size or slightly larger. Designing such a multi-cell scheduling operation should take into account a number of co-scheduled cells and a relative similarity of channel/radio conditions among the co-scheduled cells. In addition, various embodiments of the present disclosure recognize that there is a need to determine a search space design for multi-cell scheduling, such as how/where a UE can search for PDCCH candidates for multi-cell scheduling, and how the UE can distinguish multi-cell scheduling DCI format(s) from single-cell scheduling DCI formats. In addition, the UE limits on PDCCH monitoring need to be revisited in view of multi-cell scheduling. For example, the UE needs to determine how to count a PDCCH candidate for multi-cell scheduling for different cells included in a set of co-scheduled cells. Further, various embodiments of the present disclosure recognize that there is a need to specify other PDCCH monitoring aspects, such as search space overbooking and dynamic spectrum sharing ‘DSS’ operation (namely, scheduling on a cell such as PCell from two scheduling cells such as from the PCell and a special SCell or ‘sSCell’) in presence of multi-cell scheduling operation.

In addition, various embodiments of the present disclosure recognize that there is a need for multi-cell scheduling, wherein multiple cells can be jointly scheduled using reduced signaling overhead, such as by using only a single DCI format with a same or marginally larger size than a DCI format used for single-cell scheduling. Further, various embodiments of the present disclosure recognize that there is a need to specify other PDCCH monitoring aspects, such as search space set overbooking and dynamic spectrum sharing ‘DSS’ operation (namely, scheduling on a cell such as a primary cell from two scheduling cells such as from the primary cell and a special secondary cell or ‘sSCell’) in presence of multi-cell scheduling operation.

Accordingly, various embodiments of the present disclosure provide methods and apparatus for PDCCH monitoring in case of multi-cell scheduling operation with reduced signaling overhead, such as when a set of serving cells are jointly scheduled, referred to as “co-scheduled” cells.

In one case, a search space set for multi-cell scheduling is associated only with DCI format(s) for multi-cell scheduling on a set of co-scheduled cells. Such search space sets can be referred to as multi-cell search space (MSS) sets. Such search space sets can correspond to a set-level n_CI value, which is separate from existing n_CI values corresponding to search space sets for single-cell scheduling. By monitoring the search space set, the UE can detect a DCI format for scheduling on all scheduled cells or only a subset of scheduled cells from the set of co-scheduled cells. Accordingly, the detected DCI format can have a CIF value that is same as or different from an n_CI value corresponding to the search space set for multi-cell scheduling. The search space set can be commonly configured, thereby linked, on the scheduling cell and on all scheduled cells from the set of co-scheduled cells. The UE can monitor the search space set for multi-cell scheduling when linked search spaces sets on the scheduling cell and at least one scheduled cell from the set co-scheduled cells are configured on corresponding active DL BWPs of the scheduling cell and the at least one scheduled cell. When the UE monitors a PDCCH candidate with L non-overlapping CCEs in a slot according to the search space set, the UE counts the PDCCH candidate as a fractional count 1/K towards a number of monitored PDCCH candidates in the slot, and as a fractional count L/K towards a number of monitored non-overlapping CCEs in the slot, for each cell from the set of K co-scheduled cells. For example, a PDCCH candidate for a set of 4 co-scheduled cells is counted as ¼ of a PDCCH candidate for each cell from the set of 4 co-scheduled cells. When resolving a search space set overbooking event, the UE can assign a higher priority to the search space set for multi-cell scheduling, to override search space sets for single-cell scheduling that are configured earlier in time and may have smaller search space set indexes.

In one case, a search space set for multi-cell scheduling is associated with DCI format(s) both for multi-cell scheduling on a set of co-scheduled cells and for single-cell scheduling on a first scheduled cell from the set of co-scheduled cells. Such search space sets correspond to an existing cell-level n_CI value corresponding to the first scheduled cell. For example, a search space set for single-cell scheduling on the first scheduled cell can be configured to additionally monitor DCI format(s) for multi-cell scheduling. By monitoring the search space set, the UE can detect a DCI format for single-cell scheduling on the first scheduled cell with a CIF value that is same as the n_CI value corresponding to the first scheduled cell, or can detect a DCI format for multi-cell scheduling on all scheduled cells or only a subset of scheduled cells from the set of co-scheduled cells, with a set-level CIF value that is different from the n_CI value corresponding to the first scheduled cell. The search space set is commonly configured, thereby linked, on the scheduling cell and only the first scheduled cell, and the UE monitors the linked search space sets when both are configured on active DL BWPs of the scheduling cell and the first scheduled cell. When the UE monitors a PDCCH candidate with L non-overlapping CCEs in a slot according to the search space set, the UE counts the PDCCH candidate as a full/single count towards a number of monitored PDCCH candidates in the slot, and as a full count L towards a number of monitored non-overlapping CCEs in the slot, for only the first scheduled cell—no counting towards the limits for other cells in the set of co-scheduled cells.

In one case, a search space set for multi-cell scheduling is associated only with DCI format(s) for multi-cell scheduling on a set of co-scheduled cells. Such search space sets can be referred to as multi-cell search space (MSS) sets. Such search space sets can correspond to set-level n_CI values, which are separate from existing n_CI values corresponding to search space sets for single-cell scheduling. By monitoring the search space set, the UE can detect a DCI format for multi-cell scheduling If a same CORESET is shared by multiple MSS sets for different sets of co-scheduled cells, a first n_CI/CIF value for a set of co-scheduled cells can accordingly identify a DCI format while a second n_CI/CIF value for the scheduled cells can identify the scheduled cells from the set of co-scheduled cells. The first and second n_CI values can be separate fields in a DCI format and have different numbers of bits.

An MSS set can be commonly configured, thereby linked, on the scheduling cell and on all scheduled cells from the set of co-scheduled cells. The UE can monitor the MSS set when linked search spaces sets on the scheduling cell and at least one scheduled cell from the set co-scheduled cells are configured on corresponding active DL BWPs of the scheduling cell and the at least one scheduled cell. When the UE monitors a PDCCH candidate with L non-overlapping CCEs in a slot according to the MSS set, the UE counts the PDCCH candidate as a fractional count 1/K towards a number of monitored PDCCH candidates in the slot, and as a fractional count L/K towards a number of monitored non-overlapping CCEs in the slot, for each cell from the set of K co-scheduled cells. For example, a PDCCH candidate for a set of 4 co-scheduled cells is counted as ¼ of a PDCCH candidate for each cell from the set of 4 co-scheduled cells. When resolving a search space set overbooking event, the UE can assign a higher priority to the MSS set that to search space sets for single-cell scheduling.

One motivation for multi-cell scheduling using a single DCI format is enhanced cross-carrier scheduling operation for larger number of cells, such as 4-8 cells, operating in an intra-band CA framework in frequency bands below 6 GHz or above 6 GHz, referred to as FR1 or FR2, respectively. In general, the embodiments apply to any deployments, verticals, or scenarios including inter-band CA, with eMBB, URLLC and IIoT and XR, mMTC and IoT, with sidelink/V2X communications, with multi-TRP/beam/panel, in unlicensed/shared spectrum (NRU), for non-terrestrial networks (NTN), for aerial systems such as unmanned aerial vehicles (UAVs) such as drones, for private or non-public networks (NPN), for operation with reduced capability (RedCap) UEs, and so on.

Embodiments of the present disclosure for supporting PDCCH monitoring enhancements in case of multi-cell scheduling with reduced signaling overhead are summarized in the following and are more fully elaborated further below.

In one embodiment, a UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.

In one embodiment, for a UE that is configured a set of co-scheduled cells, a DCI format for multi-cell scheduling can provide full or partial information for values of cell-common and cell-specific fields for scheduling PDSCH receptions or PUSCH transmissions on respective one or more cells from the set of co-scheduled cells. When the DCI format provides partial information, the UE can determine remaining information from RRC signaling, or by using other complementary methods.

In one embodiment, when a UE is configured a set of co-scheduled cells including a first cell, the UE can receive a PDCCH with a DCI format that schedules a PDSCH reception or PUSCH transmission only on the first cell (single-cell scheduling DCI format). The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.

In one embodiment, when a UE is configured multi-cell scheduling for a set of co-scheduled cells by a scheduling cell, the UE can determine an association among search space sets for multi-cell scheduling with the set of co-scheduled cells based on a modified definition for a carrier indicator field value, n_CI.

In one embodiment, for multi-cell scheduling for a set of co-scheduled cells, where a UE is configured a first search space set on a corresponding scheduling cell, there can be several approaches with respect to search space configuration and linking to the set of co-scheduled cells, such as configuration of linked search space sets on all co-scheduled cells, or only on one reference cell from the set of the co-scheduled cells, or on none of the co-scheduled cells.

In one embodiment, for a UE configured with one or more set(s) of co-scheduled cells, a size of a multi-cell DCI format can be set-specific (where set refers to a set of co-scheduled cells), or set-size-specific (where set size refers to a size of a set of co-scheduled cells), or search space set specific, or scheduling cell specific, or UE-specific. In addition, the UE can have a constraint/budget on a number of DCI format sizes that the UE can monitor per serving cell, per slot or across all time slots, wherein a size of a DCI format for multi-cell scheduling can be counted towards the UE constraint/budget based on a fractional count or a full count, or maybe as part of a separate UE constraint/budget for sizes of DCI formats, or maybe not counted at all.

In one embodiment, for a UE that is configured multi-cell scheduling for a set of co-scheduled cells, and compared to single-cell scheduling, the UE monitors a same total number of PDCCH candidates and non-overlapping CCEs on a corresponding scheduling cell, but the UE counts a number of PDCCH candidates and non-overlapping CCEs per scheduled cell from the set of co-scheduled cells differently based on a search space set used for multi-cell scheduling. When monitoring PDCCH candidates according to a UE-specific search space set for multi-cell scheduling, the UE counts PDCCH candidates as a fraction of a number of PDCCH candidates that the UE can monitor. For example, for a set of co-scheduled cells that includes 4 cells, the UE counts a PDCCH candidate for 4-cell scheduling as ¼ of a PDCCH candidate for each cell from the set of 4 configured cells. It is noted that such allocation also applies when no DCI is detected in the PDCCH candidate or even when the UE detects a DCI format that co-schedules a subset of the configured cells, such as only 2 cells from the 4 cells. Alternatively, the counting can be included for only one scheduled cell from the set of co-scheduled cells.

In one embodiment, when the primary cell (PCell) is among cells of a set of co-scheduled cells and scheduling on cells from the set of co-scheduled cells is from the PCell (the PCell is a scheduling cell for the set of co-schedule cells), and when the UE is configured a search space set for monitoring PDCCH for detection of a multi-cell scheduling DCI format, and when the UE determines an overbooking event for search space sets, the UE can assign a higher priority to the search space set and drop other (single-cell scheduling) search space sets before dropping such a (multi-cell scheduling) search space set. Such operation can be beneficial, for example, when a search space set for multi-cell scheduling is configured in a later point in time after some single-cell scheduling search space sets corresponding to some cells from the set of co-scheduled cells are already configured, and therefore gNB is forced to assign a larger search space set index to the multi-cell scheduling search space set than those single-cell scheduling search space sets instead of re-configuring all search space sets.

In one embodiment, for a UE that is configured multi-cell scheduling for a set of co-scheduled cells, when the UE is configured to monitor PDCCH for the set of co-scheduling cells on a first scheduling cell and a second scheduling cell, the UE allocates PDCCH candidates and non-overlapping CCEs for multi-cell scheduling based on the approaches described herein, such that, for each cell from the set of co-scheduled cells, the UE maintains a similar allocation of PDCCH candidates and non-overlapping CCEs across the first and second scheduling cells as when there is a single scheduling cell for the set of co-scheduled cells. The first scheduling cell can be the PCell, and the second scheduling cell can be a special scheduling SCell, referred to as sSCell. In one example, the set of co-scheduled cells includes the PCell. In another example, the set of co-scheduled cells additionally includes the sSCell. Therefore, both multi-cell scheduling and DSS operation impact a PDCCH monitoring behavior for a UE, wherein the impact of multi-cell scheduling is addressed separately from the impact of DSS operation.

Throughout the present disclosure, the term “configuration” or “higher layer configuration” and variations thereof (such as “configured” and so on) are used to refer to one or more of: a system information signaling such as by a MIB or a SIB (such as SIB 1), a common or cell-specific higher layer/RRC signaling, or a dedicated or UE-specific or BWP-specific higher layer/RRC signaling.

Throughout the present disclosure, the term signal quality is used to refer to e.g., RSRP or RSRQ or RSSI or SNR or SINR, with or without filtering such as L1 or L3 filtering, of a channel or a signal such as a reference signal (RS) including SSB, CSI-RS, or SRS.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same PRG.

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a PBCH, the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE may assume that SS/PBCH blocks transmitted with the same block index on the same center frequency location are quasi co-located with respect to Doppler spread, Doppler shift, average gain, average delay, delay spread, and, when applicable, spatial Rx parameters. The UE shall not assume quasi co-location for any other SS/PBCH block transmissions.

In absence of CSI-RS configuration, and unless otherwise configured, the UE may assume PDSCH DM-RS and SS/PBCH block to be quasi co-located with respect to Doppler shift, Doppler spread, average delay, delay spread, and, when applicable, spatial Rx parameters. The UE may assume that the PDSCH DM-RS within the same CDM group are quasi co-located with respect to Doppler shift, Doppler spread, average delay, delay spread, and spatial Rx. The UE may also assume that DMRS ports associated with a PDSCH are QCL with QCL Type A, Type D (when applicable) and average gain. The UE may further assume that no DM-RS collides with the SS/PBCH block.

A UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread},
‘QCL-TypeB’: {Doppler shift, Doppler spread},
‘QCL-TypeC’: {Doppler shift, average delay},
‘QCL-TypeD’: {Spatial Rx parameter}.

The UE receives a MAC-CE activation command to map up to N, e.g., N=8 TCI states to the codepoints of the DCI field ‘Transmission Configuration Indication’. When the HARQ-ACK information corresponding to the PDSCH carrying the (MAC-CE) activation command is transmitted in slot n, the indicated mapping between TCI states and codepoints of the DCI field ‘Transmission Configuration Indication’ should be applied after a MAC-CE application time, e.g., starting from the first slot that is after slot n+3Nₛₗₒₜ^{subframe,μ} where Nₛₗₒₜ^{subframe,μ} is a number of slot per subframe for subcarrier spacing (SCS) configuration μ.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets,
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enable TwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier:
The timeDurationForQCL is determined based on the subcarrier spacing of the scheduled PDSCH. If μ_{PDCCH}<μ_{PDSCH} an additional timing delay

$$d \frac{{2}^{μ} PDSCH}{{2}^{μ} PDCCH}$$

is added to the timeDurationForQCL, where d is defined in 5.2.1.5.1a-1, otherwise d is zero;
For both the cases, when the UE is configured with enableDefaultBeamForCCS, and when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For PUSCH scheduled by DCI format 0_0 on a cell and if the higher layer parameter enableDefaultBeamPL-ForPUSCH0-0 is set ‘enabled’, the UE is not configured with PUCCH resources on the active UL BWP and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell.

For PUSCH scheduled by DCI format 0_0 on a cell and if the higher layer parameter enableDefaultBeamPL-ForPUSCH0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

In Carrier Aggregation (CA), two or more Component Carriers (CCs) are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one TAG);
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell;
A non-CA capable UE can receive on a single CC and transmit on a single CC corresponding to one serving cell only (one serving cell in one TAG).

CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE is 16 for DL and 16 for UL.

When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). Depending on UE capabilities, Secondary Cells (SCells) can be configured to form together with the PCell a set of serving cells. The configured set of serving cells for a UE therefore includes one PCell and one or more SCells.

The reconfiguration, addition and removal of SCells can be performed by RRC. At intra-NR handover and during connection resume from RRC_INACTIVE, the network can also add, remove, keep, or reconfigure SCells for usage with the target PCell. When adding a new SCell, dedicated RRC signalling is used for sending all required system information of the SCell i.e., while in connected mode, UEs need not acquire broadcast system information directly from the SCells.

To enable reduced UE battery consumption when CA is configured, an activation/deactivation mechanism of Cells is supported. When an SCell is deactivated, the UE does not need to receive the corresponding PDCCH or PDSCH, cannot transmit in the corresponding uplink, nor is it required to perform CQI measurements. Conversely, when an SCell is active, the UE shall receive PDSCH and PDCCH (if the UE is configured to monitor PDCCH from this SCell) and is expected to be able to perform CQI measurements. NG-RAN ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. NG-RAN ensures that SCells mapped to PUCCH SCell are deactivated before the PUCCH SCell is changed or removed.

When reconfiguring the set of serving cells:
SCells added to the set are initially activated or deactivated;
SCells which remain in the set (either unchanged or reconfigured) do not change their activation status (activated or deactivated).

At handover or connection resume from RRC_INACTIVE:
SCells are activated or deactivated.

To enable reduced UE battery consumption when BA is configured, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH.

To enable reduced UE battery consumption when CA is configured and enable reduced UE complexity, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH.

To enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, AGC and beam management, if configured. A DCI is used to control entering/leaving the dormant BWP for one or more SCell(s) or one or more SCell group(s).

The dormant BWP is one of the UE's dedicated BWPs configured by network via dedicated RRC signalling. The SpCell and PUCCH SCell cannot be configured with a dormant BWP.

Cross-carrier scheduling with the Carrier Indicator Field (CIF) allows the PDCCH of a serving cell to schedule resources on another serving cell but with the following restrictions:
Cross-carrier scheduling does not apply to PCell i.e., PCell is scheduled via its PDCCH;
When an SCell is configured with a PDCCH, that cell's PDSCH and PUSCH are scheduled by the PDCCH on this SCell;
When an SCell is not configured with a PDCCH, that SCell's PDSCH and PUSCH are scheduled by a PDCCH on another serving cell;
The scheduling PDCCH and the scheduled PDSCH/PUSCH can use the same or different numerologies.

Cross-carrier scheduling using a carrier indicator field (CIF) allows a DCI format provided by a PDCCH on a serving/scheduling cell to schedule resources on another serving/scheduled cell with the following restrictions:
When cross-carrier scheduling from an SCell to PCell is not configured to a UE, the UE can be scheduled transmission or reception on the PCell only by a DCI format provided by a PDCCH reception on the PCell;
When cross-carrier scheduling from an SCell to PCell is configured to a UE:
PDCCH on that SCell can provide a DCI format that schedules a PDSCH reception or a PUSCH transmission from the UE on the PCell;
PDCCH on the PCell can provide a DCI format that schedules a PDSCH reception or a PUSCH transmission from the UE on the PCell;
Only one SCell can be configured to the UE for cross-carrier scheduling on the PCell.
When an SCell is configured to a UE as a scheduling cell, a PDSCH reception or a PUSCH transmission from the UE is scheduled by a DCI format provided by a PDCCH reception on the SCell;
When an SCell is not configured to a UE as a scheduling cell, a PDSCH reception or a PUSCH transmission from the UE is scheduled by a DCI format provided by a PDCCH reception on another serving cell;
A PDCCH reception on a scheduling cell can have same or different numerology than an associated PDSCH reception or PUSCH transmission on a scheduled cell.

Some of the restrictions above may be relaxed. For example, dynamic spectrum sharing (DSS) allows LTE and NR to share the same carrier. As the number of NR devices in a network increases, it is important that sufficient scheduling capacity for NR UEs on the shared carriers is ensured. In the case of DSS operation, PDCCH enhancements for cross-carrier scheduling including can be considered such that PDCCH of an SCell, referred to as a special/scheduling SCell (sSCell), can schedule PDSCH or PUSCH on the P(S)Cell.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

In addition to scheduling, PDCCH can be used for:
Activation and deactivation of configured PUSCH transmission with configured grant;
Activation and deactivation of PDSCH semi-persistent transmission;
Notifying one or more UEs of the slot format;
Notifying one or more UEs of the PRB(s) and OFDM symbol(s) where the UE may assume no transmission is intended for the UE;
Transmission of TPC commands for PUCCH and PUSCH;
Transmission of one or more TPC commands for SRS transmissions by one or more UEs;
Switching a UE's active bandwidth part;
Initiating a random-access procedure;
Indicating the UE(s) to monitor the PDCCH during the next occurrence of the DRX on-duration;
In IAB context, indicating the availability for soft symbols of an IAB-DU.

A UE monitors a set of PDCCH candidates in the configured monitoring occasions in one or more configured CORESETs according to the corresponding search space configurations.

A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET.

Polar coding is used for PDCCH. Each resource element group carrying PDCCH carries its own DMRS. QPSK modulation is used for PDCCH.

A UE monitors a set of PDCCH candidates in one or more CORESETs on the active DL BWP on each activated serving cell configured with PDCCH monitoring according to corresponding search space sets where monitoring implies decoding each PDCCH candidate according to the monitored DCI formats.

If a UE is provided monitoringCapabilityConfig for a serving cell, the UE obtains an indication to monitor PDCCH on the serving cell for a maximum number of PDCCH candidates and non-overlapping CCEs:
per slot if monitoringCapabilityConfig=r15monitoringcapability, or
per span if monitoringCapabilityConfig=r16monitoringcapability.

If the UE is not provided monitoringCapabilityConfig, the UE monitors PDCCH on the serving cell for a maximum number of PDCCH candidates and non-overlapping CCEs per slot.

A UE can indicate a capability to monitor PDCCH according to one or more of the combinations (X, Y)=(2, 2), (4, 3), and (7, 3) per SCS configuration of μ=0 and μ=1. A span is a number of consecutive symbols in a slot where the UE is configured to monitor PDCCH. Each PDCCH monitoring occasion is within one span. If a UE monitors PDCCH on a cell according to combination (X, Y), the UE supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

If a UE can support:
a first set of N_{cells,0}^{DL} serving cells where the UE is either not provided coresetPoolIndex or is provided coresetPoolIndex with a single value for all CORESETs on all DL BWPs of each scheduling cell from the first set of serving cells, and
a second set of N_{cells,1}^{DL} serving cells where the UE is not provided coresetPoolIndex or is provided coresetPoolIndex with a value 0 for a first CORESET, and with a value 1 for a second CORESET on any DL BWP of each scheduling cell from the second set of serving cells,
   the UE determines, for the purpose of reporting pdcch-BlindDetectionCA, a number of serving cells as N_{cells,0}^{DL}+R·N_{cells,1}^{DL} where R is a value reported by the UE.

If a UE indicates in UE-NR-Capability a carrier aggregation capability larger than 4 serving cells and the UE is not provided monitoringCapabilityConfig for any downlink cell or if the UE is provided monitoringCapabilityConfig=r15monitoringcapability for all downlink cells where the UE monitors PDCCH, the UE includes in UE-NR-Capability an indication for a maximum number of PDCCH candidates and for a maximum number of non-overlapped CCEs the UE can monitor per slot when the UE is configured for carrier aggregation operation over more than 4 cells. When a UE is not configured for NR-DC operation, the UE determines a capability to monitor a maximum number of PDCCH candidates and a maximum number of non-overlapped CCEs per slot that corresponds to N_{cells}^{cap} downlink cells, where:
N_{cells}^{cap} is N_{cells,0}^{DL}+R·N_{cells,1}^{DL} if the UE does not provide pdcch-BlindDetectionCA where N_{cells,0}^{DL}+N_{cells,1}^{DL} is the number of configured downlink serving cells.
otherwise, N_{cells}^{cap} is the value of pdcch-BlindDetectionCA.

When a UE is configured for NR-DC operation, the UE determines a capability to monitor a maximum number of PDCCH candidates and a maximum number of non-overlapped CCEs per slot that corresponds to N_{cells}^{cap}=N_{cells}^{MCG} downlink cells for the MCG where N_{cells}^{MCG} is provided by pdcch-BlindDetection for the MCG and determines a capability to monitor a maximum number of PDCCH candidates and a maximum number of non-overlapped CCEs per slot that corresponds to N_{cells}^{cap}=N_{cells}^{SCG} downlink cells for the SCG where N_{cells}^{SCG} is provided by pdcch-BlindDetection for the SCG. When the UE is configured for carrier aggregation operation over more than 4 cells, or for a cell group when the UE is configured for NR-DC operation, the UE does not expect to monitor per slot a number of PDCCH candidates or a number of non-overlapped CCEs that is larger than the maximum number as derived from the corresponding value of N_{cells}^{cap}.

If a UE indicates in UE-NR-Capability-r16 a carrier aggregation capability larger than two downlink cells, the UE includes in UE-NR-Capability-r16 an indication for a maximum number of PDCCH candidates and a maximum number of non-overlapped CCEs that the UE can monitor per span when the UE is configured for carrier aggregation operation over more than two downlink cells with monitoringCapabilityConfig=r16monitoringcapability. When a UE is not configured for NR-DC operation and the UE is provided monitoringCapabilityConfig=r16monitoringcapability for all downlink cell where the UE monitors PDCCH, the UE determines a capability to monitor a maximum number of PDCCH candidates and a maximum number of non-overlapped CCEs per span that corresponds to N_{cells}^{cap-r16} downlink cells, where:
N_{cells}^{cap-r16} is the number of configured downlink cells if the UE does not provide pdcch-MonitoringCA,
otherwise, N_{cells}^{cap-r16} is the value of pdcch-MonitoringCA.

When the UE is configured for carrier aggregation operation over more than 2 cells, or for a cell group when the UE is configured for NR-DC operation, the UE does not expect to monitor per span a number of PDCCH candidates or a number of non-overlapped CCEs that is larger than the maximum number as derived from the corresponding value of N_{cells}^{cap-r16}.

If a UE indicates in UE-NR-Capability a carrier aggregation capability larger than one downlink cell with monitoringCapabilityConfig=r15monitoringcapability or larger than one downlink cell with monitoringCapabilityConfig=r16monitoringcapability, the UE includes in UE-NR-Capability-r16 an indication for a maximum number of PDCCH candidates and a maximum number of non-overlapped CCEs the UE can monitor for downlink cells with monitoringCapabilityConfig=r15monitoringcapability or for downlink cells with monitoringCapabilityConfig=r16monitoringcapability when the UE is configured for carrier aggregation operation over more than two downlink cells with at least one downlink cell with monitoringCapabilityConfig=r15monitoringcapability and at least one downlink cell with monitoringCapabilityConfig=r16monitoringcapability. When a UE is not configured for NR-DC operation, the UE determines a capability to monitor a maximum number of PDCCH candidates and a maximum number of non-overlapped CCEs per slot or per span that corresponds to N_{cells,r15}^{cap-r16} downlink cells or to N_{cells,r16}^{cap-r16} downlink cells, respectively, where:
N_{cells,r15}^{cap-r16} is the number of configured downlink cells if the UE does not provide pdcch-BlindDetectionCA1,
otherwise,
if the UE reports only one combination of (pdcch-BlindDetectionCA1, pdcch-BlindDetectionCA2), N_{cells,r15}^{cap-r16} is the value of pdcch-BlindDetectionCA1,
else, N_{cells,r15}^{cap-r16} is the value of pdcch-BlindDetectionCA1 from a combination of (pdcch-BlindDetectionCA1, pdcch-BlindDetectionCA2) that is provided by pdcch-BlindDetectionCA-CombIndicator, and
N_{cells,r15}^{cap-r16} is the number of configured downlink cells if the UE does not provide pdcch-BlindDetectionCA2,
otherwise,
if the UE reports only one combination of (pdcch-BlindDetectionCA1, pdcch-BlindDetectionCA2), N_{cells,r15}^{cap-r16} is the value of pdcch-BlindDetectionCA2,
else, N_{cells,r15}^{cap-r16} is the value of pdcch-BlindDetectionCA2 from a combination of (pdcch-BlindDetectionCA1, pdcch-BlindDetectionCA2) that is provided by pdcch-BlindDetectionCA-CombIndicator.

A set of PDCCH candidates for a UE to monitor is defined in terms of PDCCH search space sets. A search space set can be a CSS set or a USS set. A UE monitors PDCCH candidates in one or more of the following search spaces sets:
a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG,
a Type0A-PDCCH CSS set configured by searchSpaceOtherSystemInformation in PDCCH-ConfigCommon for a DCI format with CRC scrambled by a SI-RNTI on the primary cell of the MCG,
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell,
a Type2-PDCCH CSS set configured by pagingSearchSpace in PDCCH-ConfigCommon for a DCI format with CRC scrambled by a P-RNTI on the primary cell of the MCG,
a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI, and
a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI.

If a UE is provided:
one or more search space sets by corresponding one or more of searchSpaceZero, searchSpaceSIB1, searchSpaceOtherSystemInformation, pagingSearchSpace, ra-SearchSpace, or a CSS set by PDCCH-Config, and
a SI-RNTI, a P-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI;
   then, for a RNTI from any of these RNTIs, the UE does not expect to process information from more than one DCI format with CRC scrambled with the RNTI per slot.

For each DL BWP configured to a UE in a serving cell, the UE can be provided by higher layer signalling with:
P≤3 CORESETs if coresetPoolIndex is not provided, or if a value of coresetPoolIndex is same for all CORESETs if coresetPoolIndex is provided,
P≤5 CORESETs if coresetPoolIndex is not provided for a first CORESET, or is provided and has a value 0 for a first CORESET, and is provided and has a value 1 for a second CORESET.

For each CORESET, the UE is provided the following by ControlResourceSet:
a CORESET index p, by controlResourceSetId or by controlResourceSetId-v1610, where:
0<p<12 if coresetPoolIndex is not provided, or if a value of coresetPoolIndex is same for all CORESETs if coresetPoolIndex is provided;
0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception in a respective CORESET;
if the UE is provided by simultaneousTCI-UpdateList1 or simultaneousTCI-UpdateList2 up to two lists of cells for simultaneous TCI state activation, the UE applies the antenna port quasi co-location provided by TCI-States with same activated tci-StateID value to CORESETs with index p in all configured DL BWPs of all configured cells in a list determined from a serving cell index provided by a MAC CE command;
an indication for a presence or absence of a transmission configuration indication (TCI) field for a DCI format, other than DCI format 1_0, that schedules PDSCH receptions or indicates SPS PDSCH release or indicates SCell dormancy or indicates a request for a Type-3 HARQ-ACK codebook report without scheduling PDSCH and is transmitted by a PDCCH in CORESET p, by tci-PresentInDCI or tci-PresentDCI-1-2.

When precoderGranularity=allContiguousRBs, a UE does not expect:
to be configured a set of resource blocks of a CORESET that includes more than four sub-sets of resource blocks that are not contiguous in frequency,
any RE of a CORESET to overlap with any RE determined from lte-CRS-ToMatchAround, or from LTE-CRS-PatternList, or with any RE of a SS/PBCH block.

For each CORESET in a DL BWP of a serving cell, a respective frequencyDomainResources provides a bitmap:
if a CORESET is not associated with any search space set configured with freqMonitorLocations, the bits of the bitmap have a one-to-one mapping with non-overlapping groups of 6 consecutive PRBs, in ascending order of the PRB index in the DL BWP bandwidth of N_{RB}^{BWP} PRBs with starting common RB position N_{BWP}^{start}, where the first common RB of the first group of 6 PRBs has common RB index 6·┌N_{BWP}^{start}/6┐ if rb-Offset is not provided, or the first common RB of the first group of 6 PRBs has common RB index N_{BWP}^{start}+N_{RB}^{offset} where N_{RB}^{offset} is provided by rb-Offset,
if a CORESET is associated with at least one search space set configured with freqMonitorLocations, the first N_{RBG,set0}^{size} bits of the bitmap have a one-to-one mapping with non-overlapping groups of 6 consecutive PRBs, in ascending order of the PRB index in each RB set k in the DL BWP bandwidth of N_{RB}^{BWP} PRBs with starting common RB position RB_{s0+k,DL}^{start,μ}, see REF 4, where the first common RB of the first group of 6 PRBs has common RB index RB_{s0+k,DL}^{start,μ}+N_{RB}^{offset} and k is indicated by freqMonitorLocations if provided for a search space set; otherwise, k=0. N_{RBG,set0}^{size}=└(N_{RB,set0}^{size}−N_{RB}^{offset})/6┘, N_{RB,set0}^{size} is a number of available PRBs in the RB set 0 for the DL BWP, and N_{RB}^{offset} is provided by rb-Offset or N_{RB}^{offset}=0 if rb-Offset is not provided. If a UE is provided RB sets in the DL BWP, the UE expects that the RB s of the CORESET are within the union of the PRBs in the RB sets of the DL BWP.

For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states as described in REF 5, the UE assumes that the DM-RS antenna port associated with PDCCH receptions is quasi co-located with the SS/PBCH block the UE identified during the initial access procedure;
if a UE has been provided a configuration of more than one TCI states by tci-StatesPDCCH-ToAddList and tci-StatesPDCCH-ToReleaseList for the CORESET as part of Reconfiguration with sync procedure as described in REF 6 but has not received a MAC CE activation command for one of the TCI states as described in REF 5, the UE assumes that the DM-RS antenna port associated with PDCCH receptions is quasi co-located with the SS/PBCH block or the CSI-RS resource the UE identified during the random access procedure initiated by the Reconfiguration with sync procedure as described in REF 6.

For a CORESET with index 0, the UE assumes that a DM-RS antenna port for PDCCH receptions in the CORESET is quasi co-located with:
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure.

For a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command for the CORESET is provided by a SS/PBCH block:
if the UE receives a MAC CE activation command for one of the TCI states, the UE applies the activation command in the first slot that is after slot k+3Nₛₗₒₜ^{subframe,μ} where k is the slot where the UE would transmit a PUCCH with HARQ-ACK information for the PDSCH providing the activation command and μ is the SCS configuration for the PUCCH. The active BWP is defined as the active BWP in the slot when the activation command is applied.

The IE SearchSpace defines how/where to search for PDCCH candidates. Each search space is associated with one ControlResourceSet. For a scheduled cell in the case of cross carrier scheduling, except for nrofCandidates, all the optional fields are absent (regardless of their presence conditions).

SearchSpace information element

-- ASN1START
-- TAG-SEARCHSPACE-START

| SearchSpace ::= | SEQUENCE { | |
|---|---|---|
| searchSpaceId | SearchSpaceId, | |
| controlResourceSetId | ControlResourceSetId | OPTIONAL, |

-- Cond SetupOnly

| | |
|---|---|
| monitoringSlotPeriodicityAndOffset | CHOICE { |
| sl1 | NULL, |
| sl2 | INTERGER (0..1), |
| sl4 | INTERGER (0..3), |
| sl5 | INTERGER (0..4), |
| sl8 | INTERGER (0..7), |
| sl10 | INTERGER (0..9), |
| sl16 | INTERGER (0..15), |
| sl20 | INTERGER (0..19), |
| sl40 | INTERGER (0..39), |
| sl80 | INTERGER (0..79), |
| sl160 | INTERGER (0..159), |
| sl320 | INTERGER (0..319), |
| sl640 | INTEGER (0..639), |
| sl1280 | INTEGER (0..1279), |
| sl2560 | INTEGER (0..2559), |

}
OPTIONAL, -- Cond Setup

| | |
|---|---|
| duration | INTEGER (2..2559) |

OPTIONAL, -- Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

}
OPTIONAL, -- Cond Setup

| | |
|---|---|
| searchSpaceType | CHOICE { |
| common | SEQUENCE { |
| dci-Format0-0-AndFormat1-0 | SEQUENCE { |

```
        ...
      }
OPTIONAL, -- Need R
```

| | |
|---|---|
| dci-Format2-0 | SEQUENCE { |
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
OPTIONAL -- Need R
        },
        ...
      }
OPTIONAL, -- Need R
```

| | |
|---|---|
| dci-Format2-1 | SEQUENCE { |

```
        ...
      }
OPTIONAL, -- Need R
```

| | |
|---|---|
| dci-Format2-2 | SEQUENCE { |

```
        ...
      }
OPTIONAL, -- Need R
```

| | |
|---|---|
| dci-Format2-3 | SEQUENCE { |
| dummy1 | ENUMERATED {sl1, sl2, sl4, sl5, sl8, sl10, sl16 |

sl20} OPTIONAL, -- Cond Setup

| | |
|---|---|
| dummy2 | ENUMERATED {n1, n2}, |

```
        ...
      }
OPTIONAL, -- Need R
    },
```

| | |
|---|---|
| ue-Specific | SEQUENCE { |
| dci-Formats | ENUMERATED {formats0-0-And-1-0, formats0- |

```
1-And-1-1},
      ...,
      [[
```

| | |
|---|---|
| dci-Formats-MT-r16 | ENUMERATED {formats2-5} |

OPTIONAL, -- Need R

| | |
|---|---|
| dci-FormatsSL-r16 | ENUMERATED {formats0-0-And-1-0, formats0- |

1-And-1-1, formats3-0, formats3-1,

| | |
|---|---|
| formats3-0-And-3-1} | OPTIONAL, - |

- Need R

| | |
|---|---|
| dci-FormatsExt-r16 | ENUMERATED {formats0-2-And-1-2, formats0- |

```
1-And-1-1And-0-2-And-1-2}
OPTIONAL -- Need R
      ]]
    }
  }
OPTIONAL -- Cond Setup2
}
```

| | |
|---|---|
| SearchSpaceExt-r16 ::= | SEQUENCE { |

| | |
|---|---|
| controlResourceSetId-r16 | ControlResourceSetId-r16 |

OPTIONAL, -- Cond SetupOnly2

| | |
|---|---|
| searchSpaceType-r16 | SEQUENCE { |
| common-r16 | SEQUENCE { |
| dci-Format2-4-r16 | SEQUENCE { |
| nrofCandidates-CI-r16 | SEQUENCE { |

| | |
|---|---|
| aggregationLevel1-r16 | ENUMERATED {n1, n2} |

OPTIONAL, -- Need R

| | |
|---|---|
| aggregationLevel2-r16 | ENUMERATED {n1, n2} |

OPTIONAL, -- Need R

| | |
|---|---|
| aggregationLevel4-r16 | ENUMERATED {n1, n2} |

OPTIONAL, -- Need R

| | |
|---|---|
| aggregationLevel8-r16 | ENUMERATED {n1, n2} |

OPTIONAL, -- Need R

| | |
|---|---|
| aggregationLevel16-r16 | ENUMERATED {n1, n2} |

```
OPTIONAL -- Need R
        },
        ...
      }
OPTIONAL, -- Need R
```

| | |
|---|---|
| dci-Format2-5-r16 | SEQUENCE { |
| nrofCandidates-IAB-r16 | SEQUENCE { |

| | |
|---|---|
| aggregationLevel1-r16 | ENUMERATED {n1, n2} |

OPTIONAL, -- Need R

| | |
|---|---|
| aggregationLevel2-r16 | ENUMERATED {n1, n2} |

OPTIONAL, -- Need R

| | |
|---|---|
| aggregationLevel4-r16 | ENUMERATED {n1, n2} |

OPTIONAL, -- Need R

| | |
|---|---|
| aggregationLevel8-r16 | ENUMERATED {n1, n2} |

OPTIONAL, -- Need R

| | |
|---|---|
| aggregationLevel16-r16 | ENUMERATED {n1, n2} |

```
OPTIONAL -- Need R
        },
        ...
      }
OPTIONAL, -- Need R
```

| | |
|---|---|
| dci-Format2-6-r16 | SEQUENCE { |

```
        ...
      }
OPTIONAL, -- Need R
      ...
    }
  }
OPTIONAL, -- Cond Setup3
```

| | |
|---|---|
| searchSpaceGroupIdList-r16 | SEQUENCE (SIZE (1..2)) OF INTEGER |

(0..1) OPTIONAL -- Need R

| | |
|---|---|
| freqMonitorLocations-r16 | BIT STRING (SIZE (5)) |

OPTIONAL -- Need R
}
-- TAG-SEARCHSPACE-STOP
-- ASN1STOP

For each DL BWP configured to a UE in a serving cell, the UE is provided by higher layers with S≤10 search space sets where, for each search space set from the S search space sets, the UE is provided the following by SearchSpace:
a search space set index s, 0≤s<40, by searchSpaceId,
an association between the search space set s and a CORESET p by controlResourceSetId or by controlResourceSetId-v1610,
a PDCCH monitoring periodicity of kₛ slots and a PDCCH monitoring offset of oₛ slots, by monitoringSlotPeriodicityAndOffset,
a PDCCH monitoring pattern within a slot, indicating first symbol(s) of the CORESET within a slot for PDCCH monitoring, by monitoringSymbolsWithinSlot,
a duration of Tₛ<kₛ slots indicating a number of slots that the search space set s exists by duration,
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively,
an indication that search space set s is either a CSS set, or a USS set by searchSpaceType,
if search space set s is a CSS set,
an indication by dci-Format0-0-AndFormat1-0 to monitor PDCCH candidates for DCI format 0_0 and DCI format 1_0,
an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level,
an indication by dci-Format2-1 to monitor PDCCH candidates for DCI format 2_1,
an indication by dci-Format2-2 to monitor PDCCH candidates for DCI format 2_2,
an indication by dci-Format2-3 to monitor PDCCH candidates for DCI format 2_3,
an indication by dci-Format2-4 to monitor PDCCH candidates for DCI format 2_4,
an indication by dci-Format2-6 to monitor PDCCH candidates for DCI format 2_6,
if search space set s is a USS set, an indication by dci-Formats to monitor PDCCH candidates either for DCI format 0_0 and DCI format 1_0, or for DCI format 0_1 and DCI format 1_1, or an indication by dci-FormatsExt to monitor PDCCH candidates for DCI format 0_2 and DCI format 1_2, or for DCI format 0_1, DCI format 1_1, DCI format 0_2, and DCI format 1_2, or for DCI format 3_0, or for DCI format 3_1, or for DCI format 3_0 and DCI format 3_1,
a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by RB_{s0+k,DL}^{start,μ}+N_{RB}^{offset}, where RB_{s0+k,DL}^{start,μ} is the index of first common RB of the RB set k, see REF 4, and N_{RB}^{offset} is provided by rb-Offset or N_{RB}^{offset}=0 if rb-Offset is not provided. For each RB set with a corresponding value of 1 in the bitmap, the frequency domain resource allocation pattern for the monitoring location is determined based on the first N_{RBG,set 0}^{size} set 0 bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell the carrier indicator field value corresponds to the value indicated by CrossCarrierSchedulingConfig.

For an active DL BWP of a serving cell on which a UE monitors PDCCH candidates in an USS, if the UE is not configured with a carrier indicator field, the UE monitors the PDCCH candidates without carrier indicator field. For an active DL BWP of a serving cell on which a UE monitors PDCCH candidates in an USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates with carrier indicator field corresponding to that secondary cell in another serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS, Y_{p,n}_{_{s,f}}_{^{μ}}=0;
for a USS, Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for p mod 3=0, Aₚ=39829 for p mod 3=1, Aₚ=39839 for p mod 3=2, and D=65537;
i=0, . . . , L−1;
N_{CCE,p} is the number of CCEs, numbered from 0 to N_{CCE,p}−1, in CORESET p and, if any, per RB set;
n_{CI} is the carrier indicator field value if the UE is configured with a carrier indicator field by CrossCarrierSchedulingConfig for the serving cell on which PDCCH is monitored;
otherwise, including for any CSS, n_{CI}=0;
m_{s,n}_{_{CI}}=0, . . . , M_{s,n}_{_{CI}}^{(L)}−1, where M_{s,n}_{_{CI}}^{(L)} is the number of PDCCH candidates the UE is configured to monitor for aggregation level L of a search space set s for a serving cell corresponding to n_{CI};
for any CSS, M_{s,max}^{(L)}=M_{s,0}^{(L)};
for a USS, M_{s,max}^{(L)} is the maximum of M_{s,n}_{_{CI}}^{(L)} over all configured n_{CI} values for a CCE aggregation level L of search space set s;
the RNTI value used for n_{RNTI} is the C-RNTI.

A UE expects to monitor PDCCH candidates for up to 4 sizes of DCI formats that include up to 3 sizes of DCI formats with CRC scrambled by C-RNTI per serving cell. (This rule is sometimes referred to as the “3+1” DCI format size budget.) The UE counts a number of sizes for DCI formats per serving cell based on a number of configured PDCCH candidates in respective search space sets for the corresponding active DL BWP.

A PDCCH candidate with index mₛ_{ⱼ}_{,n}_{_{CI}} for a search space set sⱼ using a set of CCEs in a CORESET p on the active DL BWP for serving cell n_{CI} is not counted for monitoring if there is a PDCCH candidate with index mₛ_{ᵢ}_{,n}_{_{CI}} for a search space set sᵢ<sⱼ, or if there is a PDCCH candidate with index nₛ_{ⱼ}_{,n}_{_{CI}} and nₛ_{ⱼ}_{,n}_{_{CI}}<mₛ_{ⱼ}_{,n}_{_{CI}} in the CORESET p on the active DL BWP for serving cell n_{CI} using a same set of CCEs, the PDCCH candidates have identical scrambling, and the corresponding DCI formats for the PDCCH candidates have a same size; otherwise, the PDCCH candidate with index mₛ_{ⱼ}_{,n}_{_{CI}} is counted for monitoring.

A UE does not expect to be configured CSS sets that result to corresponding total, or per scheduled cell, numbers of monitored PDCCH candidates and non-overlapped CCEs per slot or per span that exceed the corresponding maximum numbers per slot or per span, respectively.

For same cell scheduling or for cross-carrier scheduling, a UE does not expect a number of PDCCH candidates, and a number of corresponding non-overlapped CCEs per slot or per span on a secondary cell to be larger than the corresponding numbers that the UE is capable of monitoring on the secondary cell per slot or per span, respectively. If a UE is provided monitoringCapabilityConfig=r16monitoringcapability for the primary cell, except the first span of each slot, the UE does not expect a number of PDCCH candidates and a number of corresponding non-overlapped CCEs per span on the primary cell to be larger than the corresponding numbers that the UE is capable of monitoring on the primary cell per span.

For cross-carrier scheduling, the number of PDCCH candidates for monitoring and the number of non-overlapped CCEs per span or per slot are separately counted for each scheduled cell.

Table 1 provides the maximum number of monitored PDCCH candidates, M_{PDCCH}^{max,slot,μ}, per slot for a UE in a DL BWP with SCS configuration μ for operation with a single serving cell.

TABLE 1
Maximum number M_{PDCCH}^{max, slot, μ} of monitored
PDCCH candidates per slot for a DL BWP with SCS configuration
μ ∈ {0, 1, 2, 3} for a single serving cell

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

Table 2 provides the maximum number of monitored PDCCH candidates, M_{PDCCH}^{max,(X,Y),μ}, per span for a UE in a DL BWP with SCS configuration μ for operation with a single serving cell.

TABLE 2
Maximum number M_{PDCCH}^{max, (X, Y), μ} of monitored PDCCH
candidates in a span for combination (X, Y) for a DL BWP
with SCS configuration μ ∈ {0, 1} for a single serving cell

| | Maximum number M_{PDCCH}^{max, (X, Y), μ} of monitored PDCCH | | |
|---|---|---|---|
| | candidates per span for combination (X, Y) and per serving cell | | |
| μ | (2, 2) | (4, 3) | (7, 3) |
| 0 | 14 | 28 | 44 |
| 1 | 12 | 24 | 36 |

Table 3 provides the maximum number of non-overlapped CCEs, C_{PDCCH}^{max,slot,μ}, for a DL BWP with SCS configuration μ that a UE is expected to monitor corresponding PDCCH candidates per slot for operation with a single serving cell.

CCEs for PDCCH candidates are non-overlapped if they correspond to:
different CORESET indexes, or
different first symbols for the reception of the respective PDCCH candidates.

TABLE 3
Maximum number C_{PDCCH}^{max, slot, μ} of non-overlapped
CCEs per slot for a DL BWP with SCS configuration
μ ∈ {0, 1, 2, 3} for a single serving cell

| | Maximum number of non-overlapped CCEs per slot and |
|---|---|
| μ | per serving cell C_{PDCCH}^{max, slot, μ} |
| 0 | 56 |
| 1 | 56 |
| 2 | 48 |
| 3 | 32 |

Table 4 provides the maximum number of non-overlapped CCEs, C_{PDCCH}^{max,(X,Y),μ}, for a DL BWP with SCS configuration μ that a UE is expected to monitor corresponding PDCCH candidates per span for operation with a single serving cell.

TABLE 4
Maximum number C_{PDCCH}^{max, (X, Y), μ} of non-overlapped
CCEs in a span for combination (X, Y) for a DL BWP with
SCS configuration μ ∈ {0, 1} for a single serving cell

| | Maximum number C_{PDCCH}^{max, (X, Y), μ} | | |
|---|---|---|---|
| | of non-overlapped CCEs per span for | | |
| | combination (X, Y) and per serving cell | | |
| μ | (2, 2) | (4, 3) | (7, 3) |
| 0 | 18 | 36 | 56 |
| 1 | 18 | 36 | 56 |

If a UE:
does not report pdcch-BlindDetectionCA or is not provided BDFactorR, γ=R,
reports pdcch-BlindDetectionCA, the UE can be indicated by BDFactorR either γ=1 or γ=R.

If a UE is configured with N_{cells,0}^{DL,μ}+N_{cells,1}^{DL,μ} downlink cells for which the UE is not provided monitoringCapabilityConfig-r16, or is provided monitoringCapabilityConfig-r16=r15monitoringcapability but not provided CORESETPoolIndex, with associated PDCCH candidates monitored in the active DL BWPs of the scheduling cells using SCS configuration μ where Σ_{μ=0}³(N_{cells,0}^{DL,μ}+γ·N_{cells,1}^{DL,μ})≤N_{cells}^{cap}, the UE is not required to monitor, on the active DL BWPs of the scheduling cells,
more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per slot for each scheduled cell when the scheduling cell is from the N_{cells,0}^{DL,μ} downlink cells, or
more than M_{PDCCH}^{max,slot,μ}=γ·M_{PDCCH}^{max,slot,μ} PDCCH candidates or more than C_{PDCCH}^{max,slot,μ}=γ·C_{PDCCH}^{max,slot,μ} non-overlapped CCEs per slot for each scheduled cell when the scheduling cell is from the N_{cells,1}^{DL,μ} downlink cells,
more than M_{PDCCH}^{max,slot,μ} PDCCH candidates or more than C_{PDCCH}^{max,slot,μ} non-overlapped CCEs per slot for CORESETs with same coresetPoolIndex value for each scheduled cell when the scheduling cell is from the N_{cells,1}^{DL,μ} downlink cells.

N_{cells}^{cap} is replaced by N_{cells,r15}^{cap-r16}, if a UE is configured with downlink cells for which the UE is provided both monitoringCapabilityConfig-r16=r15monitoringcapability and monitoringCapabilityConfig-r16=r16monitoringcapability.

If a UE:
is configured with N_{cells,0}^{DL,μ}+N_{cells,1}^{DL,μ} downlink cells for which the UE is not provided monitoringCapabilityConfig, or is provided monitoringCapabilityConfig-r16=r15monitoringcapability but not provided coresetPoolIndex,
with associated PDCCH candidates monitored in the active DL BWPs of the scheduling cell(s) using SCS configuration μ, where Σ_{μ=0}³(N_{cells,0}^{DL,μ}+γ·N_{cells,1}^{DL,μ})>N_{cells}^{cap}, and
a DL BWP of an activated cell is the active DL BWP of the activated cell, and a DL BWP of a deactivated cell is the DL BWP with index provided by firstActiveDownlinkBWP-Id for the deactivated cell,
   the UE is not required to monitor more than M_{PDCCH}^{total,slot,μ}=└N_{cells}^{cap}·M_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ PDCCH candidates or more than C_{PDCCH}^{total,slot,μ}=└N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ non- overlapped CCEs per slot on the active DL BWP(s) of scheduling cell(s) from the N_{cells,0}^{DL,μ}+N_{cells,1}^{DL,μ} downlink cells. N_{cells}^{cap} is replaced by N_{cells,r15}^{cap-r16} if a UE is configured with downlink cells for which the UE is provided both monitoringCapabilityConfig-r16=r15monitoringcapability and monitoringCapabilityConfig-r16=r16monitoringcapability.

For each scheduled cell from the N_{cells,0}^{DL,μ} downlink cells, the UE is not required to monitor on the active DL BWP with SCS configuration μ of the scheduling cell more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot.

For each scheduled cell from the D_{cells,1}^{DL,μ} downlink cells, the UE is not required to monitor on the active DL BWP with SCS configuration μ of the scheduling cell:
more than min(γ·M_{PDCCH}^{max,slot,μ},M_{PDCCH}^{total,slot,μ}) PDCCH candidates or more than min(γ·C_{PDCCH}^{max,slot,μ},C_{PDCCH}^{total,slot,μ}) non-overlapped CCEs per slot,
more than min(M_{PDCCH}^{max,slot,μ},M_{PDCCH}^{total,slot,μ}) PDCCH candidates or more than min(γ·C_{PDCCH}^{max,slot,μ},C_{PDCCH}^{total,slot,μ}) non-overlapped CCEs per slot for CORESETs with same coresetPoolIndex value.

If a UE is configured with N_{cells,r16}^{DL,μ} downlink cells for which the UE is provided monitoringCapabilityConfig=r16monitoringcapability and with associated PDCCH candidates monitored in the active DL BWPs of the scheduling cells using SCS configuration μ, and with N_{cells,r16}^{DL,(X,Y),μ} of the N_{cells,r16}^{DL,μ} downlink cells using combination (X, Y) for PDCCH monitoring, where Σ_{μ=0}¹N_{cells,r16}^{DL,μ}≤N_{cells}^{cap-r16}, the UE is not required to monitor, on the active DL BWP of the scheduling cell, more than M_{PDCCH}^{total,(X,Y),μ}=M_{PDCCH}^{max,(X,Y),μ} PDCCH candidates or more than C_{PDCCH}^{total,(X,Y),μ}=C_{PDCCH}^{max,(X,Y),μ} non-overlapped CCEs per span for each scheduled cell when the scheduling cell is from the N_{cells,r16}^{DL,(X,Y),μ} downlink cells. If a UE is configured with downlink cells for which the UE is provided both monitoringCapabilityConfig=r15monitoringcapability and monitoringCapabilityConfig=r16monitoringcapability, N_{cells}^{cap-r16} is replaced by N_{cells,r16}^{cap-r16}.

If a UE is configured only with N_{cells,r16}^{DL,μ} downlink cells for which the UE is provided monitoringCapabilityConfig=r16monitoringcapability and with associated PDCCH candidates monitored in the active DL BWPs of the scheduling cells using SCS configuration μ, and with N_{cells,r16}^{CL(X,Y),μ} of the N_{cells,r16}^{DL,μ} downlink cells using combination (X, Y) for PDCCH monitoring, where Σ_{μ=0}¹N_{cells,r16}^{DL,μ}>N_{cells}^{cap-r16}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,(X,Y),μ}=└N_{cells}^{cap-r16}·M_{PDCCH}^{max,(X,Y),μ}·N_{cells,r16}^{DL,(X,Y),μ}/Σⱼ₌₀¹N_{cells,r16}^{DL,j}┘ PDCCH candidates or more than C_{PDCCH}^{total,(X,Y),μ}=└N_{cells}^{cap-r16}·C_{PDCCH}^{max,(X,Y),μ}·N_{cells,r16}^{DL,(X,Y),μ}/Σⱼ₌₀¹N_{cells,r16}^{DL,j}┘ non-overlapped CCEs
per set of spans on the active DL BWP(s) of all scheduling cell(s) from the N_{cells,r16}^{DL,(X,Y),μ} downlink cells within every X symbols, if the union of PDCCH monitoring occasions on all scheduling cells from the N_{cells,r16}^{DL,(X,Y),μ} downlink cells results to PDCCH monitoring according to the combination (X, Y) and any pair of spans in the set is within Y symbols, where first X symbols start at a first symbol with a PDCCH monitoring occasion and next X symbols start at a first symbol with a PDCCH monitoring occasion that is not included in the first X symbols,
per set of spans across the active DL BWP(s) of all scheduling cells from the N_{cells,r16}^{DL,(X,Y),μ} downlink cells, with at most one span per scheduling cell for each set of spans, otherwise,
where N_{cells,r16}^{DL,j} is a number of configured cells with associated PDCCH candidates monitored in the active DL BWPs of the scheduling cells using SCS configuration j. If a UE is configured with downlink cells for which the UE is provided both monitoringCapabilityConfig=r15monitoringcapability and monitoringCapabilityConfig=r16monitoringcapability, N_{cells}^{cap-r16} is replaced by N_{cells,r16}^{cap-r16}.

For each scheduled cell form the N_{cells,r16}^{DL,(X,Y),μ} downlink cells using combination (X, Y), the UE is not required to monitor on the active DL BWP with SCS configuration μ of the scheduling cell, more than min(M_{PDCCH}^{max,(X,Y),μ},M_{PDCCH}^{total,(X,Y),μ}) PDCCH candidates or more than min(C_{PDCCH}^{max,(X,Y),μ},C_{PDCCH}^{total,(X,Y),μ}) non-overlapped CCEs per span.

A UE does not expect to be configured CSS sets that result to corresponding total, or per scheduled cell, numbers of monitored PDCCH candidates and non-overlapped CCEs per slot or per span that exceed the corresponding maximum numbers per slot or per span, respectively.

For same cell scheduling or for cross-carrier scheduling, a UE does not expect a number of PDCCH candidates, and a number of corresponding non-overlapped CCEs per slot or per span on a secondary cell to be larger than the corresponding numbers that the UE is capable of monitoring on the secondary cell per slot or per span, respectively. If a UE is provided monitoringCapabilityConfig=r16monitoringcapability for the primary cell, except the first span of each slot, the UE does not expect a number of PDCCH candidates and a number of corresponding non-overlapped CCEs per span on the primary cell to be larger than the corresponding numbers that the UE is capable of monitoring on the primary cell per span.

For cross-carrier scheduling, the number of PDCCH candidates for monitoring and the number of non-overlapped CCEs per span or per slot are separately counted for each scheduled cell.

For all search space sets within a slot n or within a span in slot n, denote by s_{css} a set of CSS sets with cardinality of I_{css} and by Sᵤₛₛ a set of USS sets with cardinality of Jᵤₛₛ. The location of USS sets sⱼ, 0≤j<Jᵤₛₛ, in Sᵤₛₛ is according to an ascending order of the search space set index.

Denote by M_{S}_{ᵤₛₛ}₍ᵢ₎^{(L)}, 0≤i<I_{css}, the number of counted PDCCH candidates for monitoring for CSS set S_{css}(i) and by M_{S}_{ᵤₛₛ}₍ⱼ₎^{(L)}, 0≤j<Jᵤₛₛ, the number of counted PDCCH candidates for monitoring for USS set Sᵤₛₛ(j).

For the CSS sets, a UE monitors

$${M}_{PDCCH}^{CSS} = {\sum }_{i = 0}^{{I}_{css} - 1} {\sum }_{L} {M}_{{s}_{css} ( i )}^{( L )}$$

PDCCH candidates requiring a total of C_{PDCCH}^{CSS} non-overlapping CCEs in a slot or in a span.

The UE allocates PDCCH candidates for monitoring to USS sets for the primary cell having an active DL BWP with SCS configuration μ in a slot if the UE is not provided monitoringCapabilityConfig for the primary cell or if the UE is provided monitoringCapabilityConfig=r15monitoringcapability for the primary cell, or in the first span of each slot if the UE is provided monitoringCapabilityConfig=r16monitoringcapability for the primary cell, according to the following pseudocode. If for the USS sets for scheduling on the primary cell the UE is not provided coresetPoolIndex for first CORESETs, or is provided coresetPoolIndex with value 0 for first CORESETs, and is provided coresetPoolIndex with value 1 for second CORESETs, and if min(γ·M_{PDCCH}^{max,slot,μ},M_{PDCCH}^{total,slot,μ})>min(M_{PDCCH}^{max,slot,μ},M_{PDCCH}^{total,slot,μ}) or min(γ·C_{PDCCH}^{max,slot,μ},C_{PDCCH}^{total,slot,μ})>min(C_{PDCCH}^{max,slot,μ},C_{PDCCH}^{total,slot,μ}), the following pseudocode applies only to USS sets associated with the first CORESETs. A UE does not expect to monitor PDCCH in a USS set without allocated PDCCH candidates for monitoring. In the following pseudocode, if the UE is provided monitoringCapabilityConfig=r16monitoringcapability for the primary cell, M_{PDCCH}^{max,slot,μ} and C_{PDCCH}^{max,slot,μ} are replaced by M_{PDCCH}^{max,(X,Y),μ} and C_{PDCCH}^{max,(X,Y),μ} respectively, and M_{PDCCH}^{total,slot,μ} and C_{PDCCH}^{total,slot,μ} are replaced by M_{PDCCH}^{total,(X,Y),μ} and C_{PDCCH}^{total,(X,Y),μ} respectively.

Denote by V_{CCE}(Sᵤₛₛ(j)) the set of non-overlapping CCEs for search space set sᵤₛₛ(j) and by [symbol] (V_{CCE}(Sᵤₛₛ(j))) the cardinality of V_{CCE}(Sᵤₛₛ(j)) where the non-overlapping CCEs for search space set Sᵤₛₛ(j) are determined considering the allocated PDCCH candidates for monitoring for the CSS sets and the allocated PDCCH candidates for monitoring for all search space sets Sᵤₛₛ(k), 0≤k≤j.

Set M_{PDCCH}^{uss} = min(M_{PDCCH}^{max,slot,μ}, M_{PDCCH}^{total,slot,μ}) − M_{PDCCH}^{css}
Set C_{PDCCH}^{uss} = min(C_{PDCCH}^{max,slot,μ}, C_{PDCCH}^{total,slot,μ}) − C_{PDCCH}^{css}
Set J = 0
$while {\sum }_{L} {M}_{{S}_{uss} ( j )}^{( L )} \leq {M}_{PDCCH}^{uss} AND ( {V}_{CCE} ( {S}_{uss} ( j ) ) ) \leq {C}_{PDCCH}^{uss}$
$allocate {\sum }_{L} {M}_{{S}_{uss} ( j )}^{( L )} PDCCH candidates for monitoring to$
USS set Sᵤₛₛ(j)
${M}_{PDCCH}^{uss} = {M}_{PDCCH}^{uss} - {\sum }_{L} {M}_{{S}_{uss} ( j )}^{( L )} ;$
C_{PDCCH}^{uss} = C_{PDCCH}^{uss} − [symbol] (V_{CCE}(Sᵤₛₛ(j)));
j = j + 1;
end while.

If a UE
is configured for single cell operation or for operation with carrier aggregation in a same frequency band, and
monitors PDCCH candidates in overlapping PDCCH monitoring occasions in multiple CORESETs that have been configured with same or different qcl-Type set to ‘typeD’ properties on active DL BWP(s) of one or more cells,
   the UE monitors PDCCHs only in a CORESET, and in any other CORESET from the multiple CORESETs that have been configured with qcl-Type set to same ‘typeD’ properties as the CORESET, on the active DL BWP of a cell from the one or more cells:
the CORESET corresponds to the CSS set with the lowest index in the cell with the lowest index containing CSS, if any; otherwise, to the USS set with the lowest index in the cell with lowest index,
the lowest USS set index is determined over all USS sets with at least one PDCCH candidate in overlapping PDCCH monitoring occasions,
for the purpose of determining the CORESET, a SS/PBCH block is considered to have different QCL ‘typeD’ properties than a CSI-RS,
for the purpose of determining the CORESET, a first CSI-RS associated with a SS/PBCH block in a first cell and a second CSI-RS in a second cell that is also associated with the SS/PBCH block are assumed to have same QCL ‘typeD’ properties,
the allocation of non-overlapping CCEs and of PDCCH candidates for PDCCH monitoring is according to all search space sets associated with the multiple CORESETs on the active DL BWP(s) of the one or more cells,
the number of active TCI states is determined from the multiple CORESETs.

If a UE
is configured for single cell operation or for operation with carrier aggregation in a same frequency band, and
monitors PDCCH candidates in overlapping PDCCH monitoring occasions in multiple CORESETs where none of the CORESETs has TCI-states configured with gel-Type set to ‘typeD’,
the UE is required to monitor PDCCH candidates in overlapping PDCCH monitoring occasions for search space sets associated with different CORESETs.

For a scheduled cell and at any time, a UE expects to have received at most 16 PDCCHs for DCI formats with CRC scrambled by C-RNTI, CS-RNTI, or MCS-C-RNTI scheduling 16 PDSCH receptions for which the UE has not received any corresponding PDSCH symbol and at most 16 PDCCHs for DCI formats with CRC scrambled by C-RNTI, CS-RNTI, or MCS-C-RNTI scheduling 16 PUSCH transmissions for which the UE has not transmitted any corresponding PUSCH symbol.

If a UE is not provided monitoringCapabilityConfig=r16monitoringcapability for any serving cell, and
is not configured for NR-DC operation and indicates through pdcch-BlindDetectionCA a capability to monitor PDCCH candidates for N_{cells}^{cap}≥4 downlink cells and the UE is configured with N_{cells}^{DL}>4 downlink cells or N_{cells}^{UL}>4 uplink cells, or
is configured with NR-DC operation and for a cell group with N_{cells}^{DL} downlink cells or N_{cells}^{UL} uplink cells,
   the UE expects to have respectively received at most 16·N_{cells}^{cap} PDCCHs for
DCI formats with CRC scrambled by a C-RNTI, or a CS-RNTI, or a MCS-C-RNTI scheduling 16·N_{cells}^{cap} PDSCH receptions for which the UE has not received any corresponding PDSCH symbol over all N_{cells}^{DL} downlink cells,
DCI formats with CRC scrambled by a C-RNTI, or a CS-RNTI, or a MCS-C-RNTI scheduling 16·N_{cells}^{cap} PUSCH transmissions for which the UE has not transmitted any corresponding PUSCH symbol over all N_{cells}^{UL} uplink cells.

If a UE is provided monitoringCapabilityConfig=r16monitoringcapability for all serving cells, and
is not configured for NR-DC operation and indicates through pdcch-MonitoringCA a capability to monitor PDCCH candidates for N_{cells}^{cap-r16}≥2 downlink cells and the UE is configured with N_{cells}^{DL}>2 downlink cells or N_{cells}^{UL}>2 uplink cells, or
is configured with NR-DC operation and for a cell group with N_{cells}^{DL} downlink cells or N_{cells}^{UL} uplink cells,
   the UE expects to have respectively received at most 16·N_{cells}^{cap-r16} PDCCHs for
DCI formats with CRC scrambled by a C-RNTI, or a CS-RNTI, or a MCS-C-RNTI scheduling 16·N_{cells}^{cap-r16} PDSCH receptions for which the UE has not received any corresponding PDSCH symbol over all N_{cells}^{DL} downlink cells,
DCI formats with CRC scrambled by a C-RNTI, or a CS-RNTI, or a MCS-C-RNTI scheduling 16·N_{cells}^{cap-r16} PUSCH transmissions for which the UE has not transmitted any corresponding PUSCH symbol over all N_{cells}^{UL} uplink cells.

If a UE is provided monitoringCapabilityConfig=r16monitoringcapability for at least one serving cell and is not provided monitoringCapabilityConfig=r16monitoringcapability for at least one serving cell, and
is not configured for NR-DC operation, and indicates a capability to monitor PDCCH candidates for N_{cells,r15}^{cap-r16}≥1 downlink cells and N_{cells,r16}^{cap-r16}≥1 downlink cells, and the UE is configured with N_{cells}^{DL}>1 downlink cell or N_{cells}^{UL}>1 uplink cell, or
is configured with NR-DC operation and for a cell group with N_{cells}^{DL} downlink cells or N_{cells}^{UL} uplink cells,
   the UE expects to have respectively received
at most 16·N_{cells,r16}^{cap-r16} PDCCHs for DCI formats with CRC scrambled by a C-RNTI, or a CS-RNTI, or a MCS-C-RNTI scheduling 16·N_{cells,r15}^{cap-r16} PDSCH receptions for which the UE has not received any corresponding PDSCH symbol over all serving cells that are not provided monitoringCapabilityConfig=r16monitoringcapability,
at most 16·N_{cells,r15}^{cap-r16} PDCCHs for DCI formats with CRC scrambled by a C-RNTI, or a CS-RNTI, or a MCS-C-RNTI scheduling 16·N_{cells,r15}^{cap-r16} PUSCH transmissions for which the UE has not transmitted any corresponding PUSCH symbol over all serving cells that are not provided monitoringCapabilityConfig=r16monitoringcapability,
at most 16·N_{cells,r16}^{cap-r16} PDCCHs for DCI formats with CRC scrambled by a C-RNTI, or a CS-RNTI, or a MCS-C-RNTI scheduling 16·N_{cells,r16}^{cap-r16} PDSCH receptions for which the UE has not received any corresponding PDSCH symbol over all serving cells that are provided monitoringCapabilityConfig=r16monitoringcapability,
at most 16·N_{cells,r16}^{cap-r16} PDCCHs for DCI formats with CRC scrambled by a C-RNTI, or a CS-RNTI, or a MCS-C-RNTI scheduling 16·N_{cells,r16}^{cap-r16} PUSCH transmissions for which the UE has not transmitted any corresponding PUSCH symbol over all serving cells that are provided monitoringCapabilityConfig=r16monitoringcapability.

If a UE
is configured to monitor a first PDCCH candidate for a DCI format 0_0 and a DCI format 1_0 from a CSS set and a second PDCCH candidate for a DCI format 0_0 and a DCI format 1_0 from a USS set in a CORESET with index zero on an active DL BWP, and
the DCI formats 0_0/1_0 associated with the first PDCCH candidate and the DCI formats 0_0/1_0 associated with the second PDCCH candidate have same size, and
the UE receives the first PDCCH candidate and the second PDCCH candidate over a same set of CCEs, and
the first PDCCH candidate and the second PDCCH candidate have identical scrambling, and
the DCI formats 0_0/1_0 for the first PDCCH candidate and the DCI formats 0_0/1_0 for the second PDCCH candidate have CRC scrambled by either C-RNTI, or MCS-C-RNTI, or CS-RNTI,
   the UE decodes only the DCI formats 0_0/1_0 associated with the first PDCCH candidate.

If a UE detects a DCI format with inconsistent information, the UE discards all the information in the DCI format.

A UE configured with a bandwidth part indicator in a DCI format determines, in case of an active DL BWP or of an active UL BWP change, that the information in the DCI format is applicable to the new active DL BWP or UL BWP, respectively.

For unpaired spectrum operation, if a UE is not configured for PUSCH/PUCCH transmission on serving cell c₂, the UE does not expect to monitor PDCCH on serving cell c₁ if the PDCCH overlaps in time with SRS transmission (including any interruption due to uplink or downlink RF retuning time [10, TS 38.133]) on serving cell c₂ and if the UE is not capable of simultaneous reception and transmission on serving cell c₁ and serving cell c₂.

If a UE is provided resourceBlocks and symbolsInResourceBlock in RateMatchPattern, or if the UE is additionally provided periodicityAndPattern in RateMatchPattern, the UE can determine a set of RBs in symbols of a slot that are not available for PDSCH reception as described in [6, TS 38.214]. If a PDCCH candidate in a slot is mapped to one or more REs that overlap with REs of any RB in the set of RB s in symbols of the slot, the UE does not expect to monitor the PDCCH candidate.

A UE does not expect to be configured with dci-FormatsSL and dci-FormatsExt in a same USS.

In the downlink, the gNB can dynamically allocate resources to UEs via the C-RNTI on PDCCH(s). A UE monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to CS-RNTI can either signal and activate the configured downlink assignment, or deactivate it; i.e., a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell, if they overlap in time. Otherwise a downlink reception according to the configured downlink assignment is assumed, if activated.

The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

PUSCH may be scheduled with DCI on PDCCH, or a semi-static configured grant may be provided over RRC, where two types of operation are supported:
The first PUSCH is triggered with a DCI, with subsequent PUSCH transmissions following the RRC configuration and scheduling received on the DCI, or
The PUSCH is triggered by data arrival to the UE's transmit buffer and the PUSCH transmissions follow the RRC configuration.

In the uplink, the gNB can dynamically allocate resources to UEs via the C-RNTI on PDCCH(s). A UE monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor cancelled transmission indications using CI-RNTI on a PDCCH. If a UE receives the cancelled transmission indication, the UE shall cancel the PUSCH transmission from the earliest symbol overlapped with the resource or the SRS transmission overlapped with the resource indicated by cancellation.

In addition, with Configured Grants, the gNB can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it; i.e., a PDCCH addressed to CS-RNTI indicates that the uplink grant can be implicitly reused according to the periodicity defined by RRC, until deactivated.

If the UE is not configured with enhanced intra-UE overlapping resources prioritization, the dynamically allocated uplink transmission overrides the configured uplink grant in the same serving cell, if they overlap in time. Otherwise, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels that have data to be transmitted and which are multiplexed or can be multiplexed in MAC PDUs associated with the overlapping resources. Similarly, in case a configured uplink grant transmission or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB to schedule a retransmission. The UE may also be configured by the gNB to transmit the stored MAC PDU as a new transmission using a subsequent resource of the same configured uplink grant configuration when an explicit retransmission grant is not provided by the gNB.

Retransmissions other than repetitions are explicitly allocated via PDCCH(s) or via configuration of a retransmission timer.

The UE may be configured with up to 12 active configured uplink grants for a given BWP of a serving cell. When more than one is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When SUL is configured, the network should ensure that an active configured uplink grant on SUL does not overlap in time with another active configured uplink grant on the other UL configuration.

For both dynamic grant and configured grant, for a transport block, two or more repetitions can be in one slot, or across slot boundary in consecutive available slots with each repetition in one slot. For both dynamic grant and configured grant Type 2, the number of repetitions can be also dynamically indicated in the L1 signalling. The dynamically indicated number of repetitions shall override the RRC configured number of repetitions, if both are present.

In Multiple Transmit/Receive Point (multi-TRP) operation, a serving cell can schedule UE from two TRPs, providing better PDSCH coverage, reliability and/or data rates.

There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

The downlink/uplink physical-layer processing of transport channels includes the following steps:
Transport block CRC attachment;
Code block segmentation and code block CRC attachment;
Channel coding: LDPC coding;
Physical-layer hybrid-ARQ processing;
Rate matching;
Scrambling;
Modulation: π/2 BPSK (only for uplink with transform precoding), QPSK, 16QAM, 64QAM and 256QAM;
Layer mapping;
(for uplink only) Transform precoding (enabled/disabled by configuration), and pre-coding;
Mapping to assigned resources and antenna ports.

The UE may assume that at least one symbol with demodulation reference signal is present on each layer in which PDSCH is transmitted to a UE, and up to 3 additional DMRS can be configured by higher layers. Phase Tracking RS may be transmitted on additional symbols to aid receiver phase tracking.

The UE transmits at least one symbol with demodulation reference signal on each layer on each frequency hop in which the PUSCH is transmitted, and up to 3 additional DMRS can be configured by higher layers. Phase Tracking RS may be transmitted on additional symbols to aid receiver phase tracking.

When the UE is scheduled to receive PDSCH by a DCI, the Time domain resource assignment field value m of the DCI provides a row index m+1 to an allocation table. The indexed row defines the slot offset K₀, the start and length indicator SLIV, or directly the start symbol S and the allocation length L, and the PDSCH mapping type to be assumed in the PDSCH reception.

Given the parameter values of the indexed row:
The slot allocated for the PDSCH is Kₛ, where

$${K}_{s} = ⌊ n \cdot \frac{{2}^{{μ}_{PDSCH}}}{{2}^{{μ}_{PDCCH}}} ⌋ + {K}_{0} + ⌊ ( \frac{{N}_{slot , offset , PDCCH}^{CA}}{{2}^{{μ}_{offset , PDCCH}}} - \frac{{N}_{slot , offset , PDSCH}^{CA}}{{2}^{{μ}_{offset , PDSCH}}} ) \cdot {2}^{{μ}_{PDSCH}} ⌋ ,$$

if UE is configured with ca-SlotOffset for at least one of the scheduled and scheduling cell, and

$${K}_{s} = ⌊ n \cdot \frac{{2}^{{μ}_{PDSCH}}}{{2}^{{μ}_{PDCCH}}} ⌋ + {K}_{0} ,$$

otherwise, and where n is the slot with the scheduling DCI, and K₀ is based on the numerology of PDSCH, and μ_{PDSCH} and μ_{PDCCH} are the subcarrier spacing configurations for PDSCH and PDCCH, respectively, and
N_{slot, offset, PDCCH}^{CA} and μ_{offset,PDCCH} are the N_{slot, offset}^{CA} and the μ_{offset}, respectively, which are determined by higher-layer configured ca-SlotOffset, for the cell receiving the PDCCH respectively, N_{slot, offset, PDSCH}^{CA} and μ_{offset,PDSCH} are the N_{slot, offset}^{CA} and the μ_{offset}, respectively, which are determined by higher-layer configured ca-SlotOffset for the cell receiving the PDSCH.

When the UE is scheduled to transmit a transport block and no CSI report, or the UE is scheduled to transmit a transport block and a CSI report(s) on PUSCH by a DCI, the ‘Time domain resource assignment’ field value m of the DCI provides a row index m+1 to an allocated table. The indexed row defines the slot offset K2, the start and length indicator SLIV, or directly the start symbol S and the allocation length L, the PUSCH mapping type, and the number of repetitions (if numberOfRepetitions is present in the resource allocation table) to be applied in the PUSCH transmission.

When the UE is scheduled to transmit a PUSCH with no transport block and with a CSI report(s) by a ‘CSI request’ field on a DCI, the ‘Time domain resource assignment’ field value m of the DCI provides a row index m+1 to an allocated table. The indexed row defines the start and length indicator SLIV, or directly the start symbol S and the allocation length L, and the PUSCH mapping type to be applied in the PUSCH transmission and the K₂ value is determined as

$${K}_{2} = {max}_{j} {Y}_{j} ( m + 1 ) ,$$

where Yⱼ(m+1) is the (m+1)th entry of Yⱼ and Yⱼ, j=0, . . . , N_{Rep}−1 are the corresponding list entries of the higher layer parameter
reportSlotOffsetListDCI-0-2, if PUSCH is scheduled by DCI format 0_2 and reportSlotOffsetListDCI-0-2 is configured;
reportSlotOffsetListDCI-0-1, if PUSCH is scheduled by DCI format 0_1 and reportSlotOffsetListDCI-0-1 is configured;
reportSlotOffsetList, otherwise;

in CSI-ReportConfig for the N_{Rep} triggered CSI Reporting Settings.
The slot Kₛ where the UE shall transmit the PUSCH is determined by K₂ as Kₛ=

$$⌊ n \cdot \frac{{2}^{{μ}_{PUSCH}}}{{2}^{{μ}_{PDCCH}}} ⌋ + {K}_{2} + ⌊ \frac{{N}_{slot , offset , PDCCH}^{CA}}{{2}^{{μ}_{offset , PDCCH}}} - \frac{{N}_{slot , offset , PUSCH}^{CA}}{{2}^{{μ}_{offset , PUSCH}}} ) \cdot {2}^{{μ}_{PUSCH}} ⌋ ,$$

if UE is configured with ca-SlotOffset for at least one of the scheduled and scheduling cell,

$${K}_{s} = ⌊ n \cdot \frac{{2}^{{μ}_{PUSCH}}}{{2}^{{μ}_{PDCCH}}} ⌋ + {K}_{2} ,$$

otherwise, and where n is the slot with the scheduling DCI, K₂ is based on the numerology of PUSCH, and μ_{PUSCH} and μ_{PDCCH} are the subcarrier spacing configurations for PUSCH and PDCCH, respectively,

N_{slot, offset, PDCCH}^{CA} and μ_{offset,PDCCH} are the N_{slot, offset}^{CA} and the μ_{offset}, respectively, which are determined by higher-layer configured ca-SlotOffset for the cell receiving the PDCCH, N_{slot, offset, PUSCH}^{CA} and μ_{offset,PUSCH} are the N_{slot, offset}^{CA} and the μ_{offset},respectively, which are determined by higher-layer configured ca-SlotOffset for the cell transmitting the PUSCH.

The information element ca-SlotOffset provides slot offset between the primary cell (PCell/PSCell) and the SCell in unaligned frame boundary with slot alignment and partial SFN alignment inter-band CA. Based on this field, the UE determines the time offset of the SCell. The granularity of this field is determined by the reference SCS for the slot offset (i.e., the maximum of PCell/PSCell lowest SCS among all the configured SCSs in DL/UL SCS-SpecificCarrierList in ServingCellConfigCommon or ServingCellConfigCommonSIB and this serving cell's lowest SCS among all the configured SCSs in DL/UL SCS-SpecificCarrierList in ServingCellConfigCommon or ServingCellConfigCommonSIB). The Network configures at most single non-zero offset duration in ms (independent on SCS) among CCs in the unaligned CA configuration. If the field is absent, the UE applies the value of 0. The slot offset value can only be changed with SCell release and add. Herein, scs-SpecificCarrierList provides a set of carriers for different subcarrier spacings (numerologies), which is defined in relation to Point A. The network configures a scs-SpecificCarrier at least for each numerology (SCS) that is used e.g., in a BWP.

For carrier aggregation of cells with unaligned frame boundaries, the slot offset N_{slot, offset}^{CA} between a PCell/PScell and an SCell is determined by higher-layer parameter Ca-SlotOffset for the SCell. The quantity μ_{offset} is defined as the maximum of the lowest subcarrier spacing configuration among the subcarrier spacings given by the higher-layer parameters scs-SpecificCarrierList configured for PCell/PSCell and the SCell, respectively. The slot offset N_{slot, offset}^{CA} fulfills
when the lowest subcarrier spacing configuration among the subcarrier spacings configured for the cell is μ=2 for both cells or μ=3 for both cells, the start of slot 0 for the cell whose point A has a lower frequency coincides with the start of slot qN_{slot, offset}^{CA} mod Nₛₗₒₜ^{frame,μ}^{_{offset}} for the other cell where q=−1 if point A of the PCell/PSCell has a frequency lower than the frequency of point A for the SCell, otherwise q=1;
otherwise, the start of slot 0 for the cell with the lower subcarrier spacing of the lowest subcarrier spacing given by the higher-layer parameters scs-SpecificCarrierList configured for the two cells, or the Pcell/PSCell if both cells have the same lowest subcarrier spacing given by the higher-layer parameters scs-SpecificCarrierList configured for the two cells, coincides with the start of slot qN_{slot, offset}^{CA} mod Nₛₗₒₜ^{frame,μ}^{_{offset}} for the other cell where q=−1 if the lowest subcarrier spacing configuration given by scs-SpecificCarrierList of the PCell/PSCell is smaller than or equal to the lowest subcarrier spacing given by scs-SpecificCarrierList for the SCell, otherwise q=1.

HARQ operation is supported for DL reception. Asynchronous Incremental Redundancy HARQ is supported. The gNB provides the UE with the HARQ-ACK feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group. The UE may be configured to receive code block group-based transmissions where retransmissions may be scheduled to carry a sub-set of all the code blocks of a TB.

HARQ operation is supported for UL transmission. Asynchronous Incremental Redundancy HARQ is supported. The gNB schedules each uplink transmission and retransmission using the uplink grant on DCI. For operation with shared spectrum channel access, UE can also retransmit on configured grants. The UE may be configured to transmit code block group-based transmissions where retransmissions may be scheduled to carry a sub-set of all the code blocks of a transport block.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

In case of CA, the multi-carrier nature of the physical layer is only exposed to the MAC layer for which one HARQ entity is required per serving cell. In both uplink and downlink, there is one independent HARQ entity per serving cell and one transport block is generated per assignment/grant per serving cell in the absence of spatial multiplexing. Each transport block and its potential HARQ retransmissions are mapped to a single serving cell.

Physical uplink control channel (PUCCH) carries the Uplink Control Information (UCI) from the UE to the gNB. UCI includes at least hybrid automatic request acknowledgement (HARQ-ACK) information, scheduling request (SR), and channel state information (CSI).

UCI can be transmitted on a PUCCH or multiplexed in a PUSCH. UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH;
In all other cases UCI is multiplexed by rate matching PUSCH.

For configured grants operation with shared spectrum channel access, a CG-UCI (Configured Grant Uplink Control Information) is transmitted in PUSCH scheduled by configured uplink grant. For operation with shared spectrum channel access, multiplexing of CG-UCI and PUCCH carrying HARQ-ACK feedback can be configured by the gNB. If not configured, when PUCCH overlaps with PUSCH scheduled by a configured grant within a PUCCH group and PUCCH carries HARQ ACK feedback, PUSCH scheduled by configured grant is skipped.

Throughout the present disclosure, embodiments are described in terms of multiple PDSCHs or multiple PUSCHs that are jointly scheduled on multiple serving cells, such as a subset/set of cells from among one or more sets of co-scheduled cells.

The embodiments can apply to various other scenarios such as when a UE is jointly scheduled to receive/transmit multiple PDSCHs/PUSCHs:
from/to multiple transmission-reception points (TRPs) or other communication entities, such as multiple distributed units (DUs) or multiple remote radio heads (RRHs) and so on, for example, in a distributed MIMO operation, wherein TRPs/DUs/RRHs can be associated with one or more cells; or
in multiple time units, such as multiple slots or multiple transmission time intervals (TTIs); or
on multiple BWPs associated with one or more cells/carriers/TRPs, including multiple BWPs of a single serving cell/carrier for a UE with a capability of reception/transmission on multiple active BWPs; or
on one or more TRPs/cells, wherein the UE can receive/transmit more than one PDSCH/PUSCH on each co-scheduled TRP/cell; or
for multiple transport blocks (TBs), or for multiple codewords (CWs) corresponding to single TB or multiple TBs; or
for multiple semi-persistently scheduled PDSCHs (SPS PDSCHs) or for multiple configured grant PUSCHs (CG PUSCHs) that are jointly activated on one or multiple TRPs/cells.

Accordingly, any reference to “co-scheduled cells” can be replaced with/by “co-scheduled TRPs/DUs/RRHs”, or “co-scheduled slots/TTIs”, or “co-scheduled BWPs”, or “co-scheduled PDSCHs/PUSCHs”, or “co-scheduled TB s/CWs”, or “co-scheduled SPS-PDSCHs/CG-PUSCHs”, and so on. Similarly for other related terms, such as “multi-cell scheduling”, and so on.

Various embodiments of the present disclosure consider reception of multiple PDSCHs or transmission of multiple PUSCHs on respective cells, including carriers of a same cell such as on an UL carrier (also referred to as, a normal UL (NUL) carrier) or a supplemental UL (SUL) carrier. The embodiments also apply to cases where scheduling is for a mixture of PDSCHs and PUSCHs. For example, the UE can receive first PDSCHs on respective first cells and can transmit second PUSCHs on respective second cells, wherein the first PDSCHs and the second PUSCHs are jointly scheduled.

In one embodiment, a UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described herein. For convenience of presentation, such DCI format may be referred to as a multi-cell scheduling DCI (MC-DCI) format. The MC-DCI format can be a new DCI format, such as DCI format 0_3 for co-scheduled PUSCHs or 1_3 for co-scheduled PDSCHs. Additionally, the UE can be indicated via a DCI format such as the MC-DCI format, in a PDCCH or via a MAC CE in a PDSCH in a subset of a set of co-scheduled cells, wherein cells of the subset can change across different PDCCH monitoring occasions (Mos). For example, a first MC-DCI format in a first MO can indicate a first set/subset of co-scheduled cells, and a second DCI format in a second MO can indicate a second set/subset of co-scheduled cells.

In one example, multi-cell scheduling can also include operations related to DL/UL transmissions such as reporting HARQ-ACK information, beam/CSI measurement or reporting, transmission or reception of UL/DL reference signals, and so on.

In one example, the UE can be configured by higher layers, such as by a UE-specific RRC configuration, a number of sets of co-scheduled cells. For example, the UE can be configured a first set of cells, such as {cell #0, cell #1, cell #4, cell #7} and a second set {cell #2, cell #3, cell #5, cell #6}. The multiple sets of co-scheduled cells can be scheduled from a same scheduling cell or from different scheduling cells.

In one example, a set of co-scheduled cells can include a primary cell (PCell/PSCell) and one or more SCells. In another example, a set of co-scheduled cells can include only SCells. In one example, a scheduling cell can belong to a set of co-scheduled cells. In another example, the UE does not expect that a scheduling cell belongs to a set of co-scheduled cells.

In one example, per specifications of the system operation, a set of co-scheduled cells is defined as a set that includes all scheduled cells having a same scheduling cell, and additional higher layer configuration is not required for indication of the set of co-scheduled cells. Accordingly, a DCI format for multi-cell scheduling, or other complementary methods, can jointly schedule any number of scheduled cells that have a same scheduling cell. For example, a MC-DCI format can include a bitmap to indicate which of the scheduled cells are jointly scheduled.

In another example, a set of co-scheduled cells can have two or more scheduling cells. For example, a UE can receive a DCI format for scheduling multiple co-scheduled cells on a first scheduling cell in a first PDCCH monitoring occasion, or on a second scheduling cell in a second PDCCH monitoring occasion. The UE can receive a first MC-DCI format in a first PDCCH monitoring occasion on a first scheduling cell for scheduling a set of co-scheduled cells, and can receive a second MC-DCI format in a second PDCCH monitoring occasion on a second scheduling cell for scheduling a set of co-scheduled cells. The DCI format can be associated with any search space set type (CSS or USS) or can be restricted to be associated with USS sets. For example, the DCI format can be associated with multicast scheduling and have CRC scrambled by a G-RNTI and PDCCH candidates monitored according to CSS sets, or can be associated with unicast scheduling and have CRC scrambled by a C-RNTI and PDCCH candidates monitored according to USS sets. Such PDCCH monitoring from two scheduling cells can be simultaneous, for example in a same span of symbol or in a same slot, or can be non-overlapping, such as in different slots (per higher layer configuration, or per indication in a PDCCH or via a MAC CE). The UE may or may not expect that both the first scheduling cell and the second scheduling cell can schedule, through PDCCH transmissions in a same time interval such as a span or a slot, transmissions or receptions on a same cell. The UE can also monitor PDCCH for detection of a DCI format providing scheduling only on one cell from the set of co-scheduled cells (single-cell scheduling DCI format). For example, the UE can be configured to monitor PDCCH on a first scheduling cell for single-cell scheduling on a serving cell, and monitor PDCCH on a second scheduling cell for multi-cell scheduling on a set of co-scheduled cells that include the serving cell.

A UE can report one or more of: a maximum number of sets of co-scheduled cells, or a maximum number of cells within a set of co-scheduled cells, or a maximum total number of co-scheduled cells across different sets, or a maximum number of co-scheduled cells per PDCCH monitoring occasion, as capability to the gNB. In one example, that capability can depend on an operating frequency band or on a frequency range such as above or below 6 GHz.

Multi-cell scheduling can be an optional UE feature with capability signaling that can additionally be separate for PDSCH receptions and for PUSCH transmissions. For example, a UE can report a capability for a maximum number of {2, 4, 8, 16} co-scheduled cells for the DL and a maximum of {2, 4} co-scheduled cells for the UL. The UE can be configured a number of sets/subsets of co-scheduled cells such that the sizes of the sets/subsets do not exceed the corresponding values reported by the UE capability. For example, the UE can be configured separate sets of co-scheduled cells for PDSCH receptions compared to sets of co-scheduled cells for PUSCH transmissions.

A UE can also be configured a number of cells that do not belong to any of set of co-scheduled cells. For example, the UE can be configured a cell #8 that does not belong to either the first set or the second set of co-scheduled cells in the previous example.

In one example, restrictions can apply for co-scheduled cells and a UE can expect that co-scheduled cells in a corresponding set:
have a same numerology (SCS configuration and CP); or
have a same numerology for respective active DL/UL BWPs; or
have a same duplex configuration, for example, all cells have FDD configuration, or all cells have TDD configuration and, in case of a TDD configuration, also have a same UL-DL configuration; or
are within a same frequency band (intra-band CA) or within a same frequency range (such as FR1 or FR2 or FR2-1 or FR2-2); or
have a same licensing type, for example, all cells are licensed, or all cells are unlicensed.

In one example, the above restrictions may not apply to a scheduling cell if the scheduling cell belongs to a set of co-scheduled cells. For example, a scheduling cell can have a different SCS configuration than (other) cells in a set of co-scheduled cells. For example, a scheduling cell can be in FR1 and an FDD band, and jointly schedule a set of co-scheduled cells in FR2 and in TDD bands.

A serving cell can belong only to a single set of co-scheduled cells so that the sets of co-scheduled cells do not include any common cell, or can belong to multiple sets of co-scheduled cells to enable larger scheduling flexibility to a serving gNB. For example, a serving cell can belong to a first set of co-scheduled cells and to a second set of co-scheduled cells, for example when cells in the first and second sets of co-scheduled cells have a common feature such as a common numerology, duplex configuration, operating frequency band/range, and so on. Also, a serving cell can belong to both a first set of co-scheduled cells and to a second set of co-scheduled cells, when the serving cell has a first common feature with cells in the first set of co-scheduled cells and a second common feature with cells in the second set of co-scheduled cells, wherein the first common feature can be different from the second common feature. When a first cell using paired spectrum operation (FDD) and a second cell using unpaired spectrum operation (TDD) are in a same set of co-scheduled cells and a DCI format schedules a first PDSCH reception on the first cell and a second PDSCH reception on the second cell and the second PDSCH reception includes symbols that are UL symbols on the second cell, for example as determined based on an UL-DL configuration provided by a SIB or by UE-specific RRC signaling, the UE does not receive the second PDSCH over the UL symbols or does not receive the second PDSCH over any symbols on the second cell. Alternatively, the UE can apply rate matching for the second PDSCH around the UL symbols on the second cell, so that the UE receives the second PDSCH with an adjusted rate in other remaining symbols. Similar UE behaviors can apply when the first and second scheduled cells use unpaired spectrum operation with different UL-DL configurations, such as on different frequency bands.

In a first approach, a UE expects to be provided multi-cell scheduling for all cells in a set of co-scheduled cells. For example, for a first set of co-scheduled cells including cells {cell #1, cell #1, cell #4, cell #7}, a DCI format schedules PDSCH receptions or PUSCH transmissions on all four cells in the first set of co-scheduled cells {cell #0, cell #1, cell #4, cell #7}. When a UE is configured a first set and a second set of co-scheduled cells, in one example, the UE expects that there are no serving/scheduled cells configured in both the first and the second sets (that is, no overlap between the first and second sets). In another example, the first and second sets can have common element(s), that is, both the first set and the second set can include a first serving/scheduled cell. For example, the latter can apply when both the first and the second sets correspond to a same scheduling cell. For example, the first cell can be the scheduling cell. In one example, the MC-DCI format needs to indicate a set of co-scheduled cells, from the multiple sets of co-scheduled cells. For example, a first MC-DCI can indicate a first set of co-scheduled cells to jointly schedule all cells in the first set of co-scheduled cells, and a second MC-DCI can indicate a second set of co-scheduled cells to jointly schedule all cells in the second set of co-scheduled cells.

In a second approach, the UE can be provided multi-cell scheduling for a subset of a set of co-scheduled cells. For example, a DCI format can schedule PDSCH receptions or PUSCH transmissions on only two cells, such as {cell #0, cell #4}, from the first set of cells.

In a first option for the second approach, the subset of cells can be indicated by a MAC CE. Such a MAC CE command can include one or more of: an indication for activation or deactivation/release of a subset of cells; an indication for a number of sets of co-scheduled cells; or an indication for a number of subsets of co-scheduled cells from a corresponding number of sets of co-scheduled cells.

For example, a MAC CE activates a first subset of a set of co-scheduled cells and subsequent DCI format(s) for multi-cell scheduling apply to the first subset of cells activated by the MAC CE. The UE can receive another MAC CE command that deactivates the first subset of co-scheduled cells, or activates a second subset of co-scheduled cells, wherein the second subset can be a subset of the same set of co-scheduled cells or a subset of a different set of co-scheduled cells. If a UE receives a MAC CE that deactivates the first subset of co-scheduled cells, but does not activate a second subset of co-scheduled cells, in one alternative, the UE does not expect to receive a DCI format for multi-cell scheduling, and the UE may not monitor PDCCH according to respective search space sets, until the UE receives a new MAC CE that activates a second subset of co-scheduled cells. In another alternative, the UE can receive DCI format(s) for multi-cell scheduling even before receiving a new MAC CE that activates a second subset of co-scheduled cells, but the UE expects to be provided an indication for a subset of co-scheduled cells by the DCI format(s), or by using complementary methods, such as those described herein, for multi-cell scheduling.

In a second option for the second approach, the subset of the set of co-scheduled cells can be provided by a DCI format in a PDCCH/PDSCH. The subset of cells can change between PDCCH monitoring occasions (MOs) for PDSCH/PUSCH scheduling as indicated by a corresponding DCI format. For example, a first MC-DCI format in a first PDCCH MO indicates PDSCH or PUSCH scheduling on a first subset of cells, while a second MC-DCI format in a second PDCCH MO indicates PDSCH or PUSCH scheduling on a second subset of cells.

In a first example, a DCI format for multi-cell scheduling provides an index for a subset of cells that are co-scheduled such as a CIF value that corresponds to a subset of one or more cells from a set of co-scheduled cells. For example, UE-specific RRC signaling can indicate first/second/third/fourth indexes and corresponding first/second/third/fourth subsets that include one or more cells from a set of co-scheduled cells, wherein a subset can also include all cells from the set of co-scheduled cells. Then, a CIF field of 2 bits in a DCI format can provide a value that indicates the subset of scheduled cells. Such CIF refers, in general, to sets of co-scheduled cells, rather than individual scheduled cells, so can be referred to as “set-level” CIF (compared to “cell-level” CIF for the latter). The UE can be provided separate configuration for a first number of sets/subsets of co-scheduled cells for PDSCH reception, compared to a second number of sets/subsets of co-scheduled cells for PUSCH transmission. Therefore, the UE can be provided a first set of indexes for set-level CIFs for PDSCH receptions that are different from a second set of indexes for set-level CIFs for PUSCH transmissions. For example, the UE can be provided 4 bits for “set-level” CIF for PDSCH receptions, and 3 bits for “set-level” CIF for PUSCH transmissions. The set-level CIF can be also referred to as cell-set indicator function value or carrier-set indicator function value.

In one example, when using a two-stage method for joint scheduling of a set/subset of co-scheduled cells, as described herein, when the 1st stage DCI is on a first PDCCH on a first cell, and the 2nd stage DCI is on a first PDSCH on a second cell, and the first PDSCH schedules second PDSCHs/PUSCHs, in one option, the UE still considers the scheduling cell for the second PDSCHs/PUSCHs to be the first cell, and corresponding CIF association(s) are defined with respect to the first cell and configuration thereof. In another option, the UE considers the scheduling cell for the second PDSCHs/PUSCHs to be the second cell, and corresponding CIF association(s) are defined with respect to the second cell and configuration thereof.

In a second example, a DCI format can include a 1-bit flag field to indicate whether the DCI format is for single-cell scheduling or for multi-cell scheduling in order for a UE to accordingly interpret fields of the DCI format that may also include the CIF field. Then, for single-cell scheduling, the CIF field can be interpreted as in case of single-cell cross-carrier scheduling while for multi-cell scheduling the CIF field can be interpreted as indicating a subset from the set of co-scheduled cells. In one example, instead of an explicit 1-bit flag to indicate single-cell scheduling or multi-cell scheduling, the UE can be configured a number of sets/subsets of co-scheduled cells, some of which include only one scheduled cell and others include more than one scheduled cell. Therefore, the CIF values for single-cell scheduling can be separate from CIF values for multi-cell scheduling. For example, CIF values 0, 1, 2, 3 correspond to scheduling individual cells, and CIF values 4, 5, 6, 7 correspond to sets/subsets of co-scheduled cells and the functionality of the 1-bit flag can be absorbed in the CIF. Therefore, the UE can determine whether the DCI format is for single-cell scheduling or for multi-cell scheduling based on the CIF value.

In a third example, a DCI format for multi-cell scheduling provides a number of co-scheduled cells, and the indexes of the co-scheduled cells are provided by additional methods, such as by an additional DCI format or by higher layer signaling as described herein.

In a fourth example, a CIF field in a DCI format for multi-cell scheduling can be a bitmap mapping to the individual cells or subsets of cells from the set of co-scheduled cells. For example, when the UE is configured a maximum number of N scheduled cells, such as N=8 cells, associated with a scheduling cell, the UE can be configured a bitmap with N bits, wherein a value ‘1’ for a bit in the bitmap indicates scheduling on the corresponding cell, and a value ‘0’ for the bit in the bitmap indicates no scheduling on the corresponding cell. For example, the bitmap can be in ascending or descending order of cell indexes or (cell-level) CIF values or cell indexes for the scheduled cells. For example, the left-most bit (respectively, the right-most bit) can correspond to a scheduled cell with the smallest cell index or cell-level CIF, and the second left-most bit (respectively, the second right-most bit) can correspond to a scheduled cell with the second smallest cell index or cell-level CIF, and so on. For example, if the UE is configured a number of M scheduled cells, such as M=4 cells, that is less than a maximum supported number of N scheduled cells, such as N=8 cells, in one option, the bitmap can include 8 bits, and the remaining rightmost (respectively, the remaining leftmost) M−N bits, such as 8−4=4 bits, can be all zeros or all ones. In another option, the bitmap can include only M=4 bits.

In a third option for the second approach, a UE can implicitly determine indexes for co-scheduled cells without need for explicit gNB indication. For example, the UE can determine indexes for co-scheduled cells based on a PDCCH monitoring parameter, such as:
a CORESET index; or
a search space set index, or a carrier indicator parameter n_CI corresponding to the search space set index; or
a set of CCEs in the search space set or a first/last CCE in the search space set;
   where the UE received a PDCCH providing the DCI format for multi-cell scheduling.

According to the third option, the UE can be configured a mapping among values for PDCCH monitoring parameters, such as search space sets, and a number of co-scheduled cells or indexes of the co-scheduled cells. In one example, first and second values for parameter n_CI in a search space set can respectively indicate first and second subsets of co-scheduled cells. According to this example, the parameter n_CI can correspond to a single cell or can correspond to a group of cells, such as a subset/set of co-scheduled cells.

In a fourth option, the UE can determine a set of co-scheduled cells implicitly based on other fields in an MC-DCI format, without need for an explicit CIF field. For example, when the UE is provided a joint TDRA table for multi-cell scheduling, an index of the joint TDRA table can indicate a set/subset of co-scheduled cells. For example, an entry/row in the joint TDRA table configured by the RRC includes a first TDRA information for a first cell and a second TDRA information for a second cell, and so on, while the entry may include no information for a third cell. Therefore, when the MC-DCI format includes an indication of the entry/row of the joint TDRA table implies that the first and second cells are jointly scheduled by the MC-DCI format, while the third cells is not scheduled. In one example, other DCI fields with joint indication can be used other than TDRA, such as the FDRA field.

In another example, the UE expects that the MC-DCI includes a number N TDRA fields corresponding to a maximum number N of supported/configured scheduled cells for a scheduling cell, wherein a certain value such as all zeros or all ones for the TDRA fields is reserved to indicate no scheduling on the corresponding cell. Therefore, when the MC-DCI receives an MC-DCI format that includes M TDRA fields (out of the N TDRA fields) with the reserved value, the UE determines that the MC-DCI does not schedule the corresponding M cell and jointly schedules only the N−M cells. In one example, other DCI fields with separate indication can be used other than TDRA, such as the FDRA field.

In another example, when a HARQ process number (HPN) field or a redundancy version field, or a new data indicator field are separately provided for each scheduled cell in an MC-DCI format and a combination of those fields, such as all of those fields, have same values for a subset of co-scheduled cells, such as HPN 15 (counting from 0 to 15 for a HPN field of 4 bits), RV 1, and NDI 1, the subset of co-scheduled cells can be assumed as not being scheduled by the MC-DCI format.

In another example, when a MCS field is separately provided for each scheduled cell in an MC-DCI format and the MCS field has a predetermined value, such as 0, for a subset of co-scheduled cells, the subset of co-scheduled cells can be assumed as not being scheduled by the MC-DCI format.

Receptions or transmissions on a respective subset of cells that are jointly scheduled by a single DCI format, or by using complementary methods such as those described herein, can refer to PDSCHs or PUSCHs that may or may not overlap in time. For example, the UE can be indicated to receive PDSCHs or to transmit PUSCHs on respective co-scheduled cells wherein all receptions/transmissions are in a same slot or at least one reception/transmission is in a different slot than the remaining ones.

A UE that is configured for multi-cell scheduling can be provided a first set of cell-common parameters whose values apply for scheduling on all co-scheduled cells, and a second set of cell-specific parameters whose values apply for scheduling on each corresponding co-scheduled cell. The UE can determine cell-common and cell-specific scheduling information parameters based on the specifications of the system operation, or based on higher layer configuration. For some cell-specific scheduling information parameters, the UE can be provided differential values compared to a reference value wherein the reference value can correspond, for example, to a first scheduled cell from a set of scheduled cells. For example, the reference value can correspond to the scheduled cell with the smallest cell index or smallest (cell-level) CIF value.

For a UE that is configured a number of sets of co-scheduled cells, a DCI format for multi-cell scheduling can provide complete or partial information for cell-common or cell-specific scheduling parameters, for multiple PDSCH receptions or multiple PUSCH transmissions on respective multiple co-scheduled cells. When the DCI format for multi-cell scheduling provides partial information for a scheduling parameter, the UE can determine remaining information from UE-specific RRC signaling or by other complementary methods.

In one embodiment, for a UE that is configured a set of co-scheduled cells, a DCI format for multi-cell scheduling can provide full or partial information for values of cell-common and cell-specific fields for scheduling PDSCH receptions or PUSCH transmissions on respective two or more cells from the set of co-scheduled cells. When the DCI format provides partial information, the UE can determine remaining information from RRC signaling or by using other complementary methods.

In a first approach, referred to as concatenated DCI format for multi-cell scheduling, a single DCI format can include information of all scheduling parameters for all the co-scheduled PDSCH receptions or PUSCH transmissions, except possibly for some information that is provided by higher layers or predetermined by the specifications for system operations or implicitly determined by the UE. For example, the MC-DCI format can provide separate values of fields for PDSCH reception or PUSCH transmission on each of the multiple co-scheduled cells. A first value corresponds to a first cell, a second value corresponds to a second cell, and so on. Therefore, DCI format fields for the multiple cells are concatenated, thereby referring to such DCI format as a concatenated DCI format for multi-cell scheduling. This approach can be beneficial, for example, for co-scheduling cells that have different channel characteristics or configurations, such as for inter-band CA operation, or for co-scheduling a PDSCH reception and a PUSCH transmission. Some DCI fields can be cell-common and provided only once in a concatenated DCI format. In one example, a functionality of a field in a first DCI format scheduling PDSCH reception or PUSCH transmission on a single cell and provides information for multiple cells, such as a SCell dormancy indicator field as described in TS 38.213 v17.1.0, can remain same in a second DCI format scheduling PDSCH receptions or PUSCH transmissions on multiple cells and the field can remain as in the first DCI format. Alternatively, such fields can be omitted from the second DCI format.

In a second approach, referred to as multi-cell scheduling via multi-cell mapping, a UE can be provided information for multi-cell scheduling of multiple PDSCHs/PDCCHs on multiple respective cells using a multi-cell mapping, wherein a field in a DCI format can be interpreted to provide multiple values for a corresponding scheduling parameter for the multiple co-scheduled cells. Such interpretation can be based on a configured one-to-many mapping/table or based on multiple configured offset values for respective cells that are applied to a reference value indicated by the DCI format. For example, the field can be an MCS field wherein a value indicated in the DCI format can be for a PDSCH reception on a first cell and a value for a PDSCH reception on a second cell can be determined from the first value and a configured offset value. It is also possible that a same MCS value applies for all PDSCH receptions or PUSCH transmissions. This approach can be beneficial, for example, for co-scheduling cells that have several similar physical channel characteristics or configurations, such as for intra-band CA operation.

In a third approach, referred to as single-cell DCI pointing to a PDSCH with multi-cell scheduling, a UE can be provided information for multi-cell scheduling using a single-cell scheduling DCI format, namely a DCI format that schedules a first PDSCH on a first cell, wherein the first PDSCH includes scheduling information for reception of second PDSCH(s) or transmission of second PUSCH(s) on a subset from one or more sets of co-scheduled cells. This approach can be beneficial, for example, for co-scheduling several (such as 4-8) cells that have different channel characteristics or configurations, such as for inter-band CA operation.

In a first option for the third approach, the first PDSCH includes a MAC CE that provides scheduling information for the number of PDSCH(s) or PUSCH(s). Accordingly, the MAC CE can include a number of modified DCIs (M-DCIs), wherein each M-DCI includes full or partial scheduling information for a PDSCH/PUSCH from the number of PDSCH(s)/PUSCH(s).

In a second option for the third approach, multi-cell scheduling information is multiplexed as M-DCI in a PDSCH. The UE receives a first PDSCH that is scheduled by a single-cell scheduling DCI format, and the UE receives additional scheduling information for one or more PDSCH(s)/PUSCH(s) on one or more respective co-scheduled cell(s). The UE allocates the coded modulation symbols for M-DCIs to time/frequency resources within the first PDSCH, for example in a frequency-first, time-second manner, except for reserved resources corresponding to reference signals or other cell-level broadcast transmissions. The UE can start receiving the M-DCIs in a first symbol of the first PDSCH, or in a first symbol after first symbols with DM-RS REs, in the first PDSCH. The M-DCIs can be jointly coded and include a single CRC.

In the second option, physical layer processing of M-DCI(s) that are included in the first PDSCH can be same as that for a DCI in a PDCCH, such as for the DCI scheduling the first PDSCH, or can be same as that for data information/transport block in the first PDSCH. Herein, physical layer processing refers to, for example, modulation, coding, scrambling, and so on. In addition, the UE can determine a number of coded modulation symbols corresponding to multi-scheduling information, such as M-DCIs, that are multiplexed in a first PDSCH scheduled by a single-cell scheduling DCI format, based on a scaling factor β_{offset}^{PDSCH}=β_{offset}^{M-DCI} applied to a total (coded) payload size for the M-DCIs. Such scaling factor determines an effective channel coding rate of M-DCIs multiplexed on the first PDSCH, for flexible link adaptation and improved reliability of the M-DCIs according to physical channel conditions. A value of the scaling factor) β_{offset}^{PDSCH} can be provided by higher layers or can be indicated by a field in the DCI format in the PDCCH from a set of values provided by higher layers, such as a by a field of 2 bits that indicates a value from a set of four β_{offset}^{PDSCH} values.

In a fourth approach, referred to as multi-stage PDCCHs/DCIs for multi-cell scheduling, a UE can be provided information for multi-cell scheduling of multiple PDSCHs/PUSCHs on multiple respective cells using a multi-stage DCI method, such as a 2-stage DCI wherein, for example, a first-stage DCI format includes a set of cell-common fields, and a second-stage DCI format includes cell-specific fields. The UE receives the first-stage DCI format in a first PDCCH and the second-stage DCI format in a second PDCCH. The first PDCCH and the second PDCCH are linked. In one example, the first and the second PDCCHs are in a same search space set. This approach can be beneficial, for example, for co-scheduling several cells that have several common physical characteristics, such as a time-domain resource allocation or a frequency-domain resource allocation using the first-stage DCI format and without incurring latency or having a DCI format size that is too large (that would result if the first-stage and second-stage DCI formats were combined into a single DCI format) for receiving cell-specific parameters when the second PDCCH is received in a same slot as the first PDCCH. The first-stage DCI format can also indicate a time/frequency resource for a PDCCH providing the second-stage DCI format, such as an index of a PDCCH candidate for a corresponding CCE aggregation level, so that the UE can interpret the contents of the second-stage DCI format or reduce a number of PDCCH receptions. A UE can determine an association among a number of linked multi-stage PDCCHs/DCIs, such as two PDCCHs/DCIs, that provide multi-cell scheduling information based on parameters of the linked DCI formats, such as size(s) of the DCI format(s), or RNTI(s) associated with the DCI format(s), or by an explicit indication in some field(s) in the DCI format(s), or based on PDCCH monitoring parameters, such as CORESET, search space, CCEs, or monitoring occasions in which the UE receives the first and the second linked PDCCHs.

In one embodiment, when a UE is configured a set of co-scheduled cells including a first cell, the UE can receive a PDCCH with a DCI format that schedules a PDSCH reception or PUSCH transmission only on the first cell (single-cell scheduling DCI format). The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.

In a first example, a first DCI format size for multi-cell scheduling can be different from a second DCI format size for single-cell scheduling. The first DCI format size can be such that it can include a field (such as set-level CIF) identifying a set of co-scheduled cells and possibly a number of fields, such as cell-common scheduling parameters, enabling a UE to decode remaining scheduling information, or a PDCCH candidate that provides a second-stage DCI format.

In a second example, a same DCI format size is used for multi-cell scheduling and for single-cell scheduling, for example in order to avoid increasing a number of DCI format sizes that the UE needs to decode in order to support multi-cell scheduling with a single DCI format. Accordingly, various approaches can be considered to identify whether a DCI format performs single-cell scheduling or multi-cell scheduling as described in the following.

A PDSCH reception or a PUSCH transmission on any cell from a set of co-scheduled cells can be scheduled by a DCI format that does not schedule any other PDSCH reception or PUSCH transmission on any other cell from the set of co-scheduled cells, such as for example by a DCI format not having a multi-cell scheduling capability, or when there is no traffic associated with the other cells. For example, for a UE that is configured cross-carrier scheduling for a set of co-scheduled cells by a scheduling cell, the UE can receive on the scheduling cell a first PDCCH that includes a first DCI format for scheduling a single cell from the number of co-scheduled cells and a second PDCCH that includes a second DCI format for scheduling all cells in the set of co-scheduled cells.

Herein, a DCI format for multi-cell scheduling can refer to, for example, one or more or a combination of:
a concatenated DCI format for multi-cell scheduling; or
a DCI format based on multi-cell mapping; or
a first DCI format in a first PDCCH or a second DCI format or an M-DCI or a collection of M-DCIs included in a first PDSCH that is scheduled by the first DCI/PDCCH; or
a first DCI format in a first PDCCH or a second DCI format in a second PDCCH, wherein the first DCI/PDCCH and the second DCI/PDCCH are linked in a two-stage DCI operation;
wherein the aforementioned terms and procedures are described herein.

In a first approach, the UE can distinguish multi-cell scheduling from single-cell scheduling based on one or more dedicated DCI formats or DCI format sizes for multi-cell scheduling, that are not used for single-cell scheduling. For example, the UE can be configured a DCI format 0_3 for transmission of multiple PUSCHs or a DCI format 1_3 for reception of multiple PDSCHs on a set of co-scheduled cells. A dedicated size of a DCI format for multi-cell scheduling can also depend on a number of co-scheduled cells or a set of cell-common or cell-specific scheduling parameters for multi-cell scheduling. A dedicated DCI format size for transmission of multiple PUSCHs can be different from a dedicated DCI format size for reception of multiple PDSCHs on a set of co-scheduled cells.

In one example, when a UE is configured dedicated DCI formats or DCI format sizes for multi-cell scheduling, the UE is expected to support a larger number of DCI format sizes than when the UE operates only with single-cell scheduling. For example, a UE supporting multi-cell scheduling (by a single DCI format) can be expected to support, or can indicate as a capability, one or two additional DCI format sizes compared to a UE not supporting multi-cell scheduling by a single DCI format. The UE counts a number of sizes for DCI formats per serving cell based on a number of configured PDCCH candidates in respective search space sets for the corresponding active DL BWP.

To avoid requiring a larger number of DCI format sizes for a UE to support multi-cell scheduling and avoid fragmentation of a number of PDCCH candidates that a UE can monitor over an increased number of DCI format sizes, it is beneficial to provide additional means for distinguishing multi-cell scheduling from single cell scheduling by means other than DCI format size. A DCI format for multi-cell scheduling can have a same size as a DCI format for single cell scheduling.

In one example, an existing single-cell scheduling DCI format such as one of those supported in [TS 38.212, v17.1.0] can be re-used for multi-cell scheduling, for example, by re-interpreting existing fields or considering new/increased/configurable bit-width for existing fields or by adding new field(s). Herein, the UE determines the existence (or not) of re-interpreted/modified/new DCI fields based on whether a CIF value refers to a single scheduled cell or a set/subset of co-scheduled cells. Accordingly, re-interpreted/modified/new DCI fields follow the multi-cell scheduling configuration provided for a set of co-scheduled cells that is indicated by (a set-level value for) the CIF field.

In another example, a size/bit-width of one or more DCI field for multi-cell scheduling (including presence or absence thereof) can be configurable based on higher layer configuration for the corresponding set of co-scheduled cells or for any set/subset of co-scheduled cells associated with the same scheduling cell.

In a second approach, a UE can distinguish multi-cell scheduling based on a new/dedicated RNTI, such as a M-RNTI, for scrambling a CRC of a DCI format for multi-cell scheduling. For example, such an RNTI can be configured by UE-specific RRC signaling.

In a third approach, a UE can distinguish multi-cell scheduling based on an explicit field or indication in a DCI format for multi-cell scheduling. For example, a DCI format can include a 1-bit flag, with a value ‘1’ corresponding to multi-cell scheduling, and a value ‘0’ corresponding to single-cell scheduling. In one example, there can be restrictions on a size of a DCI format for multi-cell scheduling. For example, the UE does not expect that a DCI format for multi-cell scheduling has a same size as a fallback DCI format (0_0 or 1_0) or a ‘compact’ DCI format (0_2 or 1_2). Accordingly, a 1-bit flag to indicate single-cell versus multi-cell scheduling is only present in certain DCI formats, such as a ‘normal’ DCI format 0_1 or 1_1.

In one example, a UE can distinguish multi-cell scheduling based on a validation procedure for a single-cell scheduling DCI format. For example, when values for one or more DCI fields in a single-cell scheduling DCI format is set to default/predetermined values, the UE determines that the DCI format is used for multi-cell scheduling. In example, one or more DCI fields corresponding to cell-specific scheduling parameters, such as HPN, RV, SRI, TCI state, APs, TDRA, FDRA, or MCS, can be set to all-zeros or all-ones values, for the case of multi-cell scheduling.

In a fourth approach, a UE can distinguish multi-cell scheduling based on a CORESET associated with a search space set that is configured for receiving PDCCH that provides a DCI format for multi-cell scheduling. For example, the UE can be configured with a dedicated CORESET for multi-cell scheduling, so that search space sets for multi-cell scheduling do not overlap with search space sets that are not used for multi-cell scheduling.

In one example, a combination of the above options can be used. For example, for multi-cell scheduling based on a first stage DCI format and a second stage DCI format, the UE determines a DCI format (in a first PDCCH) that is scrambled by a new/dedicated RNTI, such as an M-RNTI, and also satisfies the aforementioned validation procedure, to be a first-stage DCI format and a second-stage DCI format can be included in a PDSCH scheduled by the first stage DCI format or in another PDCCH, as described herein.

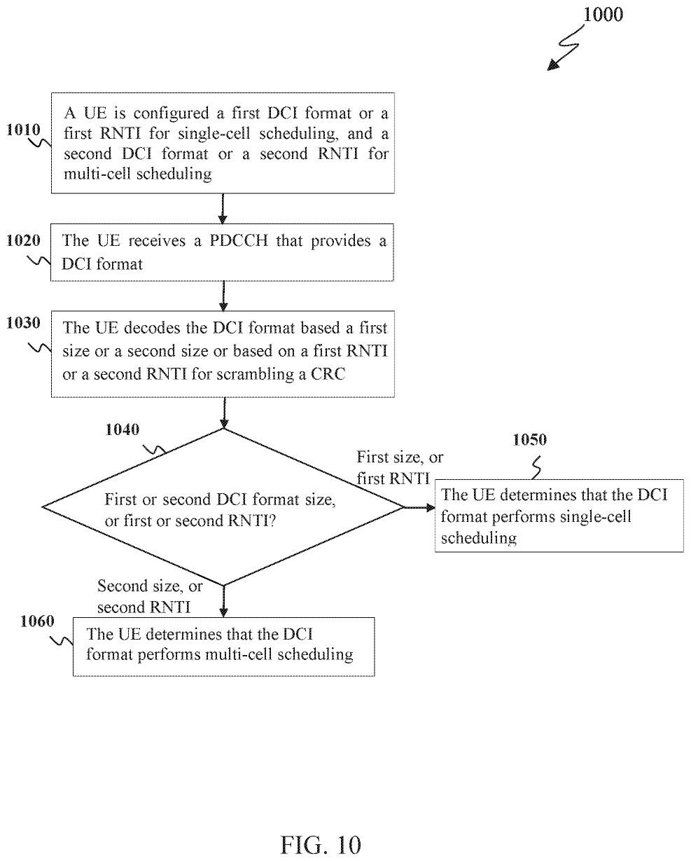

FIG. 10 illustrates an example method 1000 for distinguishing a multi-cell scheduling DCI format from a single-cell scheduling DCI format according to embodiments of the present disclosure. The embodiment of the method 1000 for distinguishing a multi-cell scheduling DCI format from a single-cell scheduling DCI format illustrated in FIG. 10 is for illustration only. FIG. 10 does not limit the scope of this disclosure to any particular implementation of the method 1000 for distinguishing a multi-cell scheduling DCI format from a single-cell scheduling DCI format.

As illustrated in FIG. 10, the method 1000 begins at step 1010, where a UE (such as the UE 116) is configured a first DCI format or a first RNTI for single-cell scheduling, and a second DCI format or a second RNTI for multi-cell scheduling. At step 1020, the UE receives a PDCCH that provides a DCI format. At step 1030, the UE decodes the DCI format based a first size or a second size or based on a first RNTI or a second RNTI for scrambling a CRC. At step 1040, the UE determines whether the decoded DCI format has the first size or the second size, or has CRC scrambled by the first RNTI or the second RNTI. At step 1050, when the DCI format has the first size or has CRC scrambled by the first RNTI, the UE determines that the DCI format performs single-cell scheduling. At step 1060, when the DCI format has the second size or CRC scrambled by the second RNTI, the UE determines that the DCI format performs multi-cell scheduling.

In one embodiment, when a UE is configured multi-cell scheduling for a set of co-scheduled cells by a scheduling cell, the UE can determine an association among search space sets for multi-cell scheduling and subsets of the set of co-scheduled cells based on a modified interpretation for a value of a CIF field, n_CI, in a DCI format performing multi-cell scheduling.

In a first approach, a UE can be configured search space sets to monitor only DCI formats for multi-cell scheduling (MC-DCI formats). Such search space sets that are dedicated to multi-cell scheduling can be referred to as multi-cell search space (MSS) sets. As described, a MC-DCI format can also be used for scheduling on a single cell. Configuration of MSS sets is beneficial, for example, to allow the UE to monitor PDCCH for MC-DCI formats more (or less) frequently than for SC-DCI formats, or to allocate PDCCH candidates that are better suited to MC-DCI formats, such as more PDCCH candidates for larger ALs that are more compatible with larger sizes used for MC-DCI formats and may be unnecessary for smaller sizes used for SC-DCI formats.

In one example, each of such search space sets can have a respective identifier, such as an n_CI value associated with a CIF field in a DCI format performing multi-cell scheduling, so there is a separate MSS set for each set/subset of co-scheduled cells and corresponding n_{CI} value.

In another example, the UE can be configured an MSS set for a scheduling cell, that corresponds to a number of sets/subsets of co-scheduled cells and corresponding n_{CI} values associated with the scheduling cell. Therefore, the UE can receive PDCCH candidates and decode respective DCI formats for multi-cell scheduling of different sets of co-scheduled cells according to the PDCCH monitoring occasions determined based on the MSS set configuration. The PDCCH candidates and associated non-overlapping CCEs can be different for different sets/subsets of co-scheduled cells, corresponding to different n_{CI} values. For example, the UE can determine PDCCH candidates corresponding to different sets/subsets of co-scheduled cells from a same MSS set based on different n_{CI} values in the formula:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

The association of n_{CI} values with sets/subsets of co-scheduled cells can be provided by higher layer signaling, for example, inside the MSS set configuration or in an RRC information element (IE) related/similar to cross-carrier scheduling, or in a separate RRC IE.

For example, an MSS set can be used to support scheduling of all sets/subsets of co-scheduled cells and support all corresponding n_{CI} values associated with the scheduling cell. For example, the UE can be configured multiple MSS sets corresponding to the same sets/subsets of co-scheduled cells. For example, the UE can be configured multiple MSS sets corresponding to all sets/subsets of co-scheduled cells associated with a scheduling cell.

In yet another example, the UE can be configured multiple MSS sets for each scheduling cell, for example, to accommodate different PDCCH monitoring occasions (such as different periodicity and slot offset) or to improve flexibility in configuration/association with different sets of co-scheduled cells. For example, a first MSS set can correspond to a first number of sets/subsets of co-scheduled cells associated with a scheduling cell, and a second MSS set can correspond to a second number of sets/subsets of co-scheduled cells associated with the scheduling cell. The first number of sets/subsets of co-scheduled cells can have no overlap or can have some overlap with the second sets/subsets of co-scheduled cells. According to this example, the UE is provided higher layer signaling that indicates which n_{CI} values and respective sets/subsets of co-scheduled cells are associated with the first MSS set or the second MSS set. Such information can be provided, for example, inside the configuration information of the first or second MSS set or in a separate RRC IE such as one related/similar to cross-carrier scheduling.

An example of an information element SearchSpaceMultiCell, is provided wherein a UE can be configured to monitor only a DCI format for multi-cell scheduling. Herein, DCI formats 0_4 and 1_4 are considered to be DCI formats for uplink multi-cell scheduling and downlink multi-cell scheduling, respectively. In this example, the MSS sets is associated with only one set of co-scheduled cells as indicated by coScheduledSetId. Herein, cif-set-InSchedulingCell refers to a CIF or n_{CI} value corresponding to the respective set of co-scheduled cells, for example, as provided in MultiCellSchedulingConfig IE discussed further below.

SearchSpace information element - SearchSpaceMultiCell

-- ASN1START
-- TAG-SEARCHSPACE-START

| | |
|---|---|
| SearchSpaceMultiCell-r18 ::= | SEQUENCE { |
| searchSpaceId | SearchSpaceId, |
| controlResourceSetId | ControlResourceSetId |

OPTIONAL, -- Cond SetupOnly

| | |
|---|---|
| coScheduledSetId | cif-set-InSchedulingCell, |

OPTIONAL, -- Need R

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | |
|---|---|
| duration | INTEGER (2..2559) |

OPTIONAL, -- Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

}
OPTIONAL, -- Cond Setup

| | |
|---|---|
| searchSpaceType-r18 | SEQUENCE { |
| ue-Specific-r18 | SEQUENCE { |
| dci-Formats-MC-r18 | ENUMERATED {formats0-3-And-1-3, formats0- |

3, formats1-3}
OPTIONAL -- Need R
}

Another example of an information element SearchSpaceMultiCell is provided wherein the MSS sets are associated with multiple sets/subsets of co-scheduled cells, as indicated by coScheduledSetId. In one example, when coScheduledSetId is not present in the SearchSpaceMultiCell configuration of the MSS set, the MSS set is associated with all sets/subsets of co-scheduled cells corresponding to the respective scheduling cell. In another example, when coScheduledSetId is not present in the SearchSpaceMultiCell configuration of the MSS set, the UE can determine association of the MSS set with different sets/subsets of co-scheduled cells based on implicit methods, such as multi-cell extensions for the UE procedure for search space linking, as is subsequently described. Herein, cif-set-InSchedulingCell refers to a CIF or n_{CI} value corresponding to the respective set of co-scheduled cells, for example, as provided in MultiCellSchedulingConfig IE discussed further below.

SearchSpace information element - SearchSpaceMultiCell

-- ASN1START
-- TAG-SEARCHSPACE-START

| | |
|---|---|
| SearchSpaceMultiCell-r18 ::= | SEQUENCE { |
| searchSpaceId | SearchSpaceId, |
| controlResourceSetId | ControlResourceSetId |

OPTIONAL, -- Cond SetupOnly

| | |
|---|---|
| coScheduledSetId | SEQUENCE (SIZE (1..maxNrofCoScheduledSets)) OF |
| cif-set-InSchedulingCell, | OPTIONAL, -- Need R |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | | |
|---|---|---|
| duration | INTEGER (2..2559) | OPTIONAL, |

-- Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

}
OPTIONAL, -- Cond Setup

| | |
|---|---|
| searchSpaceType-r18 | SEQUENCE { |
| ue-Specific-r18 | SEQUENCE { |
| dci-Formats-MC-r18 | ENUMERATED {formats0-3-And-1-3, formats0- |

```
3, formats1-3}
-- Need R
    }
  }
OPTIONAL -- Cond Setup2
}
```

In a second approach, a UE is configured search space sets used for monitoring PDCCH providing DCI formats that can perform both single-cell and multi-cell scheduling.

An example for an update to a SearchSpace information element wherein the UE can be configured to monitor DCI formats for both multi-cell scheduling and single-cell scheduling is provided by “SearchSpace information element”.

SearchSpace information element

-- ASN1START
-- TAG-SEARCHSPACE-START

| | |
|---|---|
| SearchSpace ::= | SEQUENCE { |
| searchSpaceId | SearchSpaceId, |
| controlResourceSetId | ControlResourceSetId |

OPTIONAL, -- Cond SetupOnly

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

| | |
|---|---|
| } | OPTIONAL, - |

- Cond Setup

| | |
|---|---|
| duration | INTEGER (2..2559) |

OPTIONAL, -- Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- |

Cond Setup

| | |
|---|---|
| searchSpaceType | CHOICE { |
| common | SEQUENCE { |
| dci-Format0-0-AndFormat1-0 | SEQUENCE { |

| | |
|---|---|
| ... | |
| } | OPTIONAL, -- |

Need R

| | |
|---|---|
| dci-Format2-0 | SEQUENCE { |
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
OPTIONAL -- Need R
        },
        ...
      }
OPTIONAL, -- Need R
```

| | |
|---|---|
| dci-Format2-1 | SEQUENCE { |

```
        ...
      }
OPTIONAL, -- Need R
```

| | |
|---|---|
| dci-Format2-2 | SEQUENCE { |

```
        ...
      }
OPTIONAL, -- Need R
```

| | |
|---|---|
| dci-Format2-3 | SEQUENCE { |
| dummy1 | ENUMERATED {sl1, sl2, sl4, sl5, sl8, sl10, sl16, |

sl20} OPTIONAL, -- Cond Setup

| | |
|---|---|
| dummy2 | ENUMERATED {n1, n2}, |

```
        ...
      }
OPTIONAL -- Need R
    },
```

| | |
|---|---|
| ue-Specific | SEQUENCE { |
| dci-Formats | ENUMERATED {formats0-0-And-1-0, formats0- |

```
1-And-1-1},
OPTIONAL -- Need R
      ...,
      [[
```

| | |
|---|---|
| dci-Formats-MT-r16 | ENUMERATED {formats2-5} |

OPTIONAL, -- Need R

| | |
|---|---|
| dci-FormatsSL-r16 | ENUMERATED {formats0-0-And-1-0, formats0- |

1-And-1-1, formats3-0, formats3-1, formats3-0-And-3-1}
OPTIONAL, -- Need R

| | |
|---|---|
| dci-FormatsExt-r16 | ENUMERATED {formats0-2-And-1-2, formats0- |

1-And-1-1And-0-2-And-1-2},

OPTIONAL

-- Need R

| | |
|---|---|
| dci-Formats-MC-r18 | ENUMERATED {formats0-3-And-1-3, formats0- |

```
3, formats1-3}, OPTIONAL -- Need R
      ]]
    }
  }
OPTIONAL -- Cond Setup2
```

| | |
|---|---|
| coScheduledSetId | SEQUENCE (SIZE (1..maxNrofCoScheduledSets)) OF |
| cif-set-InSchedulingCell, | OPTIONAL, -- Need R |

}

In one example, a search space set for a set of co-scheduled cells can be a UE-specific search space (USS) set defined by an n_CI parameter that is generalized to apply to the configured set of co-scheduled cells, instead of a single scheduled cell. For example, a n_CI or CIF=0 can refer to self-carrier scheduling, an n_CI or CIF in a set {1, 2, . . . , 7} can refer to cross-carrier scheduling of a single scheduled cell, and an n_CI or CIF in a set {8, 9, . . . , 15} can refer to cross-carrier scheduling of one from eight subsets of co-scheduled cells from a set of co-scheduled cells. In one example, existing CIF values {0, 1, 2, . . . , 7} are sufficient for both single-cell and multi-cell scheduling, and the UE can be provided by higher layers an association between a CIF value and a single cell or a set of co-scheduled cells. For example, CIF values {0, 1, 2, 3} can be associated with single-cell scheduling for four different scheduled cells, and CIF values {4, 5, 6, 7} can be associated with multi-cell scheduling for four different sets of co-scheduled cells. The CIF association for set(s) of co-scheduled cells can be provided by an extension of the cross-carrier scheduling information element (IE) or by a separate IE. In one example, the value range for CIF can be extended for example to {0, 1, . . . , 15}, wherein the specific split of this extended value range among cell-level CIF values and set-level CIF values can be up to gNB configuration. For example, the UE can be configured with {0, 1, . . . , 4} for cell-level CIF values, and {5, 6, . . . , 15} for set-level CIF values.

A search space for determining CCE locations for PDCCH candidates can be provided as

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

wherein all parameters are defined as in the case of single-cell scheduling, and a value for the n_CI parameter is provided by RRC configuration, as described above. In addition, the initial value Y_{p,-1}=nRNTI≠0 can be based on C-RNTI or based on an RNTI, such as an M-RNTI, for multi-cell scheduling.

In one example, if the UE is configured to have only one set of co-scheduled cells associated with a scheduling cell, such as when the set of co-scheduled cells includes all scheduled cells corresponding to the scheduling cell, then a single value for n_{CI} can be used, such as n_{CI}=8. Such value can be fixed in the specifications for system operations. For example, the DCI format can exclude a CIF value. For example, the DCI format can include a flag to indicate single-cell scheduling (for example, with flag value=0) or multi-cell scheduling (for example, with flag value=1), and a CIF is present in the DCI format when the flag indicates (value 0, so) single-cell scheduling, and the DCI format does not include a CIF when the flag indicates (value 1, so) multi-cell scheduling.

In one example, the n_{CI} can be the same as the one used by the field in the DCI format to indicate a subset of scheduled cells. For example, for a set of 4 cells {cell #0, cell #1, cell #2, cell #3}, when there are four possible n_{CI} values, n_{CI}=0, 1, 2, 3, that respectively indicate scheduling on {cell #0, cell #1}, {cell #2, cell #3}, {cell #0, cell #2} and {cell #0, cell #1, cell #2, cell #3}, search spaces for corresponding PDCCH candidates can be determined based on n_{CI}=0, 1, 2, 3.

In another example, if the UE can be configured to have multiple sets of co-scheduled cells associated with a scheduling cell, there can be various options for mapping among sets of co-scheduled cells associated with a scheduling cell and values of n_{CI}.

In a first option, the UE receives higher layer signaling, such as dedicated RRC configuration, that provides values of n_{CI} for a set of co-scheduled cells. The association of n_{CI} values with sets/subsets of co-scheduled cells can be provided, for example, inside the configuration information for a respective search space set for multi-cell scheduling or in an RRC information element (IE) related/similar to cross-carrier scheduling, or in a separate RRC IE.

An example is provided below, wherein a MultiCellSchedulingConfig IE can be configured, for example, within the ServingCellConfig IE of the respective scheduling cell, so that there is no need for explicit indication of the scheduling cell. In addition, the individual/cell-level CIF values correspond to respective values provided in the CrossCarrierSchedulingConfig IE for the respective serving/scheduled cells associated with the respective scheduling cells. The UE does not expect that an individual/cell-level CIF value that is configured for a serving/scheduled cell in a CrossCarrierSchedulingConfig IE is re-used as a set-level CIF value for a set of co-scheduled cells in the MultiCellSchedulingConfig IE. Herein, maxNrofCoScheduledSets refers to a maximum supported number of sets of co-scheduled cells for any scheduling cell, and can be a constant such as 4 or 8 or 16 that is predetermined in the specifications of system operation. Furthermore, maxNrofCoScheduledCellsPerSet refers to a maximum number of serving cells that can be included any set of co-scheduled cells, and can be a constant such as 4 or 8 or 16 that is predetermined in the specifications of system operation. For RRC configuration IE, information of which cells belong to a set of co-scheduled cells can be provided by, for example, a list of individual/cell-level CIF values corresponding to the cells that are included in the set, or in another example, by a bitmap that includes a ‘1’ for a cell that is included in the set and a ‘0’ for a cell that is not included in the set of co-scheduled cells.

MultiCellSchedulingConfig information element

-- ASN1START
-- TAG-MULTICELLSCHEDULINGCONFIG-START

| | |
|---|---|
| MultiCellSchedulingConfig-r18 ::= | SEQUENCE { |
| setOfCoScheduledCellsToAddModList-r18 | SEQUENCE (SIZE |
| (1..maxNrofCoScheduledSets)) OF setOfCoScheduledCells-r18 | OPTIONAL, -- Need |

N

| | |
|---|---|
| setOfCoScheduledCellsToReleaseList-r18 | SEQUENCE (SIZE (1.. |
| maxNrofCoScheduledSets)) OF setOfCoScheduledCells-r18 | OPTIONAL, -- Need N |

}

| | |
|---|---|
| setOfCoScheduledCells-r18 ::= | SEQUENCE { |
| cif-InSchedulingCell | INTEGER (1..15), |

OPTIONAL, -- Need R

| | |
|---|---|
| coScheduledCells | SEQUENCE (SIZE (1..maxNrofCoScheduledCellsPerSet)) |

OF INTEGER (0..7), OPTIONAL, -- Need R
}
-- TAG-MULTICELLSCHEDULINGCONFIG-STOP
-- ASN1STOP

In a second option, the UE determines a value of n_{CI} for a set of co-scheduled cells based on values of n_{CI} for each scheduled cell included in the set of co-scheduled cells. In one example, a value of n_{CI} for a set of co-scheduled cells can be based on summation of n_{CI} values corresponding to the cells included in the set of co-scheduled cells. In another example, a value of n_{CI} for a set of co-scheduled cells can be defined as:

$${n}_{CI} ( set ) = {n}_{0} + ( ( {\sum }_{i ϵ set} {n}_{CI} ( cell \# i ) ) mod L ) ,$$

$$or$$

$$CIF ( set ) = {n}_{0} + ( ( {\sum }_{i ϵ set} CIF ( cell \# i ) mod L ) .$$

wherein n₀ can have values such as n₀=8 or n₀=0, and L can have for example a value L=8.

In a third option, the UE determines a value of n_{CI} for a set of co-scheduled cells based on a value of n_{CI} for a reference scheduled cell in the set of co-scheduled cells. In one example, this method is used when a same cell is not a reference cell for more than one set of co-scheduled cells, while in another example, this method can be used even when two sets of co-scheduled cells share a same reference cell. For example, a reference scheduled cell in a set of co-scheduled cells can be:
a cell with a smallest or largest n_{CI} or CIF value; or
a cell with a smallest or largest cell index (cell ID or ServCellIndex) value; or
the scheduling cell, namely n_{CI}=0, at least for the case where the scheduling cell is included in the set of co-scheduled cells;
a scheduled cell that is included in the set and is explicitly indicated as a reference cell by higher layer signaling;
a scheduled cell that is included in the set and is implicitly indicated as a reference cell, such as by configuration of the respective search space on a DL BWP of the scheduled cell;
a reference cell from the set/subset of serving cells that is used for counting the DCI size budget including the size of MC-DCI format, such as a cell for which the size of MC-DCI format is counted towards the “3+1” DCI size budget (and possibly not counted for other cells from the set of co-scheduled cells), for example, a cell from the set/subset of co-scheduled cells which is configured with the smallest number of DCI format sizes.

According to the third option, the UE determines a same search space and corresponding PDCCH candidates for multi-cell scheduling with an n_{CI} value based on a reference scheduled cell from the set and for single-cell scheduling when only the reference scheduled cell is scheduled by the scheduling cell. In such case, the UE can use other means to distinguish multi-cell scheduling from single-cell scheduling, such as DCI format size or RNTI for scrambling a CRC of a DCI format or an indication in the DCI format.

In one example, a search space set for multi-cell scheduling on a set of co-scheduled cells can be associated with multiple n_{CI} values, such as a first n_{CI} value corresponding to a first cell from the set of co-scheduled cells when the UE monitors a first linked search space set configured on the first cell, and a second n_{CI} value corresponding to a second cell from the set of co-scheduled cells when the UE monitors a second linked search space set configured on the second cell.

When multiple sets of co-scheduled cells are associated with a same scheduling cell, the UE monitors PDCCH for each set of co-scheduled cells separately, wherein each set can have a different n_{CI} value. In one example, a DCI format can schedule only a subset of cells from the set of co-scheduled cells. For example, a DCI format can co-schedule 2 cells from a set of 4 co-scheduled cells. A CIF value in the DCI format refers to the subset of cells that are actually scheduled, and does not refer to the set of co-scheduled cells. For example, for a set of co-scheduled cells that includes {cell #0, cell #1, cell #2, and cell #3}, a n_{CI} value of ‘00’ can be associated with scheduling for cell #0 and cell #1, a n_{CI} value of ‘01’ can be associated with scheduling for cell #0 and cell #2, a n_{CI} value of ‘10’ can be associated with scheduling for cell #0 and cell #3, and a n_{CI} value of ‘00’ can be associated with scheduling for cell #0, cell #1, cell #2, and cell #3. In another example, a DCI format for multi-cell scheduling schedules all serving cells included in a set of co-scheduled cells, so a CIF value in the DCI format is same as an n_{CI} value associated with the respective search space set.

In one realization, the UE can be indicated by a serving gNB a same n_CI value for multiple sets/subsets of co-scheduled cells. For example, the UE can be indicated a first n_CI value for first sets/subsets of co-scheduled cells, and a second n_CI value for second sets/subsets of co-scheduled cells. In one example, indication of same or different n_CI values for different sets/subsets of co-scheduled cells can be up to gNB implementation. In another example, there can be restrictions or conditions on whether same or separate n_CI values can be indicated. For example, the UE can be indicated a same n_CI value for first sets/subsets of co-scheduled cells when one or more of the following conditions are satisfied:
there is a set/subset of co-scheduled cells, from the first sets/subsets of co-scheduled cells, that includes all other sets/subsets of co-scheduled cells from the first sets/subsets of co-scheduled cells; or
for any two sets/subsets of co-scheduled cells, from the first sets/subsets of co-scheduled cells, there is at least one serving cell that is included in the two sets/subsets.

For example, when the UE is configured Set 1={cell 1, cell 2}, and Set 2={cell 3, cell4}, and the UE is not configured a Set 3={cell 1, cell 2, cell 3, cell 4} (or, alternatively, a Set 4={cell 1, cell 4} and a Set 5={cell 2, cell 3}), then separate n_CI values can be indicated for Set 1 and Set 2; otherwise a same n_CI can be indicated for all of Set 1 and Set 2 and Set 3 (or, alternatively, a same n_CI value for all of Set 1 and Set 2 and Set 4 and Set 5).

In another example, the UE can be indicated a same/shared n_{CI} value for sets/subsets of co-scheduled cells with different number of cells, and separate n_{CI} values for sets/subsets of co-scheduled cells that include a same number of cells. For example, Set 1={cell 1, cell 2} and Set 2={cell 1, cell 2, cell 3, cell 4} can have a first n_{CI} value, such as n_{CI}=5, and Set 3={cell 3, cell 4} and Set 4={cell 1, cell 2, cell 5, cell 6} can have a second n_{CI} value, such as n_{CI}=6. For example, indication of same or separate n_CI values can be based on a combination of set/subset size condition and intersection conditions described above.

In one example, different sets/subsets of co-scheduled cells that are indicated a same n_CI value can correspond to different sizes for multi-cell scheduling DCI (MC-DCI) formats. Different n_CI values can correspond to a same size of a MC-DCI format that is used for scheduling on more than one sets of cells. For example, the MC-DCI format can have a first size for a first set/subset of co-scheduled cells, and a second size for a second set/subset of co-scheduled cells. For example, a size of MC-DCI format can be based on a size of a set/subset of co-scheduled cells that is associated with an n_CI value.

In one example, the UE can be configured a first group of co-scheduled cells and a second group of co-scheduled cells. The UE can be indicated a first n_CI value for the first group of co-scheduled cells and all corresponding subsets of the first group of co-scheduled cells, and a second n_CI value for the second group of co-scheduled cells and all corresponding subsets of the second group of co-scheduled cells. For example, a first group includes cells {1, 2, 3, 4} and all of its subsets, and a second group includes cells {5, 6, 7, 8} and all of its subsets. For example, the UE can be provided separate configurations for co-scheduling on cells of the first and second groups of co-scheduled cells, such as for one or more of: TDRA tables (including joint multi-cell TDRA tables), MCS (including differential MCS), NZP CSI-RS trigger, rate matching indicator, TCI state, and so on. For example, the UE can be indicated same values, such as cell-common values, for DCI fields of a multi-cell scheduling DCI format for each of the first or second groups of co-scheduled cells. For example, the first group of co-scheduled cells can correspond to a first frequency band or a first frequency range such as FR1, and the second group of co-scheduled cells can correspond to a second frequency band or a second frequency range such as FR2.

In one example, the UE can be provided a first n_CI value for first sets/subsets of co-scheduled cells that are associated with a first search space set (for example, based on a search space linking procedure), and a second n_CI value for second sets/subsets of co-scheduled cells that are associated with a second search space set. For example, when a set/subset of co-scheduled cells is associated with both the first search space set and the second search space set, the UE monitors PDCCH for detection of a MC-DCI format for the set/subset of co-scheduled cells according to the first search space set based on the first n_CI value, and according to the second search space set based on the second n_CI value.

In one example, a UE can monitor PDCCH according to a common search space (CSS) set for multi-cell scheduling. The UE can be configured to monitor PDCCH for detection of a unicast DCI format such as a DCI format 0_0 or 1_0 repurposed for multi-cell scheduling. For example, such unicast DCI format can be a first-stage DCI format for a two-stage scheduling mechanism with a second-stage DCI multiplexed in a PDSCH that is scheduled by the first-stage DCI, or in another PDCCH, as described herein. In another example, the UE does not expect to be configured to monitor PDCCH according to a CSS set for multi-cell scheduling.

In one example, a UE can monitor PDCCH according to a common search space (CSS) set for multi-cell scheduling. The UE can be configured to monitor PDCCH for detection of a unicast DCI format such as a DCI format 0_0 or 1_0 repurposed for multi-cell scheduling. For example, such unicast DCI format can be a first-stage DCI format for a two-stage scheduling mechanism with a second-stage DCI multiplexed in a PDSCH that is scheduled by the first-stage DCI, or in another PDCCH, as described herein. In another example, the UE does not expect to be configured to monitor PDCCH according to a CSS set for multi-cell scheduling.

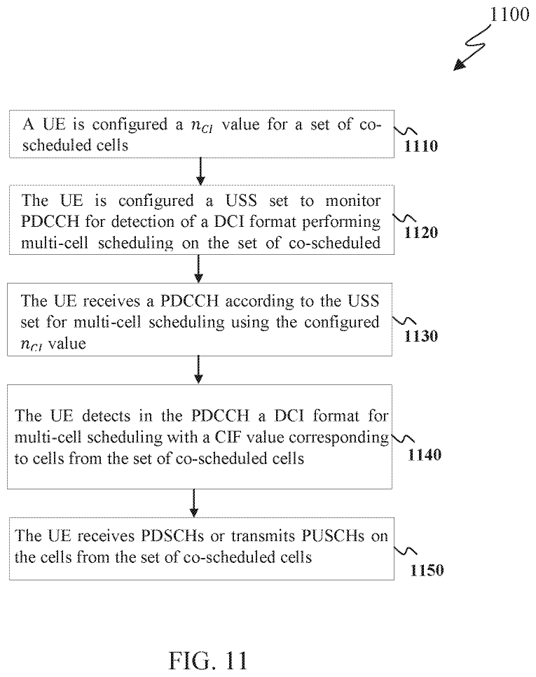

FIG. 11 illustrates an example method 1100 for monitoring PDCCH in a search space set for multi-cell scheduling according to embodiments of the present disclosure. The embodiment of the method 1100 for monitoring PDCCH in a search space set for multi-cell scheduling is for illustration only. FIG. 11 does not limit the scope of this disclosure to any particular implementation of the method 1100 for monitoring PDCCH in a search space set for multi-cell scheduling.

As illustrated in FIG. 11, the method 1100 begins at step 1100, where a UE (such as the UE 116) is configured a n_{CI} or CIF value for a set of co-scheduled cells. At step 1120, the UE is configured a UE-specific search space (USS) set to monitor PDCCH for detection of a DCI format performing multi-cell scheduling on the set of co-scheduled cells. At step 1130, the UE receives a PDCCH according to the USS set for multi-cell scheduling using the configured n_{CI} value. At step 1140, the UE detects in the PDCCH a DCI format for multi-cell scheduling with a CIF value corresponding to cells from the set of co-scheduled cells. At step 1150, the UE receives PDSCHs or transmits PUSCHs on cells from the set of co-scheduled cells.

In one example, no indication of n_{CI} or CIF values is needed in order to determine an association of a search space set with a set of co-scheduled cells. For example, when a UE is configured a search space set associated with a CORESET on a scheduling cell, the UE can determine PDCCH candidates according to the search space set for all sets/subset of co-scheduled cells associated with the scheduling cell. The UE determines PDCCH candidates associated with each set of co-scheduled cells by applying the corresponding n_{CI} value (set-level CIF) in the PDCCH search space equation for the search space set. This method can be beneficial when the UE is not configured a dedicated DCI format or a dedicated DCI format size for multi-cell scheduling, such as when a same DCI format or a same DCI format size can be used for both single-cell scheduling and multi-cell scheduling. A same PDCCH candidate can be monitored for decoding either a SC-DCI format or an MC-DCI format (using a same RNTI, such as C-RNTI), without making any distinction between the DCI formats, so there won't be any impact on PDCCH candidate determination or search space set association. This method can also be beneficial when a size of a MC-DCI format does not depend on a subset of co-scheduled cells, is dimensioned according to the set of co-scheduled cells, and a UE can infer the co-scheduled cells based on predetermined values of fields corresponding to cells from the set of co-scheduled that are not scheduled. For example, when a separate MCS field is used in the MC-DCI format for each cell from the set of co-scheduled cells, a value of 0 can indicate that a cell is not scheduled by a given MC-DCI format.

For example, when a UE is configured a search space set associated with a CORESET on a scheduling cell, and the search space configuration includes monitoring a DCI format for multi-cell scheduling (such as DCI format 0_3 or 1_3), the UE can determine PDCCH candidates according to the search space set for all sets/subset of co-scheduled cells associated with the scheduling cell. The UE determines PDCCH candidates associated with each set of co-scheduled cells by applying the corresponding n_{CI} value (set-level CIF) in the PDCCH search space equation for the search space set. This method can be beneficial when the UE is configured a dedicated DCI format or a dedicated DCI forma size for multi-cell scheduling, different from those for single-cell scheduling, different from those for single-cell scheduling. The UE can be configured by higher layers or can be predetermined in the specifications for system operation to monitor a search space set that includes an MC-DCI format for all sets/subset of co-scheduled cells associated with the scheduling cell.

In one example, the UE determines an association among search space sets and sets/subsets of co-scheduled cells implicitly based on the search space set configuration/linking or based on the active DL BWPs of the co-scheduled cells on which the search space sets are configured. For example, when a UE is configured:
a first search space set associated with a CORESET on a scheduling cell, and
‘linked’ search space sets on a set/subset of co-scheduled cells, wherein the linked search space sets are associated with the first search space sets,
   the UE can determine PDCCH candidates according to the first search space set for the sets/subset of co-scheduled cells. Accordingly, the UE determines PDCCH candidates associated with the set/subset of co-scheduled cells by applying the corresponding n_{CI} value (set-level CIF) in the PDCCH search space equation for the first search space set. For example, when the UE is configured:
a set/subset of co-scheduled cells comprising cell indexes {#2, #4, #5, #7}, with a set-level CIF=6, and
a first search space set on a scheduling cell corresponding to the set/subset of co-scheduled cells, and
four linked search space sets (for example, with same search space set ID as the first search space set) on the four cells from the set/subset of co-scheduled cells (i.e., cells with indexes #2, #4, #5, and #7), that are linked to the first search space set,
   the UE monitors the first (or linked) search space set(s) for PDCCH candidates according to the n_{CI} value (set-level CIF=6) corresponding to the set/subset of co-scheduled cells with indexes {#2, #4, #5, #7}.

In one example, the UE monitors PDCCH according to the first/linked search space sets regardless of whether the linked search space sets are configured on the respective active DL BWPs of the set/subset of co-schedule cells. In the example above, the UE monitors the first (or linked) search set(s) for PDCCH candidates corresponding to the set/subset of co-scheduled cells {#2, #4, #5, #7} even if the linked search space sets on some cells, for example, #4 and #5 are configured on DL BWPs that are not the active DL BWPs of serving cells #4 and #5, respectively. In one example, the UE monitors PDCCH according to the first/linked search space sets even when all linked search space sets are configured on respective active DL BWPs of the cells in the set/subset of co-scheduled cells that are not the respective active DL BWPs of the cells.

In one example, the UE monitors PDCCH according to the first/linked search space sets when the linked search space sets are configured on the respective active DL BWPs of the cells in the set/subset of co-schedule cells. For example, the UE does not monitor PDCCH according to the first/linked search space set for a set/subset of co-scheduled cells when the first search space set is configured on a DL BWP that is not the active DL BWP of the scheduling cell or when at least one of the linked search space sets is configured on respective DL BWPs that are not the respective active DL BWPs of the respective cell from the set/subset of co-schedule cells. For example, the UE does not monitor PDCCH according to the first/linked search set(s) for PDCCH candidates corresponding to the set/subset of co-scheduled cells {#2, #4, #5, #7} when the corresponding linked search space set for one cell, say cell #4, is configured on respective DL BWP of cell #4, even if the corresponding linked search space sets for cells #2, #5, and #7 are configured on the respective DL BWPs.

In another example, the UE monitors a search space set on the scheduling cell for a set/subset of co-scheduled cells for which the linked search space sets are configured on the respective active DL BWPs of the set/subset of co-scheduled cells. For example, the UE can determine association of a search space set on the scheduling cell with a first set/subset of co-scheduled cells when first linked search space sets are configured on the respective active DL BWPs of the first set/subset of co-scheduled cells, and can determine association of the search space set on the scheduling cell with a second set/subset of co-scheduled cells when second linked search space sets are configured on the respective active DL BWPs of the second set/subset of co-scheduled cells. Herein, the first and second linked search spaces sets are linked to the search space set on the scheduling cell. In one example, it the UE can be provided set-level n_{CI} or CIF values corresponding to the first and second sets/subsets of co-scheduled cells, so that PDCCH candidates can be determined accordingly.

For example, when the UE is configured 4 linked search space sets (for example, with same search space set ID) on cells #2, #4, #5, and #7, that are linked to a first search space set on the scheduling cell associated with cells #2, #4, #5, and #7, the UE monitors the first (or linked) search space set(s) for PDCCH candidates according to a first set-level n_{CI} value (say, CIF=4) corresponding to co-scheduled cells {#2, #7} when the linked search space sets on cells #2 and #7 are configured on respective active DL BWPs (and the linked search space sets on cells #4 and #5 are configured on respective DL BWPs that are not active DL BWPs). For example, the UE monitors the same first (or linked) search space set(s) for PDCCH candidates according to a second set-level n_{CI} value (say, CIF=5) corresponding to co-scheduled cells {#4, #7} when the linked search space sets on cells #4 and #7 are configured on respective active DL BWPs (and the linked search space sets on cells #2 and #5 are configured on respective DL BWPs that are not active DL BWPs). Herein, it is assumed that the UE is provided set-level n_{CI} or CIF values (for example, CIF=4 or CIF=5) corresponding to the first and second sets/subsets of co-scheduled cells.

In the above examples, the configuration of the original search space set on the scheduling cell can indicate monitoring a multi-cell scheduling DCI format when the UE is configured a dedicated DCI format or a dedicated DCI format size for multi-cell scheduling, different from those for single-cell scheduling.

In another example, the UE may not be configured a dedicated DCI format (or a dedicated DCI format size) for multi-cell scheduling different from that (those) for single-cell scheduling. Accordingly, the UE can determine PDCCH candidates according to a search space set with a set-level CIF or n_{CI} value, corresponding to a set of co-scheduled cells, to monitor DCI formats that are shared with single-cell scheduling. For example, the UE decodes the PDCCH candidates with respect to an RNTI (such as, M-RNTI) that is configured for scrambling a CRC for a DCI format (for single-cell scheduling) that is re-used for multi-cell scheduling.

In yet another example, the UE may not be configured a dedicated DCI format for multi-cell scheduling nor a dedicated RNTI for multi-cell scheduling, so both the DCI format and the RNTI for multi-cell scheduling will be same as those for single-cell scheduling (for example, for multi-cell scheduling, an existing single-user DCI format such as 0_1 or 1_1 can include additional DCI fields or DCI fields with different bit-width based on multi-cell scheduling configuration). In such a case, when the UE determines linked search space set(s) corresponding to a set/subset of co-scheduled cell, (using any of the methods described throughout this disclosure such as extended search space linking or explicit configuration or predetermined rules), the UE can determine different separate PDCCH candidates for multi-cell scheduling based on the set-level n_{CI} or CIF value corresponding to the set/subset of co-scheduled cells. For example, the UE can determine first PDCCH candidates for single-cell scheduling on each of the cells from the set/subset of co-scheduled cells based on corresponding cell-level n_{CI} or CIF values, and second PDCCH candidates for multi-cell scheduling on the set/subset of co-scheduled cells based on corresponding set-level n_{CI} or CIF value.

In one example, when association of a search space set on a scheduling cell with a set of co-scheduled cells is provided by explicit indication, such as by an IE in the search space set configuration, the UE determines PDCCH candidates associated with the set/subset of co-scheduled cells by applying the corresponding n_{CI} value (set-level CIF) in the PDCCH search space equation for the search space set. The UE can be configured, by explicit configuration, one or multiple sets/subsets of co-scheduled cells associated with a same search space set.

When a UE is configured a search space set associated with multiple sets/subsets of co-scheduled cells, such as by an IE in the search space set configuration that includes first and second set-level CIF values, the UE can determine first PDCCH candidates based on a first n_{CI} value equal to the first set-level CIF value corresponding to a first set/subset of co-scheduled cells, and determine second PDCCH candidates based on a second n_{CI} value equal to the second set-level CIF value corresponding to a second set/subset of co-scheduled cells. Herein, the first and second PDCCH candidates are both according to the same search space set (for example, for determining PDCCH monitoring occasions and so on).

In one example, when association of a search space set on a scheduling cell with a set of co-scheduled cells is provided by explicit indication, such as by an IE in the search space set configuration, the UE determines the PDCCH candidates according to the indicated n_{CI} value (set-level CIF) for the corresponding set/subset of co-scheduled cells regardless of whether zero or one or multiple linked search space set(s) are configured on zero or one or multiple cells from the set/subset of co-scheduled cells, and regardless of whether or not any linked search space sets are on respective active DL BWPs of the set/subset of co-scheduled cells. In another example, the UE does not monitor PDCCH according to an indicated n_{CI} value (set-level CIF) corresponding to a set/subset of co-scheduled cells when the UE is configured one or multiple linked search space set(s) on one or multiple cells from the set/subset of co-scheduled cells, and one or more of the linked search space sets are not configured on the respective active DL BWPs of the set/subset of co-scheduled cells.

In another example, the UE applies multi-cell extension of search space linking on top of the explicit configuration of sets/subsets of co-scheduled cells associated with a search space set. For example, when association of a search space set on a scheduling cell with a set of co-scheduled cells is provided by explicit indication, such as by an IE in the search space set configuration, the UE does not monitor PDCCH according to an indicated n_{CI} value (set-level CIF) corresponding to the set/subset of co-scheduled cells when the UE is not configured one or multiple linked search space sets on one or multiple cells from the set/subset of co-scheduled cells, or when one or more of the linked search space sets configured on one or more cells from the set/subset of co-scheduled cells are configured on respective DL BWPs that are different from respective active DL BWPs.

In one example, when a UE is configured a search space set associated with multiple sets/subsets of co-scheduled cells, such as by an IE in the search space set configuration that includes multiple set-level CIF values, the UE can determine PDCCH candidates based on a reference n_{CI} value, that equals one of the multiple set-level CIF values. The UE does not determine PDCCH candidates based on other set-level CIF values indicated for the search space set. For example, the reference n_{CI} value can be equal to one of:
the smallest set-level CIF value, or
the largest CIF value, or
a CIF value that corresponds to a set of co-scheduled cells with the smallest size among the multiple sets of co-scheduled cells, or
a CIF value that corresponds to a set of co-scheduled cells with the largest size among the multiple sets of co-scheduled cells.

The UE can decode the PDCCH candidates for monitoring multi-cell scheduling DCI formats associated with the multiple set-level CIF values. For example, the UE can determine a first size for the multi-cell scheduling DCI format based on a first set-level CIF value, and a second size for the multi-cell scheduling DCI format based on a second set-level CIF value.

In one example, the UE can determine an association among search space sets and sets/subsets of co-scheduled cells implicitly based on linked search space sets configured on the active DL BWPs of the co-scheduled cells, even when the search space set is explicitly indicated one or more associated set(s) of co-scheduled cells. For example, when the UE:
is provided a search space set associated, by higher layer configuration such as by an IE in the search space configuration, with a first set-level n_{CI}/CIF value, corresponding to a first set of co-scheduled cells, and
is provided first linked search space sets on the first set of co-scheduled cells, wherein the first linked search space sets are associated with/linked to the first search space set, and
determines that second linked search space sets on second cells are configured on the respective active DL BWP of the second cells, wherein the second cells are a subset of the first set of co-scheduled cells, and the second search space sets are a subset of the first linked search space sets,
   the UE determines PDCCH candidates according to the first search space set (or according to the second linked search space sets) based on a second set-level n_{CI}/CIF value that corresponds to the second cells.

For example, when configuration of a search space set on the scheduling cell includes an association with a first set-level n_{CI}/CIF=6 corresponding to a first set of co-scheduled cells comprising cells {#2, #4, #5, #7}, and when the linked search space sets on cells #2 and #7 are configured on respective DL BWPs (and the linked search space sets on cells #4 and #5 are not configured on respective DL BWPs), the UE determines PDCCH candidates according to the search space sets (or according to the linked search space sets) based on, say, n_{CI}/CIF=4 that corresponds to the subset of co-scheduled cells {#2, #7}.

In one example, the UE can be configured to monitor PDCCH candidates according to a cell-level n_{CI}/CIF value, corresponding to a single scheduled cell, and the UE can be configured to monitor the PDCCH candidate according to DCI format(s) for multi-cell scheduling only, or according to DCI format(s) shared for both single-cell scheduling and multi-cell scheduling (such as based on RNTI or based on explicit indication/flag in the DCI). For example, the UE can be configured, by higher layer configuration of the search space set, one or multiple set-level CIF values that can be used for decoding the multi-cell scheduling DCI format(s). For example, the UE determines a first size for a MC-DCI format corresponding to a first set-level CIF value, and determines a second size for the MC-DCI format corresponding to a second set-level CIF value.

In one example, a search space set can include monitoring only one of a downlink MC-DCI format or uplink MC-DCI format, but not both. For example, a search space set such as an MSS set can include monitoring only a downlink MC-DCI format such as 1_3 and not include monitoring an uplink MC-DCI format such as 0_3. In another example, a search space set such as an MSS set can include monitoring only an uplink MC-DCI format such as 0_3 and not include monitoring an uplink MC-DCI format such as 1_3. Such design can be beneficial, for example, due to different DCI sizes and corresponding CCE AL values needed for downlink and uplink MC-DCI formats.

In one embodiment, several approaches are considered for search space set configuration and linking to sets of co-scheduled cells.

For single-cell scheduling, a UE is configured a first search space set on a scheduling cell and a second search space set on a scheduled cell, wherein the first and second search space sets are linked by having a same search space index and the second search space set includes none of the optional fields, except for nrofCandidates (regardless of their presence conditions in the SearchSpace IE). In addition, the UE applies the search space set for the scheduled cell only if the DL BWPs in which the linked search space sets are configured in the scheduling cell and the scheduled cell are both active.

In one example, for the optional fields in a linked search space set in the scheduled cell, the UE uses same values corresponding to the fields as provided in a linked (that is, the original) search space set in the scheduling cell. In another example, the UE can be provided separate values for some of the optional fields in a linked search space set in the scheduled cell that are different from values for corresponding fields in the linked search space set in the scheduling cell. For example, a PDCCH monitoring periodicity, offset, or duration can be different on the scheduled cell than on the scheduling cell.

In one example, search space linking can be based on explicit configuration of an IE that provides search space set ID(s) for linked search space set(s). For example, linked search spaces sets on the scheduling cell and scheduled cell(s) can have different search space set IDs. In one example, some IEs in linked search space sets can be different from the original search space set, such as a number of monitored PDCCH candidates, or a set of DCI formats that are monitored in the linked search space set. For example, the original search space set configured on the scheduling cell can include PDCCH monitoring according to first DCI formats, and the linked search space set configured on the scheduled cells can include PDCCH monitoring according to second DCI formats. For example, the second DCI formats can be a subset of the first DCI formats. For example, the UE can be configured to monitor DCI formats for both single-cell scheduling and multi-cell scheduling on the original search space set, and the UE can be configured to monitor DCI formats for multi-cell scheduling (and not those for single-cell scheduling) on the linked search space set.

For multi-cell scheduling, in an exemplary realization, a same search space set for multi-cell scheduling can be provided on all cells from the set of co-scheduled cells. It is also possible that a search space set for multi-cell scheduling is provided only on the scheduling cell and is not provided on any of the (other) co-scheduled cells.

In a first approach, a UE can be configured a first search space set on a corresponding scheduling cell and a number of N linked search space sets on all N cells in a set of co-scheduled cells, with a search space set configured on each of the N cells. For example, all N search space sets can have a same search space set index as the first search space set. For example, the first search space set can include all parameters and IEs for configuration of a search space set, while the N linked search space sets include none of the optional fields, except for nrofCandidates (regardless of their presence conditions in the SearchSpace IE). The first approach is beneficial, for example, for the case of MSS sets that are dedicated to multi-cell scheduling. In a variation, a UE can be configured a first search space set on a corresponding scheduling cell and a number of M linked search space sets on M cells, from a set of co-scheduled cells that includes N cells, with 1≤M<N, where a ‘linked’ search space set is configured on each of the M cells.

For example, the UE applies a linked search space set for a scheduled cell from the set of co-scheduled cells if the DL BWPs in which the linked search space sets are configured in the scheduling cell and in the scheduled cell are both active.

In another example, the UE applies the linked search space sets for the set of co-scheduled cells if the DL BWPs in which the linked search space sets are configured in the scheduling cell and in at least one cell from the set of co-scheduled cells are active. In this example, the UE can operate with a same n_{CI} value for the first search space set and all N linked search space sets, or can operate with different n_{CI} values for the first search space set and all N linked search space sets, based on the at least one cell with active DL BWP. For example, the linked search space sets for multi-cell scheduling on a set of co-scheduled cells can be associated with a first n_{CI} value corresponding to a first cell from the set of co-scheduled cells when the UE monitors a linked search space set configured on an active DL BWP of the first cell, and associated with a second n_{CI} value corresponding to a second cell from the set of co-scheduled cells when the UE monitors a linked search space set configured on an active DL BWP of the second cell.

In yet another example, the UE applies the linked search space sets for the set of co-scheduled cells if the DL BWPs in which the linked search space sets are configured in the scheduling cell and in all N cells from the set of co-scheduled cells are all active. In this example, the UE is expected to operate with a same n_{CI} value for the first search space set and all N linked search space sets.

In a special case where the scheduling cell is among the set of N co-scheduled cells, an additional search space set on the scheduling cell is not needed, as the UE is already configured with the first search space set (with full search space configuration) on the scheduling cell. Then, only (N−1) search space sets need to be configured on the remaining cells from the set of co-scheduled cells.

In one example, when a search space set is for multi-cell scheduling, a UE expects to be configured a same number of PDCCH candidates by a parameter nrofCandidates on each of the N linked search spaces sets for the set of co-scheduled cells. In another example, when a search space can be used for both single cell scheduling and multi-cell scheduling, the UE can be configured different numbers of PDCCH candidates by corresponding parameters nrofCandidates on each of the N linked search spaces sets for the set of co-scheduled cells. In one example, the UE can be configured two separate values for parameters nrofCandidates for each AL, wherein a first nrofCandidates value for an AL provides a number of PDCCH candidates for single cell scheduling for the AL, and a second nrofCandidates value for the AL provide a number of PDCCH candidates for multi-cell scheduling for the AL. In another example, when an UE is configured a search space set that is associated with two or multiple sets/subsets of co-scheduled cells, the UE can be configured, for each CCE AL value, two or multiple values for parameter nrofCandidates, such that a first value of the parameter nrofCandidates for a given AL corresponds to a first set of co-scheduled cells, and a second value of the parameter nrofCandidates for the given AL corresponds to a second set of co-scheduled cells, and so on. In a variation, the first value of the parameter nrofCandidates for the given AL corresponds to first sets of co-scheduled cells with a first size (i.e., a first number of cells), and the second value of the parameter nrofCandidates for the given AL corresponds to second sets of co-scheduled cells with a second size (i.e., a second number of cells), and so on.

In a second approach, the UE can be configured a first search space set on a scheduling cell and a second linked search space set only on a reference scheduled cell from a set of co-scheduled cells. The UE does not expect to be configured linked search space sets on other cells from the set of co-scheduled cells. Herein, a reference cell from the set of co-scheduled cells can refer to one or more of the examples described herein.

According to the second approach, the UE applies the linked search space sets for a scheduled cell only if the DL BWPs in which the linked search space sets are configured in the scheduling cell and the reference cell are both active.

In a variation of the second approach, the reference scheduled cell can be any cell from a set of co-scheduled cells. Such variation can be applicable, for example, when a UE is configured a search space set to monitor PDCCH for detection of DCI formats for both single cell scheduling and multi-cell scheduling. Then, a search space set configuration and linking can follow the existing rules for search space sets for single cell scheduling only.

In one example, the UE can be configured:
a first search space set on a first cell from a set of co-scheduled cells, wherein the UE monitors PDCCH for detection of DCI formats for both single cell scheduling on the first cell and multi-cell scheduling on the set of co-scheduled cells, and
a second search space set on a second cell from the set of co-scheduled cells, wherein the

UE monitors PDCCH for detection of DCI formats for both single cell scheduling on the second cell and multi-cell scheduling on the set of co-scheduled cells.

In one example, when a search space linking rule is based on configuration of a linked search space set (e.g., with same search space index) on only one cell from a set/subset of co-scheduled cells, and when the UE is configured a search space set for monitoring a multi-cell scheduling DCI (MC-DCI) format on a first cell, the UE determines PDCCH candidates according to the search space set for any set/subset of co-scheduled cells that include the first cell. In one example, sets/subsets of co-scheduled cells that include the first cell can be associated with different n_CI values. In another example, sets/subsets of co-scheduled cells that include the first cell can be associated with a same n_CI value.

In one realization, a reference cell for search space linking can be same as a reference cell for counting PDCCH candidates and non-overlapping CCEs or for counting DCI size budget for an MC-DCI.

In one example, for the first approach or the second approach, the linked search space sets can have fully or partially separate configurations (including for optional IEs or for search space indexes), and a linkage of the search space sets can be explicitly indicated, such as by indicating an index of a first search space set on the scheduling cell to which a second search space set on a cell from the set of co-scheduled cells is linked. According to this example, the first and the second search space sets are dedicated to multi-cell scheduling or are at least associated with DCI format(s) for multi-cell scheduling.

In a third approach, search space set linking is not used for multi-cell scheduling, and multi-cell scheduling is treated as self-cell scheduling. A UE can be configured only a first search space set on a corresponding scheduling cell and the UE does not expect any other linked search space sets on any (other) cells from the set of co-scheduled cells. Accordingly, there is no constraint on a DL BWP for any of the cells from the set of co-scheduled cells and only a DL BWP of the scheduling cell on which the first search space set is configured needs to be active. For example, the UE monitors PDCCH according to the search space set based on: (i) set-level n_{CI} or CIF values associated with any sets/subsets of co-scheduled cells corresponding to the same scheduling cell, or (i) set-level n_{CI} or CIF values associated with first sets/subsets of co-scheduled cells corresponding to the same scheduling cell that are explicitly indicated, e.g., by an IE, in the search space set configuration. For example, for scheduling on subsets of a set of cells that includes {cell #0, cell #1, cell #2, cell #3}, a UE receives information for search space sets only on one scheduling cell and CIF values of ‘00’, ‘10’, ‘01’, ‘11’ in an MC-DCI format indicate scheduling on {cell #0, cell #1}, {cell #0, cell #2}, {cell #0, cell #3} and {cell #0, cell #1, cell #2, cell #3}, respectively. In one example, a CIF value is used to indicate a subset of scheduled cells while an n_{CI} value is same for all subsets of scheduled cells so that a same PDCCH candidate can schedule on any subset of cells as indicated by the CIF value.

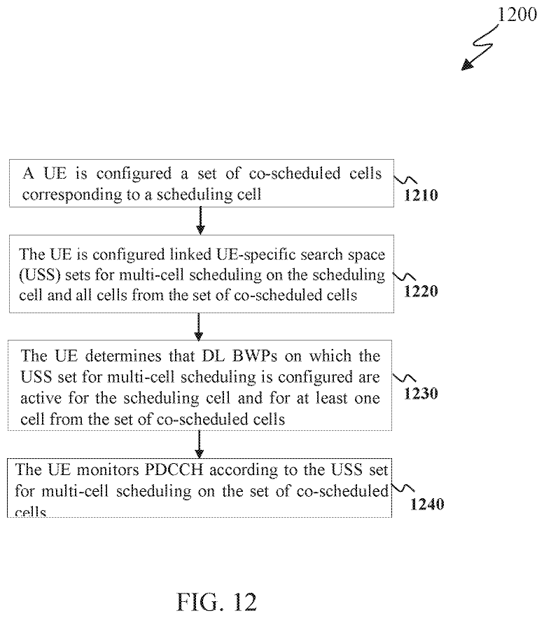

FIG. 12 illustrates an example method 1200 for search space linking for multi-cell scheduling according to embodiments of the present disclosure. The embodiment of the method 1200 for search space linking for multi-cell scheduling is for illustration only. FIG. 12 does not limit the scope of this disclosure to any particular implementation of the method 1200 for search space linking for multi-cell scheduling.

As illustrated in FIG. 12, the method 1200 begins at step 1210, where a UE (such as the UE 116) is configured a set of co-scheduled cells having a same scheduling cell. At step 1220, the UE is configured linked UE-specific search space (USS) sets for multi-cell scheduling on the scheduling cell and on all cells from the set of co-scheduled cells. At step 1230, the UE determines that DL BWPs on which the USS set for multi-cell scheduling is configured are active for the scheduling cell and for at least one cell from the set of co-scheduled cells. At step 1240, the UE monitors PDCCH according to the USS set for multi-cell scheduling on the set of co-scheduled cells.

In one embodiment, for a UE configured with one or more set(s) of co-scheduled cells, a size of a multi-cell DCI format can be set-specific (where set refers to a set of co-scheduled cells), or set-size-specific (where set size refers to a size of a set of co-scheduled cells), or search space set specific, or scheduling cell specific, or UE-specific. In addition, the UE can have a constraint/budget on a number of DCI format sizes that the UE can monitor per serving cell, per slot or across all time slots, wherein a size of a DCI format for multi-cell scheduling can be counted towards the UE constraint/budget based on a fractional count or a full count, or maybe as part of a separate UE constraint/budget for sizes of DCI formats, or maybe not counted at all.

In a first realization, a size of a multi-cell scheduling DCI format can be set-specific, that is, can be (only) based on a set of co-scheduled cells with an associated set-level CIF, provided by higher layers. For example, a first multi-cell scheduling DCI format corresponding to a first set of co-scheduled cells (with a first number of cell) can have a first size, and a second multi-cell scheduling DCI format corresponding to a second set of co-scheduled cells (with a second number of cells) can have a second size. For examples, the first and second sizes depend on the configuration (such as presence, absence, or bit-width) of DCI fields as provided for the first and second sets of co-scheduled cells, respectively. Herein, the UE determines an associated set-level CIF based on an n_{CI} value configured/determined for set of co-scheduled cell in a search space set that includes the monitoring the first DCI format, or based on a set-level CIF value that is indicated in the carrier indicator field value of the multi-cell scheduling DCI format. In one example, the UE determines a size for a first multi-cell scheduling DCI format associated with a first set of co-scheduled cells regardless of whether or not the UE is configured second multi-cell scheduling DCI format(s) within a same (or different) search space set, or whether or not the first multi-cell scheduling DCI format is configured within a same (or different) search space set but associated with a second set of co-scheduled cells.

In a second realization, a size of a multi-cell scheduling DCI format can be set-size-specific, that is, can be based on a size of a set of co-scheduled cells. For example, when first and second sets of co-scheduled cells have a same size (that is, a same number of cells), the UE expects a same size for the multi-cell scheduling DCI format for both the first and the second sets of co-scheduled cells. In one example, the same DCI format size applies when the UE monitors the multi-cell scheduling DCI format corresponding to the first and the second sets of co-scheduled cells in a same search space set. In another example, the same DCI format size applies regardless of whether or not the UE monitors the multi-cell scheduling DCI format corresponding to the first and the second sets of co-scheduled cells in a same search space set. For example, the DCI format size alignment applies across different search space sets (configured on respective DL BWPs of the respective sets of co-scheduled cells).

In one example, a same size is achieved before/without any zero padding. In another example, the UE expects zero padding a first DCI format with smaller size, so that the first DCI format has a same size as a second DCI format with originally larger size. In one example, the DCI fields are size aligned separately. In another example, zero padding is appended to the end of the DCI format with smaller size.

In a third realization, a size of a multi-cell scheduling DCI format can be search space set specific, that is, can be based on a search space set in which the UE monitors the DCI format. For example, the UE can determine a first size for a multi-cell scheduling DCI format monitored in a first search space set, and a second size for the multi-cell scheduling DCI format monitored in a second search space set. For example, the DCI format size can depend not only on higher layer configuration for DCI fields for a corresponding set of co-scheduled cells, but also on higher layer configuration for DCI fields for other sets of co-scheduled cells for which the DCI format is monitored in the same search space set. For example, when a UE determines that a search space set is associated with multiple sets of co-scheduled cells, the UE determines a same size for a multi-cell scheduling DCI format corresponding to the multiple sets of co-scheduled cells, wherein the DCI size alignment can be achieved, for example, by zero padding. For example, DCI fields can be size aligned separately, or zeros can be appended to the end of the DCI format(s) with smaller size(s) so that their size becomes equal to the largest size.

In a fourth realization, a size of a multi-cell scheduling DCI format can be scheduling cell specific, that is, can be based on a corresponding scheduling cell that receives the DCI format. For example, the UE determines a same size for a multi-cell scheduling DCI format corresponding to multiple sets of co-scheduled cells associated with a same scheduling cell. For example, the same size applies regardless of same or different size(s) of the multiple sets of co-scheduled cells, or regardless of same or different search space set(s) in which the UE monitors the multi-cell scheduling DCI format for the multiple sets of co-scheduled cells. For example, the DCI size alignment can be achieved by zero padding. For example, DCI fields can be size aligned separately, or zeros can be appended to the end of the DCI format(s) with smaller size(s) so that their size becomes equal to the largest size.

In a variation of the fourth realization, a size of a multi-cell scheduling DCI format can be BWP-specific, that is, can be based on a DL BWP of the corresponding scheduling cell that receives the DCI format.

In a fifth realization, a size of a multi-cell scheduling DCI format can be UE-specific. For example, the UE determines a same size for a multi-cell scheduling DCI format corresponding to multiple sets of co-scheduled cells associated with same or different scheduling cell(s). For example, the DCI size alignment can be achieved by zero padding. For example, DCI fields can be size aligned separately, or zeros can be appended to the end of the DCI format(s) with smaller size(s) so that their size becomes equal to the largest size.

In one example, the first, or second, or third, or fourth, or fifth realizations above can be applied to a multi-cell scheduling DCI format itself in addition to/instead of only a size of the multi-cell scheduling DCI format.

In one example, a size of a DCI format for multi-cell scheduling is fixed to a predetermined/configured value regardless of a number of cells included in a set/subset of co-scheduled cells. For example, the predetermined/configured value for the size of the DCI format for multi-cell scheduling can be based on a maximum possible/allowed number of co-scheduled cells, such as 8 cells. For example, when a size of a DCI format for multi-cell scheduling is less than the predetermined/configured value, the UE can perform zero padding at the end of the DCI format or separately for each DCI field, so that the size of the DCI format after zero-padding equals to the predetermined/configured value.

In another example, the UE can be provided a set-size threshold as well as two values for a size of a DCI format for multi-cell scheduling. Then, when a first DCI format schedules multiple PDSCH receptions or PUSCH transmission on a first set of co-scheduled cells (associated with a first set-level n_{CI} parameter for the respective search space set) that has a first size less than or equal to the set-size threshold, the first DCI format can have a size equal to the first value from the two values. When a second DCI format schedules multiple PDSCH receptions or PUSCH transmission on a second set of co-scheduled cells (associated with a second set-level n_{CI} parameter for the respective search space set) that has a second size greater than the set-size threshold, the first DCI format can have a size equal to the second value from the two values. For example, the set-size threshold can be 4 cells, and the two values for DCI format size can be 96 bits and 124 bits (excluding CRC bits). For sets of co-scheduled cells not exceeding 4 cells, a DCI format size can be 96 bits, and for sets of co-scheduled cells with 5-8 cells, a DCI format size can be 124 bits (excluding CRC bits). For example, this method can be extended to N values for a size of a multi-cell scheduling DCI format, and (N−1) set-size thresholds. For example, the values for the sizes of the multi-cell scheduling DCI format and the set-size threshold(s) can be predetermined in the specifications for system operation or can be provided by higher layer configuration.

In 5G NR Rel-17 [TS 38.213 v17.1.0], a UE expects to monitor PDCCH candidates for up to 4 sizes of DCI formats that include up to 3 sizes of DCI formats with CRC scrambled by C-RNTI per serving cell. This rule is sometimes referred to as the “3+1” rule for a UE's DCI size budget. The UE counts a number of sizes for DCI formats per serving cell based on a number of configured PDCCH candidates in respective search space sets for the corresponding active DL BWP.

There can be various options for modification of the “3+1” rule when a UE is configured one or multiple set(s) of co-scheduled cells or the UE is configured to monitor DCI format(s) for multi-cell scheduling. Herein, a size of a multi-cell scheduling DCI format can be determined based on any of the first/second/third/fourth/fifth options described above.

In a first option, the UE does not count a size of a multi-cell scheduling DCI format towards the UE's “3+1” DCI size budget.

In a second option, the UE counts a size of a multi-cell scheduling DCI format based on a fractional count or inverse scaling towards the UE's “3+1” DCI size budget for each cell from a set of co-scheduled cells. For example, a size of a DCI format for multi-cell scheduling corresponding to a set of co-scheduled cells with M cells can be counted as a fractional count, such as 1/M, towards the UE's “3+1” DCI size budget for each of the M cells. For example, the fractional count or inverse scaling can be based on a scaling factor that is predetermined in the specifications for system operation, or can be provided by higher layer configuration. When a first multi-cell scheduling DCI format corresponds to a first set S1 of co-scheduled cells with M1 cells, but the size of the first DCI format is aligned, for example by zero padding, with a size of the second multi-cell scheduling DCI format corresponding to a second set S2 of co-scheduled cells with M2 cells, in one option, the UE counts the (aligned) size of the first/second DCI formats as:
1/M1 towards the UE's “3+1” DCI size budget for each of the M1 (or M2) cells, or
1/M2 towards the UE's “3+1” DCI size budget for each of the M1 (or M2) cells, or
1/min(M1,M2) towards the UE's “3+1” DCI size budget for each of the M1 (or M2) cells, or
1/max(M1,M2) towards the UE's “3+1” DCI size budget for each of the M1 (or M2) cells, or
1/M* towards the UE's “3+1” DCI size budget for each of the M* cells, wherein M* cells comprise the union of the M1 cells and M2 cells, that is, M*=|S₁∪S₂|, or
1/\hat{M} towards the UE's “3+1” DCI size budget for each of the \hat{M} cells (or M* cells), wherein \hat{M} cells comprise the intersection of the M1 cells and M2 cells, that is, \hat{M}=|S₁∩S₂|.

In a third option, the UE counts a size of a multi-cell scheduling DCI format as a full count (that is, one size) without any scaling, towards the UE's “3+1” DCI size budget for each cell from a set of co-scheduled cells.

In a fourth option, the UE counts a size of a multi-cell scheduling DCI format as a full count (that is, one size) without any scaling, towards the UE's “3+1” DCI size budget for a reference cell from a set of co-scheduled cells. For example, a reference cell can refer to any of the examples described herein. In one example, the UE counts a size of a multi-cell scheduling DCI format as a full count (that is, one size) without any scaling, towards the UE's “3+1” DCI size budget for a first cell from the set of co-scheduled cells for which the UE does not expect to be/is not configured more than 3+1 DCI sizes for the first cell.

In one example, the UE can report a capability corresponding to one or more of the first/second/third/fourth options described above.

There can be also various alternatives for modification of the “3+1” rule itself when a UE is configured one or multiple set(s) of co-scheduled cells or the UE is configured to monitor DCI format(s) for multi-cell scheduling.

In a first alternative, the “3+1” rule is not modified.

In a second alternative, the “3+1” rule can be modified to “3+1+1” or “3+1+2”, wherein the additional ‘1’ or ‘2’ corresponds to a UE budget for monitoring 1 or 2 sizes for multi-cell scheduling DCI format(s) separate from existing DCI formats in [TS 38.212 v17.1.0].

In a third alternative, the “3+1” rule can be modified to “N+1”, wherein N>3 reflect UE's combined budget for sizes of multi-cell scheduling DCI formats or DCI formats with CRC scrambled by C-RNTI per serving cell.

In a fourth alternative, the “3+1” rule can be modified to “3+M”, wherein M>1 reflect UE's combined budget for sizes of multi-cell scheduling DCI formats or DCI formats with CRC scrambled not by C-RNTI per serving cell.

In a fifth alternative, the “3+1” rule (or any of the modified rules described in the alternatives above) can be applied per slot, rather than across all slots. Herein, a slot can be a slot of smallest SCS or largest SCS, among SCS configurations of a set of co-scheduled cells, or a slot of the scheduling cell, or a reference slot such as 15 kHz in FR1 and 60 kHz in FR2, or a slot of a primary cell, or a slot of a cell with smallest CIF/cell index, or a slot of a cell with largest CIF/cell index, and so on.

In one example, the UE can report a capability for modified UE's DCI size budget rule corresponding to one or more of the first/second/third/fourth alternatives described above. In one example, the UE can be provided, by higher layers, information about which alternative to use as a modified “3+1” rule, wherein a ‘mode’ parameter can indicate, for example, the previous four alternatives, along with any additional higher layer parameters, when applicable.

In a sixth alternative, the specifications for system operation can exclude a constraint/restriction such as the “3+1” rule on the UE's DCI size budget. For example, the UE is not subject/limited to only “3+1” DCI format as described in [TS 38.213, v17.1.0].

In one embodiment, a UE configured for multi-cell scheduling for a set of co-scheduled cells monitors a same total number of PDCCH candidates and non-overlapping CCEs for a corresponding scheduling cell as when the UE is configured for single-cell scheduling, but the UE counts a number of PDCCH candidates and non-overlapping CCEs per scheduled cell from the set of co-scheduled cells differently when the search space set is used for monitoring DCI formats for multi-cell scheduling. The UE applies modified methods such as fractional counting for PDCCH candidates and non-overlapping CCEs in case of multi-cell scheduling, but applies methods as described in TS 38.213 v16.5.0 for monitoring DCI format(s) for single-cell scheduling when counting PDCCH candidates and non-overlapping CCEs.

In a first case, when the UE monitors PDCCH candidates according to a search space set to monitor a multi-cell scheduling DCI format, the UE counts each PDCCH candidate as a fraction towards a maximum number of PDCCH candidates that the UE can monitor in a slot or a span for each scheduled cell from the set of co-scheduled cells. For example, for a set of co-scheduled cells that includes 4 cells, the UE counts a PDCCH candidate for 4-cell scheduling as ¼ of a PDCCH candidate, or as a fraction of a PDCCH candidate that is provided by higher layers, for each scheduled cell from the set of 4 cells. Similar scaling can apply to a number of non-overlapping CCEs. That allocation applies regardless of whether or not a DCI format is detected for a PDCCH candidate or regardless of whether a detected DCI format co-schedules the entire set, such as all 4 cells, or only a subset of the configured cells, such as only 2 cells from the 4 cells. Herein, the slot or span is with respect to SCS configuration of the active DL BWP of the scheduling cell.

In one example, a scaling factor for such fractional counting or inverse scaling can be based on inter-band CA vs. intra-band CA configuration. For example, the UE treats multiple co-scheduled cells (with intra-band CA configuration) in a same frequency band as a single cell. For example, for a set with 4 co-scheduled cells, wherein first 2 cells are intra-band CA in a first frequency band, and the second 2 cells are intra-band CA in a second frequency band, the UE counts the first two cells as one “effective” cell and the second two cells as another “effective” cell, so a total of two “effective” cells. Therefore, the UE counts a PDCCH candidate for such a set of co-scheduled cells as ½ (not ¼) for each cell from the set of co-scheduled cells. In another example, for a set with 4 co-scheduled cells, wherein all 4 cells are intra-band CA in a same frequency band, the UE counts the 4 cells as one “effective” cell, so a total of one “effective” cell. Therefore, the UE counts a PDCCH candidate for such a set of co-scheduled cells as 1 (not ¼) for each cell from the set of co-scheduled cells. Similar scaling can apply to a number of non-overlapping CCEs.

In one example, the UE determines scaling factor for fractional counting or inverse scaling based on an n_{CI} value (cell-level or set-level CIF) associated with the search space set. For example, when the UE determines PDCCH candidates based on a set-level CIF for the n_{CI} value associated with a search space set, the UE counts a PDCCH candidate (respectively, non-overlapping CCEs) monitored according to a multi-cell DCI format inversely with the number of cells in the set of co-scheduled cells that corresponds to the set-level CIF for the n_{CI} value. The UE can determine such a set-level n_{CI} value associated with a search space set using various explicit or implicit methods, as described herein.

Herein, a multi-cell scheduling DCI format can be a DCI format dedicated to multi-cell scheduling, such as a DCI format 0_3 or 1_3, or can be a DCI format that can be used for both single-cell scheduling and multi-cell scheduling, for example based on an explicit indication/flag in the DCI format for differentiation between single-cell and multi-cell scheduling.

In one example, the UE applies such inverse scaling or fractional counting when monitoring a MC-DCI format. In another example, the UE applies the inverse scaling when monitoring PDCCH for a DCI format shared between single-cell and multi-cell scheduling.

In another example, the UE does not apply the inverse scaling when monitoring a DCI format shared between single-cell and multi-cell scheduling; rather, the UE counts a PDCCH candidate (respectively, non-overlapping CCEs) for monitoring such a DCI format as a full count without any scaling for a reference cell and does not count for other serving/co-scheduled cells. Herein, a reference cell from the set of co-scheduled cells can refer to any of the examples described herein.

In one example, the UE does not expect to monitor DCI format(s) for single-cell scheduling only, in a search space set associated with a set-level CIF for the n_{CI} value corresponding to a set of co-scheduled cells. For example, when the UE:
is configured a search space set associated with a CORESET on a scheduling cell, wherein the search space set includes monitoring DCI formats for both single-cell scheduling and multi-cell scheduling, and
determines PDCCH candidates according to a search space set associated with a set-level n_{CI}/CIF value corresponding to a set of co-scheduled cells, the UE allocates a configured number of PDCCH candidates for the search space set to the monitor multi-cell scheduling DCI format(s), and not monitor DCI format(s) for single-cell scheduling only.

Herein, a DCI format for single cell scheduling only, refers to a DCI format that is not shared with multi-cell scheduling, such as a fallback DCI format 0_0 or 1_0.

In one example, for a search space set associated with multiple sets of co-scheduled cells, the UE can count PDCCH candidates (or non-overlapping CCEs) separately for each set of co-scheduled cells, or can count PDCCH candidates (or non-overlapping CCEs) only one time for a reference set of co-scheduled cells. For example, a counting of PDCCH candidates (or non-overlapping CCEs) can be based on fractional counting or inverse scaling of the counts towards a corresponding limit for each cell from a set of co-scheduled cells. For example, when the UE is configured or determines that a search space set is associated with a first set of co-scheduled cells with a first number of cells, and is also associated with a second set of co-scheduled cells with a second number of cells, in one option, the UE counts:
first PDCCH candidates (or non-overlapping CCEs) corresponding to the first set of co-scheduled cells with inverse scaling based on a first scaling factor, where the first scaling factor is in turn based on a size of the first set of co-scheduled cells (that is, the first number), and
second PDCCH candidates (or non-overlapping CCEs) corresponding to the second set of co-scheduled cells with inverse scaling based on a second scaling factor, where the second scaling factor is in turn based on a size of the second set of co-scheduled cells (that is, the second number).

For example, when a search space is associated with a first set with 4 co-scheduled cells, and a second set with 8 co-scheduled cells, the UE counts a first PDCCH candidate corresponding to the first set of co-scheduled cells as ¼ of a PDCCH candidate for each of the 4 cells in the first set, and counts a second PDCCH candidate corresponding to the second set of co-scheduled cells as ⅛ of a PDCCH candidate for each of the 8 cells in the second set.

This option is beneficial, for example, when the UE determines first PDCCH candidates based on a first set-level CIF value corresponding to the first set of co-scheduled cells, and determine second PDCCH candidates based on a second set-level CIF value corresponding to the second set of co-scheduled cells. This option can be beneficial, for example, when the UE determines different sizes for a multi-cell scheduling DCI format corresponding to the first and second sets of co-scheduled cells.

In one example, when a search space is associated with a set of co-scheduled cells that includes N cells, and when M cells from the set of co-scheduled cells are deactivated serving cells or have corresponding active DL BWPs that are dormant BWPs, with 1≤M<N, the UE counts a PDCCH candidate corresponding to the set of co-scheduled cells as:
1/(N−M) of a PDCCH candidate for each of the N cells; or
1/(N−M) of a PDCCH candidate for each of the other (N−M) cells with activated and non-dormant cells/BWPs, and as 0 PDCCH candidates for the M cells; or
1 PDCCH candidate for each of the N cells; or
1 PDCCH candidate for each of the other (N−M) cells with activated and non-dormant cells/BWPs, and as 0 PDCCH candidates for the M cells; or
1 PDCCH candidate only for a single reference cell, and 0 PDCCH candidates for the other cells.

Similarly, the UE counts L non-overlapping CCEs corresponding to the PDCCH candidate as:
L/(N−M) of a PDCCH candidate for each of the N cells; or
L/(N−M) of a PDCCH candidate for each of the other (N−M) cells with activated and non-dormant cells/BWPs, and as 0 PDCCH candidates for the M cells; or
L PDCCH candidate for each of the N cells; or
L PDCCH candidate for each of the other (N−M) cells with activated and non-dormant cells/BWPs, and as 0 PDCCH candidates for the M cells; or
L PDCCH candidate only for a single reference cell, and 0 PDCCH candidates for the other cells.

In one example, a UE can report a capability for which option the UE supports from the above options for BD/CCE counting in the presence of deactivated cells or dormant BWP.

For example, when the UE is configured a search space set that is associated with:
a first set of co-scheduled cells including M cells and corresponding to a first set-level CIF value such as n_{CI,1}, and
a second set of co-scheduled cells including N cells and corresponding to a second set-level CIF value such as n_{CI,2},
   the UE determines first PDCCH candidates according to the search space set based on n_{CI,1}, and second PDCCH candidates according to the search space set based on n_{CI,2}. Then, the UE counts the first PDCCH candidates based on first predetermined or configured scaling factors corresponding to the M cells in the first set of co-scheduled cells, and counts the second PDCCH candidates based on second predetermined or configured scaling factors corresponding to the N cells in the second set of co-scheduled cells. For example, the UE determines the first scaling factors to be 1/M for the M cells in the first set of co-scheduled cells and determines the second scaling factors to be 1/N for the N cells in the second set of co-scheduled cells. For example, the UE determines the first scaling factors to be 1 for a first reference cell and 0 for other cells from the M cells in the first set of co-scheduled cells and determines the second scaling factors to be 1 for a second reference cells and 0 for other cells from the N cells in the second set of co-scheduled cells. The first reference cell can be same or different from the second reference cells.

In one example, higher layers can provide the UE with a first scaling factor value α₁ for the M cells in the first set of co-scheduled cells, and second scaling factor value α₂ for the N cells in the second set of co-scheduled cells. Accordingly, the UE counts a PDCCH candidate from the first PDCCH candidates as α₁ PDCCH candidates for the M cells in the first set of co-scheduled cells, and counts a PDCCH candidate from the second PDCCH candidates as α₂ PDCCH candidates for the N cells in the second set of co-scheduled cells.

In one example, based on UE capability or higher layer configuration, the UE can count a PDCCH candidate from the first PDCCH candidates as either 1 or 2 (or 3) PDCCH candidates across the M cells in the first set of co-scheduled cells. For example, the UE counts a PDCCH candidate from the first PDCCH candidates as α₁ or 2α₁ or 3α₁ PDCCH candidates for each cell from the M cells in the first set of co-scheduled cells. For example, the UE counts a PDCCH candidate from the second PDCCH candidates as α₂ or 2α₂ or 3α₂ PDCCH candidates for each cell from the N cells in the second set of co-scheduled cells.

In one example, the UE can be configured by higher layers different values for different cells in a set of co-scheduled cells for counting PDCCH candidates. The values can be specific to a search space set or a set of co-scheduled cells or shared across different search space sets or sets of co-scheduled cells that are associated with/include a given cell.

Similar examples can be applied to non-overlapping CCEs, wherein the counting corresponds to L non-overlapping CCCEs for a PDCCH candidate with CCE AL value equal to L.

In another option, the UE counts both the first and the second PDCCH candidates towards corresponding limits of each of co-scheduled cells based on fractional counting or inverse scaling with a shared scaling factor. For example, the shared scaling factor can be a reference scaling factor. For example, the reference scaling factor can be based on a smallest size or a largest size among sizes of the multiple seats of co-scheduled cells. In the example above, the first PDCCH candidate and the second PDCCH candidate are both counted as ¼ (or both counted as ⅛) towards corresponding limits for each of the 4 cells from the first set of co-scheduled cells or each of the 8 cells from the second set of co-scheduled cells. Similar examples apply to non-overlapping CCEs.

In a variation of this option, the UE determines PDCCH candidates only based on a reference set of co-scheduled cells, and therefore, a fractional counting or inverse scaling of a count of PDCCH candidates (or non-overlapping CCEs) is based on a reference scaling factor, which is in turn based on a size of a reference set of co-scheduled cells (or based on a reference size of a set of co-scheduled cells). For example, a reference set of co-scheduled cells can be a set of co-scheduled cells with:
a smallest set-level CIF value, or
a largest set-level CIF value, or
a smallest size among the multiple sets of co-scheduled cells, or
a largest size among the multiple sets of co-scheduled cells, or
CIF value provided by higher layers.

In another example, a reference set of co-scheduled cells can be a set (with smallest/largest CIF value or set size) that includes a reference cell, wherein various examples for determining a reference cell are previously described herein.

In another example, when a UE monitors PDCCH candidates in a search space set according to a cell-level n_{CI} value that corresponds to a single scheduled cell, in a first option, the UE counts monitored PDCCH candidates (or non-overlapping CCEs) differently for single-cell scheduling DCI formats compared to MC-DCI format(s). For example, the UE counts a PDCCH candidate (or non-overlapping CCEs) as full count, without any scaling, towards to the limits for the single scheduled cell associated with the cell-level n_{CI} value when monitoring the PDCCH candidate (or non-overlapping CCEs) for decoding a SC-DCI format. For example, the UE counts a PDCCH candidate (or non-overlapping CCEs) with inverse scaling or fractional counting, when monitoring the PDCCH candidate (or non-overlapping CCEs) for decoding a MC-DCI format (dedicated). Herein, the fractional counting or inverse scaling is based on a size of a set of co-scheduled cells whose corresponding set-level CIF value is provided, such as by higher layer configuration of the search space set.

In one example, when the UE is configured:
to monitor PDCCH candidates in a search space set according to a cell-level n_{CI} value that corresponds to a single scheduled cell, and
to monitor a multi-cell scheduling DCI format in the search space set, and
multiple set-level CIF values, corresponding to multiple sets of co-scheduled cells, for decoding the multi-cell scheduling DCI format,
   the UE counts a number of PDCCH candidates (or non-overlapping CCEs) based on fractional counting or inverse scaling, wherein the scaling factor is based on a size of a reference CIF value (or size of a reference set of co-scheduled cells). For example, the reference CIF value can be:
the smallest set-level CIF value, or
the largest set-level CIF value, or
a CIF value that corresponds to a set of co-scheduled cells with the smallest size among the multiple sets of co-scheduled cells, or
a CIF value that corresponds to a set of co-scheduled cells with the largest size among the multiple sets of co-scheduled cells.

In another example, a reference CIF value can be a CIF value for a reference cell, wherein the reference cell can be based on the examples provided herein.

When a UE monitors PDCCH candidates in a search space set according to a cell-level n_{CI} value that corresponds to a single scheduled cell, in a second option, the UE counts monitored PDCCH candidates (or non-overlapping CCEs) similarly for single-cell scheduling DCI formats and MC-DCI formats. For example, the UE counts a PDCCH candidate (or non-overlapping CCEs) as full count, without any scaling, towards to the limits for the single scheduled cell associated with the cell-level n_{CI} value regardless of whether the UE monitors the PDCCH candidate (or non-overlapping CCEs) for decoding an SC-DCI format or an MC-DCI format.

In one example, the UE can count a PDCCH candidate for decoding a MC-DCI format as more than one PDCCH candidate, for example, due to a potentially larger size of the MC-DCI format. For example, the UE can count a PDCCH candidate for decoding a MC-DCI format based on a scaling factor, such as two PDCCH candidates. Similarly, the UE can count L non-overlapping CCEs for decoding according to a MC-DCI format by a scaling factor, such as 2*L non-overlapping CCEs. In another example, a scaling factor can be provided by higher layers or by the specifications for system operations. In another example, a UE can report a capability whether the UE counts a PDCCH candidate (or corresponding L non-overlapping CCEs) with or without a scaling factor. In one example, there can be different scaling factors (and corresponding different higher layer parameter, or corresponding different UE capability) for the PDCCH candidates compared to non-overlapping CCEs.

In one example, the UE applies the above example rules for fractional counting or inverse scaling when counting PDCCH candidates or non-overlapping CCEs towards per-scheduled-cells limits for the corresponding quantities. For example, the UE does not apply any fractional counting or inverse scaling when counting PDCCH candidates or non-overlapping CCEs towards per-scheduling-cell limits for the corresponding quantities. For example, the UE counts a PDCCH candidate for decoding an MC-DCI format for multi-cell scheduling as a full count (that is, one PDCCH candidate, without any inverse scaling) towards the maximum number of PDCCH candidates that the UE can monitor in a slot of the scheduling cell. Similarly, the UE counts L non-overlapping CCEs for decoding an MC-DCI format for multi-cell scheduling as a full count (that is, L non-overlapping CCEs, without any inverse scaling) towards the maximum number of non-overlapping CCEs that the UE can monitor in a slot of the scheduling cell.

In another example, similar to introducing a number of reference cells for counting MC-DCI format sizes towards a limit of DCI format sizes, a number of reference cells can be introduced for counting a number of PDCCH candidates and a number of non-overlapping CCEs for decoding MC-DCI formats. The reference cells can be same as the ones for counting MC-DCI format sizes. For example, an SCell from the set of co-scheduled cells can be associated, for example by information based on UE-specific higher layer signaling, with a MC-DCI format (DCI format 1_3) for scheduling PDSCH receptions and with a MC-DCI format (DCI format 0_3) for scheduling PUSCH transmissions. For example, a first SCell from the set of co-scheduled cells can be associated, for example by information based on UE-specific higher layer signaling, with a MC-DCI format (DCI format 1_3) for scheduling PDSCH receptions and a second SCell from the set of co-scheduled cells can be associated with a MC-DCI format (DCI format 0_3) for scheduling PUSCH transmissions.

In a second case, when the UE monitors PDCCH candidates on a search space set associated with a first scheduled cell from a configured set of co-scheduled cells, and also monitors PDCCH candidates for detection of DCI formats for single-cell scheduling associated with the first scheduled cell, UE does not consider multi-cell scheduling for allocation of PDCCH candidates. Therefore, the UE counts all PDCCH candidates associated with the search space set only towards the PDCCH monitoring allocation for the first scheduled cell.

As described herein, a search space set used for multi-cell scheduling can be:
a search space set that is associated only with MC-DCI formats, or
a search space set that is associated with both MC-DCI formats and SC-DCI formats, or
a search space set that is associated only with SC-DCI formats, wherein the SC-DCI formats can be used for or can result in multi-cell scheduling.

An SC-DCI format can also be used for scheduling a subset of a set of co-scheduled cells, for example, by using a different RNTI or a single/multi-cell scheduling flag of 1 bit, or by using multi-cell mapping, or by providing the multi-cell scheduling information in a PDSCH that is scheduled by the DCI format or in another PDCCH, as described herein.

A DCI format for single-cell scheduling can be used not only for scheduling a single cell but also for scheduling a set of co-scheduled cells, for example, by using a different RNTI or a single/multi-cell scheduling flag of 1 bit, or by using multi-cell mapping, or by providing the multi-cell scheduling information in a PDSCH that is scheduled by the DCI format or in another PDCCH, as described herein.

For counting a number of PDCCH candidates and non-overlapping CCEs for a corresponding scheduling cell, there is no impact to UE behavior due to multi-cell scheduling support. For example, multi-cell scheduling is a scheme for how to consume and allocate a PDCCH monitoring capability of a UE, unlike a multi-TRP operation that may require increasing a number of PDCCH candidates and non-overlapping CCEs monitored by a UE on a scheduling cell. Therefore, there is no change to counting of scheduled cells such as for determination of N_{cells,0}^{DL,μ} or N_{cells,1}^{DL,μ} parameters and determination of M_{PDCCH}^{total,slot,μ} or C_{PDCCH}^{total,slot,μ} limits (or corresponding limits for PDCCH monitoring per span, instead of per slot).

In another option, when a scheduled cell is configured, in addition to single-cell scheduling via self-carrier or cross-carrier scheduling, as a member of a set of co-scheduled cells, the scheduled cell can be counted more number of times towards N_{cells,0}^{DL,μ} or N_{cells,1}^{DL,μ} parameters, for the purpose of determination of M_{PDCCH}^{total,slot,μ} or C_{PDCCH}^{total,slot,μ} limits, such as:
one additional count; or
one additional count for each set of co-scheduled cells that includes the scheduled cell; or
one additional count for each search space set associated with a set of co-scheduled cells that includes the scheduled cell; or
one additional fractional count, for example 1/K or a count provided by higher layers, for each set of co-scheduled cells with K cells that includes the scheduled cell; or
one additional fractional count, for example 1/K or a count provided by higher layers, for each search space set associated with a set of co-scheduled cells with K cells that includes the scheduled cell.

It is noted that, a UE can be configured multiple separate search space sets for multi-cell scheduling on a same set of co-scheduled cells.

In one example, the UE applies a configurable scaling factor for counting a scheduled cell from a set of co-scheduled cells, in addition to or instead of the counting methods described above.

In the above example, the UE applies such additional/modified counts for parameters N_{cells,0}^{DL,μ} or N_{cells,1}^{DL,μ} when the UE determines M_{PDCCH}^{total,slot,μ}=└N_{cells}^{cap}·M_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ PDCCH candidates or C_{PDCCH}^{total,slot,μ}=└N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ non-overlapped CCEs per slot on the active DL BWP(s) of scheduling cell(s) from the N_{cells,0}^{DL,μ}+N_{cells,1}^{DL,μ} downlink cells. In one example, the UE may not be provided coresetPoolIndex on the set of co-scheduled cells.

Counting a number of PDCCH candidates and non-overlapping CCEs per scheduled cell, in case of multi-cell scheduling can depend on a scenario for multi-cell scheduling operation, as considered next.

When a search space set is associated only with MC-DCI formats for a set of co-scheduled cells (in the following, this is referred to as a multi-cell scheduling search space set), in a first approach the UE counts each PDCCH candidate or non-overlapping CCE associated with the search space set as a fraction of one PDCCH candidate or one non-overlapping CCE for each cell from the set of co-scheduled cells. The fraction can be specified in the system operation, for example as a function of the size for the set of co-scheduled cells, or can be provided by higher layers. Such approach can provide an accurate representation of a UE capability for PDCCH monitoring because it considers that the UE is monitoring fewer PDCCH candidates, compared to single-cell scheduling, for scheduling a same number of cells that can be larger than one. A sum of the fractions across all cells in the set of co-scheduled cells can equal one or can be different than one, such as greater than one.

For example, a UE can be configured separate scaling factors that the UE applies to count a PDCCH candidate or non-overlapping CCE for each cell from the set of co-scheduled cells. Alternatively, the UE can be configured a scaling factor to count PDCCH candidates or non-overlapping CCEs for all cells in the set of co-scheduled cells.

In another example, a UE determines scaling factors for counting PDCCH candidates or non-overlapping CCEs based on a number of cells in the set of co-scheduled cells. For a set of co-scheduled cells including 4 cells, the UE counts each PDCCH candidate or each non-overlapping CCE for a corresponding search space set as ¼ PDCCH candidate or ¼ non-overlapping CCE for each of the 4 co-scheduled cells.

In yet another example, when a UE monitors a search space set for multi-cell scheduling on a set of K co-scheduled cells, and the search space set includes N PDCCH candidates, the UE counts the monitored PDCCH candidates associated with the search space set in a slot/span as

$$\frac{N}{K}$$

PDCCH candidates towards a maximum number of PDCCH candidates that the UE can monitor per slot/span for each of K co-scheduled cells.

In a second approach, a UE counts each PDCCH candidate or non-overlapping CCE for a search space set associated with multi-cell scheduling as one PDCCH candidate or one non-overlapping CCE for each cell from the set of co-scheduled cells.

According to the second approach, when a UE monitors PDCCH of a search space set for multi-cell scheduling on a set of K co-scheduled cells, and the search space set includes N PDCCH candidates, the UE counts the monitored PDCCH candidates associated with the search space set in a slot/span as N PDCCH candidates towards a maximum number of PDCCH candidates that the UE can monitor per slot/span for each of K co-scheduled cells.

In the first and second approaches, the UE counts the number of PDCCH candidates and non-overlapping CCEs based on a configured set of co-scheduled cells, regardless of how many cell(s) from the set of co-scheduled cells are co-scheduled by a DCI format for multi-cell scheduling. Therefore, for a set with 4 co-scheduled cells, the UE applies the fractional allocation of ¼ PDCCH candidate or ¼ non-overlapping CCE, according to the first approach, or the full allocation of 1 PDCCH candidate or 1 non-overlapping CCE, or a value provided by higher layers for example together with the configuration of the set of co-scheduled cells, according to the second approach, per cell from the 4 configured co-scheduled cells even when the UE determines that a multi-cell scheduling DCI format schedules only 2 cells from the configured set of 4 co-scheduled cells.

In one example, when a UE monitors a PDCCH candidate according to a search space set with a first set-level CIF value for the n_{CI} parameter, and the UE decodes the PDCCH candidate according to a DCI format, and the DCI format indicates a second cell-level or set-level CIF that is different from the first set-level CIF, the UE counts the PDCCH candidate based on a fractional count with an inverse scaling, wherein the scaling factor is based on a size of a set of co-scheduled cells corresponding to the second CIF value. Similar examples apply for non-overlapping CCEs. In one option, the UE counts the fractional counting by inverse scaling towards all cells in the set of co-scheduled cells. In another option, the UE counts the fractional counting by inverse scaling towards cell(s) from the set of co-scheduled cells that correspond to the second cell-level or set-level CIF value, and does not count the PDCCH candidate towards the corresponding limits on number of PDCCH candidates for other remaining cells from the set of co-scheduled cells Similar examples apply for non-overlapping CCEs. In yet another option, the UE counts the PDCCH candidate as a full count (that is, one PDCCH candidate) for each cell that corresponds to the second cell-level or set-level CIF value, and does not count the PDCCH candidate towards the corresponding limits on number of PDCCH candidates for other remaining cells from the set of co-scheduled cells. Similar examples apply for non-overlapping CCEs.

In one example, when the UE monitors a PDCCH candidate according to a search space with an n_{CI} parameter corresponding to a set of co-scheduled cells, the UE counts the PDCCH candidate as a full count (that is, one PDCCH candidate) for each cell from the set of co-scheduled cells. Similar examples apply for non-overlapping CCEs.

In one example, the UE counts a PDCCH candidate for decoding a multi-cell scheduling DCI format as a full count (that is, one PDCCH candidate) for each cell from a corresponding set of co-scheduled cells. Similar examples apply for non-overlapping CCEs. Herein, the UE can determine the corresponding set of co-scheduled cells based on a CIF value in the DCI format, or based on an explicit indication of the set of co-scheduled cells as provided in a search space in which the PDCCH is monitors, or based on an implicit determination of the set of co-scheduled cells such as by determining the cells on which linked search space set(s) (for example, with same search space index) are configured (on the corresponding active DL BWPs).

In one example, when the UE monitors a PDCCH candidate according to a search space with an n_{CI} parameter corresponding to a set of co-scheduled cells, the UE counts the PDCCH candidate as one PDCCH candidate for a reference cell from the set of co-scheduled cells, and does not count the PDCCH candidate towards the corresponding limits on number of PDCCH candidates for other remaining cells from the set of co-scheduled cells Similar examples apply for non-overlapping CCEs. Herein, a reference cell can be based on the examples described herein.

In one example, when the UE monitors a PDCCH candidate for decoding a multi-cell scheduling DCI format, the UE counts the PDCCH candidate as one PDCCH candidate for a reference cell from the set of co-scheduled cells, and does not count the PDCCH candidate towards the corresponding limits on number of PDCCH candidates for other remaining cells from the set of co-scheduled cells. Similar examples apply for non-overlapping CCEs. Herein, a reference cell can be based on the examples described herein. Herein, the UE determines a set of co-scheduled cells corresponding to a DCI format as described earlier.

In one example, the UE can consider a set of co-scheduled cells as a virtual cell. For example, the virtual cell can be a new cell, separate from the configured set of serving cells, and associated with the same scheduling cell as the cells in the set of co-scheduled cells. For example, when the UE monitor a PDCCH candidate according to a search space set with an n_{CI} parameter corresponding to a set of co-scheduled cells, the UE counts the PDCCH candidate towards a limit on number of PDCCH candidates for the corresponding virtual cell. Similar examples apply for non-overlapping CCEs. For example, when the UE monitor a PDCCH candidate for decoding a multi-cell scheduling DCI format corresponding to a set of co-scheduled cells, the UE counts the PDCCH candidate towards a limit on number of PDCCH candidates for the corresponding virtual cell. Similar examples apply for non-overlapping CCEs. In one example, the UE counts the corresponding virtual cell towards N_{cells,0}^{DL,μ} or N_{cells,1}^{DL,μ} parameters, for the purpose of determination of M_{PDCCH}^{total,slot,μ} or C_{PDCCH}^{total,slot,μ} limits.

In one example, a new UE capability can be introduced for PDCCH monitoring when the UE is configured a set of co-scheduled cells. For example, the new capability can be in terms of a first number of single-cell scheduling and a second number of multi-cell scheduling combinations. For example, parameters M_{PDCCH}^{total,M-cell,(X,Y),μ} or C_{PDCCH}^{total,M-Cell,(X,Y),μ} can be defined, wherein X refers to a number of single-cell scheduling, and Y refers to a number/size of sets(s) of multi-cell scheduling combinations. For example, a UE capability (4,4) can correspond to 4 cells with single-cell scheduling and 4 sets of co-scheduled cells, each with 4 cells. In one example, the single-cell scheduling capability X can refer to self-scheduling. In another example, the single-cell scheduling capability X can refer to both self-scheduling and cross-carrier scheduling of a single scheduled cells. In another example, X can refer to a number of sets of co-scheduled cells, and Y can refer to a size of the sets of co-scheduled cells. For example, a UE capability (2,4) can correspond to 2 sets of co-scheduled cells, wherein each set can include 4 cells. In one example, cell counting parameters such as N_{cells,r18}^{DL,(X,Y),μ} can be defined for cell corresponding to such UE capability, for computations of UE limits on number of PDCCH candidates or non-overlapping CCEs such as parameters M_{PDCCH}^{total,M-cell,(X,Y),μ} or C_{PDCCH}^{total,M-cell,(X,Y),μ}.

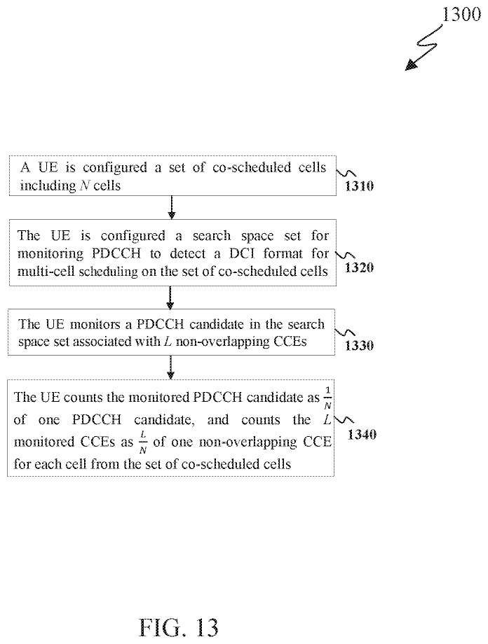

FIG. 13 illustrates an example method 1300 for counting PDCCH candidates for multi-cell scheduling operation when a search space set is associated with multi-cell scheduling DCI formats according to embodiments of the present disclosure. The embodiment of the method 1300 for counting PDCCH candidates for multi-cell scheduling operation when a search space set is associated with multi-cell scheduling DCI formats is for illustration only. FIG. 13 does not limit the scope of this disclosure to any particular implementation of the method 1300 for counting PDCCH candidates for multi-cell scheduling operation when a search space set is associated with multi-cell scheduling DCI formats.

As illustrated in FIG. 13, the method 1300 begins at step 1310, where a UE (such as the UE 116) is configured a set of co-scheduled cells that includes N cells. At step 1320, the UE is configured a search space set for monitoring PDCCHs for detection of a DCI format for multi-cell scheduling on the set of co-scheduled cells. At step 1330, the UE monitors a PDCCH candidate in the search space associated with L non-overlapping CCEs. At step 1340, the UE counts the monitored PDCCH candidate as

$$\frac{1}{N}$$

of one PDCCH candidate, and counts the L monitored CCEs as

$$\frac{L}{N}$$

of one non-overlapping CCE for each cell from the set of co-scheduled cells.

When a search space set is configured for monitoring PDCCHs for detection of both multi-cell scheduling DCI format(s) and single-cell scheduling DCI format(s), the UE counts each PDCCH candidate or non-overlapping CCE associated with the search space set as one PDCCH candidate or one non-overlapping CCE for only one scheduled cell that corresponds to the single-cell scheduling DCI formats. Therefore, MC-DCI format is counted the same way as SC-DCI format.

In one example, per UE capability report or per higher layer configuration, the UE counts MC-DCI formats differently compared to SC-DCI formats. For example, the UE counts each PDCCH candidate or non-overlapping CCE for detection of MC-DCI format as 2 or 3 PDCCH candidates or 2 or 3 non-overlapping CCEs, while the UE counts the same PDCCH candidate or non-overlapping CCE for detection of an SC-DCI format as 1 PDCCH candidate or 1 non-overlapping CCE.

When a search space set is configured for monitoring PDCCH for only single-cell scheduling DCI formats and the single-cell scheduling DCI formats can also be used for multi-cell scheduling, such as:
by using a different RNTI or a flag in the DCI format indicating single/multi-cell scheduling, or
by repurposing some of the DCI fields such as by using a multi-cell mapping, or
by scheduling a PDSCH that includes the multi-cell scheduling information, or
by pointing to a second-stage DCI format in a second PDCCH (such as by indication of a PDCCH candidate index for the second-stage DCI format),
   the UE counts PDCCH candidates and non-overlapping CCEs same as when the search space set is only for single-cell scheduling.

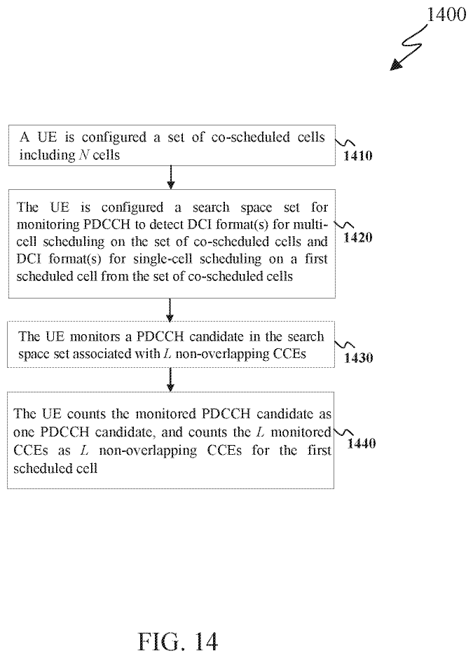

FIG. 14 illustrates an example method 1400 for counting PDCCH candidates for multi-cell scheduling operation when a search space set is configured for both single-cell scheduling and multi-cell scheduling DCI formats according to embodiments of the present disclosure. The embodiment of the method 1400 for counting PDCCH candidates for multi-cell scheduling operation when a search space set is configured for both single-cell scheduling, and multi-cell scheduling DCI formats is for illustration only. FIG. 14 does not limit the scope of this disclosure to any particular implementation of the method 1400 for counting PDCCH candidates for multi-cell scheduling operation when a search space set is configured for both single-cell scheduling and multi-cell scheduling DCI formats.

As illustrated in FIG. 14, the method 1400 begins at step 1410, where a UE (such as the UE 116) is configured a set of co-scheduled cells including N cells. At step 1420, the UE is configured a search space set for monitoring PDCCH to detect DCI format(s) for multi-cell scheduling on the set of co-scheduled cells and DCI format(s) for single-cell scheduling on a first scheduled cell from the set of co-scheduled cells. At step 1430, the UE monitors a PDCCH candidate in the search space set associated with L non-overlapping CCEs. At step 1440, the UE counts the monitored PDCCH candidate as one PDCCH candidate, and counts the L monitored CCEs as L non-overlapping CCEs for the first scheduled cell.

A UE counts the PDCCH candidates and non-overlapping CCEs for multi-cell scheduling based on slots/spans and an associated subcarrier spacing (SCS)/numerology of a scheduling cell, regardless of values of SCS of cells in the set of co-scheduled cells.

There can be a number of options for determining a DCI size for a SC-DCI format that is monitored in a search space set that is configured for monitoring MC-DCI formats, when the UE determines corresponding PDCCH candidates based on set-level n_{CI} or CIF value.

In a first option, the UE does not expect that a search space configured for monitoring MC-DCI format is also configured for monitoring SC-DCI formats. That is, the UE can monitor only SC-DCI formats or MC-DCI formats in a given search space set. Therefore, DCI size determination for the SC-DCI format is not relevant.

In a second option, when a UE is configured a search space set, such as a USS set, that includes both SC-DCI formats and MC-DCI formats, and the UE applies a set-level n_{CI} or CIF value to determine the PDCCH candidates corresponding to a set of co-scheduled cells, the UE can monitor PDCCH in such PDCCH candidates only according to MC-DCI formats (and not according to SC-DCI formats). For example, the configured number of PDCCH candidates is solely used for multi-cell scheduling, i.e., for decoding MC-DCI formats. This method can be applied to BD/CCE counting or DCI format size budget determination such as the “3+1” rule. Therefore, DCI size determination for the SC-DCI format is not relevant. It is noted that, the same search space can be used for monitoring SC-DCI formats when the UE determines PDCCH candidates according to a cell-level n_{CI} corresponding to a scheduled cell that is associated with the search space set.

In a third option, the UE is predetermined or configured to decode SC-DCI format corresponding only to one scheduled cell from the set of co-scheduled cells that is associated with the set-level n_{CI} or CIF value. For example, the one scheduled cell can be a reference cell such as a cell with smallest cell index or smallest cell-level CIF value from the set of co-scheduled cells. For example, the one scheduled cell can be configured by higher layers. The reference cell can be same for all sets of co-scheduled cells that are associated with the search space set, or the UE can identify separate reference cells for different sets of co-scheduled cells that are associated with the search space set. The UE determines the size of the SC-DCI formats based on the configuration for the one (reference/configured) scheduled cell.

In a fourth option, the UE expects a same DCI size for SC-DCI formats corresponding to different cells. For example, for a set of co-scheduled cells includes cells {1, 2, 3, 4}, the UE expects that a size of DCI format 1_1 is same for cells 1, 2, 3, and 4. Similar for other SC-DCI formats, such as 1_2, 0_1, 0_2, and so on. In a variant, the UE determines a DCI size for SC-DCI formats based on a largest DCI size among different cells in a set of co-scheduled cells. For example, zero padding is applied for a DCI format corresponding to a cell with smaller DCI size. For example, DCI format 1_1 on cell 3 is the longest, then zeros are appended to DCI format 1_1 on cells 1, 2, and 4 until they achieve a same size as DCI format 1_1 on cell 3.

In a fifth option, when a UE determines a PDCCH candidates according to a search space sets based on a set-level n_{CI} or CIF value that is associated with a set of a co-scheduled cells, the UE decodes the PDCCH candidates according to all different DCI format sizes for the SC-DCI formats configured to be monitored on the search space set. For example, the UE decodes the PDCCH candidate based on a first DCI size for DCI format 1_1 on a first cell and based on a second DCI size for DCI format 1_1 on a second cell, and so on, wherein the first cell and the second cell belong to the set of co-scheduled cells.

In one embodiment, when the following apply for a UE:
a primary cell (PCell) is a scheduling cell for a set of co-schedule cells, and
the UE is configured a first search space set on the PCell that can be used for monitoring a multi-cell scheduling DCI format for the set of co-scheduled cells, and
the UE determines a search space set overbooking event on the PCell,
   the UE can assign a higher priority to the first search space set and drop other (single-cell scheduling) USS sets before dropping the first search space set.

In one example, the set of co-scheduled cells includes the PCell.

Such operation can be beneficial, for example, when the first search space set for multi-cell scheduling is configured in a later point in time after some single-cell scheduling search space sets corresponding to some cells from the set of co-scheduled cells are already configured, and therefore the gNB is forced to assign a larger search space set index to the first search space set for multi-cell scheduling than indexes of those search space sets for single-cell scheduling. In such scenarios, the UE can assign higher priority to the first search space set for multi-cell scheduling, for example by implicit determination or by using a higher layer configured parameter, to override the smaller indexes that are configured by the gNB for the search space sets for single-cell scheduling.

In a first approach, the UE determines the higher priority for the first search space set implicitly without any gNB signaling or higher layer configuration. For example, the UE can assign a higher priority to the first search space set (multi-cell scheduling search space set) compared to any single-cell scheduling search space set, regardless of search space set indexes.

In a second approach, the UE receives higher layer configuration for a priority level parameter associated with search space sets configured on the PCell. For example, a value ‘0’ for the priority level parameter indicates low priority, and a value ‘1’ for the priority level parameter indicates high priority. In one example, the priority level parameter can take on parameters from a set {0, 1, 2, . . . , N−1}, wherein N is configured by higher layers or predetermined in the specifications of the system operation, and a search space set with higher priority is configured a larger value for the priority level parameter. In one example, the UE can be provided a large value, such as ‘1’, for the priority level parameter for a search space set for multi-cell scheduling. In another example, the UE can be provided a large value, such as ‘1’, for the priority level parameter even for a search space set for single-cell scheduling, for example for URLLC operation.

According to the second approach, the UE assigns higher priority first in descending order of the priority level parameter, and then/next/second in ascending order of search space set index. For example, the UE assigns the highest priority to a search space set with largest value of the priority level parameter and with smallest search space set index.

For example, when the UE is configured a value ‘ 1’ for the priority level parameter for the first search space set, the UE can assign a higher priority to the first search space set (multi-cell scheduling search space set) compared to any search space sets, including any single-cell scheduling search space sets, with a value ‘0’ for the priority level parameter even when the search space sets have smaller search space set indexes compared to an index of the first search space set. However, the first search space set (the multi-cell scheduling search space set) can have a lower priority compared to another multi-cell scheduling or single-cell scheduling search space set with a same value ‘1’ for the priority level parameter and with a smaller search space index.

In one example, the multi-cell scheduling search space set refers to a search space set that is configured for monitoring only the multi-cell scheduling DCI format. In another example, the multi-cell scheduling search space set refers to a search space set that is configured for monitoring both the multi-cell scheduling DCI format and a single-cell scheduling DCI format.

In one example, a priority parameter need not be present in the configuration for all search space sets. For example, the UE can be configured with first search space sets with a priority parameter value of “present” or “enabled”, and second search space sets with no configuration provided for a priority parameter. For example, the second search space sets can be search space sets for monitoring MC-DCI formats only or monitoring both MC-DCI and SC-DCI formats, while the first search space sets can be search space sets for monitoring only SC-DCI formats. For example, in case of a search space set overbooking procedure, the UE applies higher priority to search space sets for which the priority parameter value is provided.

A UE determines a search space set overbooking event based on whether or not a number of configured PDCCH candidates or non-overlapping CCEs in a slot/span exceed a predetermined limit, such as a maximum or total number of PDCCH candidates or non-overlapping CCEs that the UE is capable of monitoring per slot/span of the scheduling cell. Herein, a configured number of PDCCH candidates or non-overlapping CCEs in a slot/span is summation of corresponding number of all common search space (CSS) sets and UE-specific search space (USS) sets, including for single-cell scheduling and for multi-cell scheduling, in the slot/span. Herein, the UE determines a configured number of PDCCH candidates or non-overlapping CCEs in the slot/span corresponding to multi-cell scheduling search space sets based on the different options described herein.

In one example, a UE procedure for search space set overbooking and dropping can apply when PDCCH candidates for detection of MC-DCI formats are counted for a PCell, for example, when the PCell belongs to a set of co-scheduled cells that is associated with a search space set, or when the PCell is a scheduling cell for the set of co-scheduled cells. In another example, the UE procedure for search space set overbooking and dropping can apply (even) when PDCCH candidates for detection of MC-DCI formats are counted for a SCell, for example, when the SCell belongs to a set of co-scheduled cells that is associated with the search space set, or when the SCell is a scheduling cell for the set of co-scheduled cells. In one example, search space overbooking and dropping can apply to any/all cells in a set of co-scheduled cells. In one example, search space overbooking and dropping can apply to a single reference cell from a set of co-scheduled cells, wherein the single reference cell can be predetermined or configured by higher layers. For example, the reference cell can be a cell with smallest cell index or cell-level n_{CI} or CIF value from the set of co-scheduled cells, or a same reference cell that is used for DCI size budget determination for MC-DCI formats or is used for PDCCH candidate counting for MC-DCI formats, or for search space set configuration/linking, and so on.

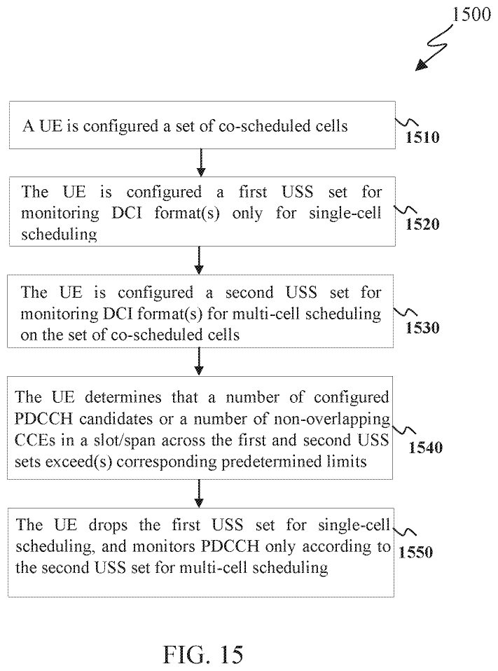

FIG. 15 illustrates an example method 1500 for search space set overbooking and dropping for multi-cell scheduling operation according to embodiments of the present disclosure. The embodiment of the method 1500 for search space set overbooking and dropping for multi-cell scheduling operation is for illustration only. FIG. 15 does not limit the scope of this disclosure to any particular implementation of the method 1500 for search space set overbooking and dropping for multi-cell scheduling operation.

As illustrated in FIG. 15, the method 1500 begins at step 1510, where a UE (such as the UE 116) is configured a set of co-scheduled cells. At step 1520, the UE is configured a first USS set for monitoring DCI format(s) only for single-cell scheduling. At step 1530, the UE is configured a second USS set for monitoring DCI format(s) only for multi-cell scheduling on the set of co-scheduled cells. At step 1540, after accounting for PDCCH candidates or non-overlapping CCEs allocated to CSS sets on a corresponding scheduling cell, the UE determines that a number of PDCCH candidates or a number of non-overlapping CCEs in a slot/span across the first and second USS sets exceeds corresponding predetermined limits. For example, the corresponding predetermined limits can be difference of a maximum number of PDCCH candidates or a maximum number of non-overlapping CCEs, respectively, that the UE is capable of from a number of PDCCH candidates or a number of non-overlapping CCEs that the UE allocated to the CSS sets on the scheduling cells. At step 1550, the UE drops the first USS set for single-cell scheduling and monitors PDCCH only according to the second USS set for multi-cell scheduling.

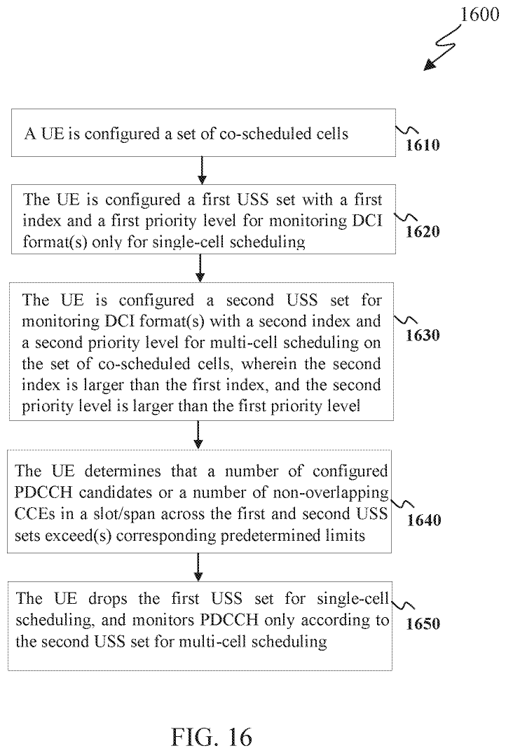

FIG. 16 illustrates an example method 1600 for search space set overbooking and dropping for multi-cell scheduling operation when a search space set is additionally configured with a priority level parameter according to embodiments of the present disclosure. The embodiment of the method 1600 for search space set overbooking and dropping for multi-cell scheduling operation when a search space set is additionally configured with a priority level parameter is for illustration only. FIG. 16 does not limit the scope of this disclosure to any particular implementation of the method 1600 for search space set overbooking and dropping for multi-cell scheduling operation when a search space set is additionally configured with a priority level parameter.

As illustrated in FIG. 16, the method 1600 begins at step 1610, where a UE (such as the UE 116) is configured a set of co-scheduled cells. At step 1620, the UE is configured a first USS set with a first index and a first priority level for monitoring DCI format(s) only for single-cell scheduling. At step 1630, the UE is configured a second USS set for monitoring DCI format(s) with a second index and a second priority level for multi-cell scheduling on the set of co-scheduled cells, wherein the second index is larger than the first index, and the second priority level is larger than the first priority level. At step 1640, after accounting for PDCCH candidates or non-overlapping CCEs allocated to CSS sets on a corresponding scheduling cell, the UE determines that a number of configured PDCCH candidates or a number of non-overlapping CCEs in a slot/span across the first and second USS sets exceed(s) corresponding predetermined limits. For example, the corresponding predetermined limits can be difference of a maximum number of PDCCH candidates or a maximum number of non-overlapping CCEs, respectively, that the UE is capable of from a number of PDCCH candidates or a number of non-overlapping CCEs that the UE allocated to the CSS sets on the scheduling cells. At step 1650, the UE drops the first USS set for single-cell scheduling, and monitors PDCCH only according to the second USS set for multi-cell scheduling.

In one example, a search space set overbooking procedure can be separate for first search space sets that are configured for monitoring MC-DCI formats, compared to second search space sets that are configured for monitoring SC-DCI formats. For example, PDCCH monitoring limits can be separate for the first and the second search space sets. For example, such behavior can depend on a separate/new UE capability for separate PDCCH candidates/CCEs for multi-cell scheduling.

In one embodiment, for a UE that is configured multi-cell scheduling for a set of co-scheduled cells, when the UE is configured to monitor PDCCH, for scheduling the set of co-scheduled cells, on a first scheduling cell and on a second scheduling cell, the UE counts/allocates PDCCH candidates and non-overlapping CCEs for multi-cell scheduling based on approaches described herein. The allocation is such that, for each cell from the set of co-scheduled cells, the UE maintains an allocation of PDCCH candidates and non-overlapping CCEs across the first and second scheduling cells similar to a corresponding allocation for single-cell scheduling. The first scheduling cell can be the PCell, and the second scheduling cell can be a special scheduling SCell, referred to as an sSCell, or the first and second scheduling cells can be any cells. In one example, the set of co-scheduled cells includes the PCell. In another example, the set of co-scheduled cells additionally includes the sSCell. Therefore, both multi-cell scheduling and DSS operation can impact PDCCH monitoring for the UE, wherein the impact of multi-cell scheduling is addressed separately from the impact of DSS operation.

In one example, configuration of one or two scheduling cells can be dependent on a monitored DCI format. For example, the UE can monitor SC-DCI formats on a first scheduling cell (for example, the PCell) and monitor MC-DCI formats on a second scheduling cell (for example, the sSCell). For example, the UE can monitor SC-DCI formats for self-scheduling on a cell, and monitor other DCI formats, such as SC-DCI formats for cross-carrier scheduling or MC-DCI formats on a different scheduling cell.

In one example, when first search space sets on the first scheduling cell for scheduling a set of co-scheduled cells and second search space sets on the second scheduling cell for scheduling the set of co-scheduled cells are configured such that first search space sets do not overlap in time with second search space sets, then the UE determines limits on the number of PDCCH candidates and non-overlapping CCEs based on existing rules, such as those in NR Rel-15/16, as described in TS 38.213 v16.5.0.

When first search space sets on the first scheduling cell for scheduling a set of co-scheduled cells and second search space sets on the second scheduling cell for scheduling the set of co-scheduled cells are configured such that first search space sets can overlap in time with second search space sets (UE monitors PDCCH in a same slot or span), then there can be different approaches for how the UE determines limits on the number of PDCCH candidates and non-overlapping CCEs.

In a first approach, for each cell from the set of co-scheduled cells, a sum of numbers of PDCCH candidates across the first and second scheduling cells and a sum of numbers of non-overlapping CCEs across the first and second scheduling cells are within predetermined respective limits for PDCCH candidates and non-overlapping CCEs. Herein, the predetermined respective limits can refer to a maximum number of PDCCH candidates and a maximum number of non-overlapping CCEs, respectively, that a UE is capable of monitoring for each scheduled cell in a reference slot/span. The reference slot can be with respect to a smallest/largest SCS, or can be a slot of the first/second scheduling cell, for example, the PCell. Similarly, the limits (maximum numbers) can be with respect to a reference SCS such as a smallest/largest SCS, or with respect to SCS of the first/second scheduling cell, for example, min(M_{PDCCH}^{max,slot,μ},M_{PDCCH}^{total,slot,μ}) PDCCH candidates or min(M_{PDCCH}^{max,slot,μ},M_{PDCCH}^{total,slot,μ}) non-overlapping CCEs, where μ is a smallest SCS. In another example, the limits (maximum numbers) can be with respect to both SCSs corresponding to the two scheduling cells, for example, α·min(M_{PDCCH}^{max,slot,μ1},M_{PDCCH}^{total,slot,μ1})+β·min(M_{PDCCH}^{max,slot,μ2},M_{PDCCH}^{total,slot,μ2}) PDCCH candidates or α·min(C_{PDCCH}^{max,slot,μ1},C_{PDCCH}^{total,slot,μ1)}+β·min(C_{PDCCH}^{max,slot,μ2},C_{PDCCH}^{total,slot,μ2}) non-overlapping CCEs, where μ1 and μ2 are the SCS of the first and second scheduling cells, respectively, and the scaling factors 0≤α≤1 and 0≤β≤1 can be provided by higher layers.

In a second approach, for each cell from the set of co-scheduled cells, a first number of PDCCH candidates and a first number of non-overlapping CCEs corresponding to the first scheduling cell is within a first scaling factor of first predetermined limits corresponding to PDCCH candidates and non-overlapping CCEs, respectively. In addition, a second number of PDCCH candidates and a second number of non-overlapping CCEs corresponding to the second scheduling cell is within a second scaling factor of second predetermined limits corresponding to PDCCH candidates and non-overlapping CCEs, respectively. For example, a sum of the first and second scaling factors can be equal to one. In another example, the first predetermined limits correspond to the first scheduling cell and the second predetermined limits correspond to the second scheduling cell, for example, α·min(M_{PDCCH}^{max,slot,μ1},M_{PDCCH}^{total,slot,μ1}) PDCCH candidates or α·min(C_{PDCCH}^{max,slot,μ1},C_{PDCCH}^{total,slot,μ1}) non-overlapping CCEs on P(S)Cell, and β·min(M_{PDCCH}^{max,slot,μ2},M_{PDCCH}^{total,slot,μ2}) PDCCH candidates or β·min(C_{PDCCH}^{max,slot,μ2},C_{PDCCH}^{total,slot,μ2}) non-overlapping CCEs on sSCell. In another example, the first predetermined limits and the second predetermined limits are same and, for example, correspond to the first scheduling cell, such as the PCell. For example, α·min(M_{PDCCH}^{max,slot,μ1},M_{PDCCH}^{total,slot,μ1}) PDCCH candidates or α·min(C_{PDCCH}^{max,slot,μ1},C_{PDCCH}^{total,slot,μ1}) non-overlapping CCEs on P(S)Cell, and (1−α)·min(M_{PDCCH}^{max,slot,μ1},M_{PDCCH}^{total,slot,μ1}) PDCCH candidates or (1−α)·min(C_{PDCCH}^{max,slot,μ1},C_{PDCCH}^{total,slot,μ1}) non-overlapping CCEs on sSCell, where μ1 and μ2 are the SCS of the PCell and sSCell, respectively, and the scaling factors 0≤α≤1 and 0≤β≤1 can be provided by higher layers.

In both the first and the second approaches, the UE counts a number of PDCCH candidates and non-overlapping CCEs in a reference slot according to search space sets with PDCCH candidates in the reference slot. For search space sets that are associated only with DCI formats for single-cell scheduling, the UE counts the PDCCH candidates and non-overlapping CCEs per existing rules, such as those in NR Rel-15/16/17, as described in TS 38.213 v17.0.0. For search space sets that are associated with DCI formats for multi-cell scheduling and with or without DCI formats for single-cell scheduling, the UE counts the PDCCH candidates and non-overlapping CCEs, for example, per rules described herein. For example, when a search space set is associated with DCI formats for both multi-cell scheduling and single-cell scheduling, the UE counts the PDCCH candidates and non-overlapping CCEs only towards the limits for a single scheduled cell that correspond to the DCI formats for single-cell scheduling. In another example, when a search space set is associated with DCI formats for only multi-cell scheduling on a set of K co-scheduled cells, the UE counts the PDCCH candidates and non-overlapping CCEs with a fractional allocation, such as 1/K or with an allocation provided by higher layers, towards the limits of PDCCH candidates and non-overlapping CCEs for each cell from the set of K co-scheduled cells.

In one realization, for a cell from the set of co-scheduled cells, such as the PCell, when a number of PDCCH candidates or non-overlapping CCEs across the first and second scheduling cells exceeds a corresponding predetermined limits, referred to as a search space set overbooking event, the UE drops search space sets with lowest priority. The search space sets can be on both scheduling cells or on only one of the two scheduling cells such as on the first scheduling cell that can also be the PCell. When search space set dropping occurs on both cells and for a search space set with a same index on both scheduling cells, a priority for search space set dropping can additionally depend on the scheduling cell index, in ascending or descending order, or can depend on a priority level parameter provided by higher layers, or can be predetermined such as PCell (or the sSCell) having lower priority. When the search space set dropping occurs on only one scheduling cell, that scheduling cell can be indicated to the UE by higher layers or be determined in the specifications of the system operation, such as the PCell (or the sSCell).

A search space set with lowest priority can be a search space set with a largest search space set index or can also depend on single-cell scheduling vs. multi-cell scheduling aspects as described herein. For example, a search space set for multi-cell scheduling can have a higher priority compared to a search space set for single-cell scheduling for resolving an overbooking event.

In one example scenario, a UE can be configured:
a first scheduled cell such as a PCell that can be scheduled by two scheduling cells, such as the PCell and an sSCell, and
a set of co-scheduled cells that is scheduled by the sSCell, such that the set of co-scheduled cells includes the first scheduled cell (PCell).

Accordingly, the UE can be configured:
CSS sets on the PCell, and
first USS sets on the PCell for self-carrier scheduling the PCell, and
second USS sets on the sSCell for cross-carrier scheduling the PCell using single-cell DCI format(s), and
third USS sets on the sSCell for multi-cell scheduling on the set of co-scheduled cells that includes the PCell.

When the CSS set and the first USS sets cannot have PDCCH candidates that are not in a/any (reference) slot with any of the second and third USS sets, the UE allocates the PDCCH candidates and the non-overlapping CCEs separately for the PCell and the sSCell per existing PDCCH monitoring rules, such as those in NR Rel-15/16.

When the CSS set and the first USS sets can have PDCCH candidates that are in a (reference) slot with some PDCCH candidates from USS set(s) from the second or third USS sets, the UE determines limits on a number of PDCCH candidates or non-overlapping CCEs that the UE is capable of monitoring for the first scheduled cell in the (reference) slot:
jointly across the two scheduling cells (PCell and sSCell), or
separately for each of the two scheduling cells (a first limit for PCell and a second limit for sSCell).

The UE can determine such limits as described above for the case that the two scheduling cells apply to all cells in the set of co-scheduled cells.

The UE counts a number of PDCCH candidates and non-overlapping CCEs for the first scheduled cells (PCell) in the (reference) slot as follows:
one count for each PDCCH candidate and corresponding non-overlapping CCEs for a CSS set from the CSS sets that overlaps the (reference) slot, and
one count for each PDCCH candidate and corresponding non-overlapping CCEs for a USS set from the first USS sets that overlaps the (reference) slot, and
one count for each PDCCH candidate and corresponding non-overlapping CCEs for a USS set from the second USS sets that overlaps the (reference) slot, and
a fractional 1/K count, or a fractional count provided by higher layers, for each PDCCH candidate and corresponding non-overlapping CCEs for a USS set from the third USS sets that overlaps the (reference) slot, where K is a number of cells in the set of co-scheduled cells.

In one example, the UE prioritizes PDCCH candidates for multi-cell scheduling over PDCCH candidates for single-cell scheduling. In another example, the UE prioritize USS sets for/with multi-cell over USS sets for single-cell. Herein, the prioritization can be based on one or more of search space set type, search space set index, a priority level configured for the DCI formats or for search space sets, and so on. In one example, such prioritization of PDCCH candidates can correspond to a search space set overbooking and dropping procedure defined for a scheduling cell, that can be a primary cell or a secondary cell. In another example, the prioritization of PDCCH candidates can refer to existing UE capability for PDCCH monitoring as considered in [TS 38.213 v17.1.0] or a new UE capability for PDCCH monitoring corresponding to multi-cell scheduling, for example defined in NR Rel-18.

In one example, for the case of two-stage DCI format for multi-cell scheduling, when the first stage and the second stage DCIs are on PDCCH and PDSCH, respectively, the first stage DCI can include a smaller payload such as only essential cell-common parameters, and the second stage DCI can have a flexible or variable (large) payload size, such as non-essential or cell-specific parameters. For example, the size of the second stage DCI can be based on higher layer configuration of cell-specific parameters.

In another example, when both the first and second stage DCIs are on PDCCHs, such as linked PDCCHs, in one option, the respective size of the first and second stage DCI formats can be arbitrary, for example, up to gNB configuration. In another example, the UE expects a fixed size of the first stage DCI, and a size of the second stage DCI can be up to the gNB configuration. For example, the size of the first stage DCI does not depend on the number of co-scheduled cells.

In one example, when the UE is configured two scheduling cells for a set of co-scheduled cells, the UE can be indicated by higher layer signaling whether search space set overbooking is enabled or disabled for a first scheduling cell or a second scheduling cell (or both or none). In one example, a default behavior can be that overbooking is enabled on PCell and disabled on a scheduling SCell. The configuration can be applied for all scheduled cells in a set of co-scheduled cells, or can be applied only to some cells from the set of co-scheduled cells, such as the PCell. The UE can be indicated by higher layer signaling information of scheduled cells for which the UE applies the UE procedures for search space overbooking and dropping.

In one example, scaling factors for distribution of PDCCH monitoring limits among two scheduling cells, such as the parameters 0≤α≤1 or 0≤β≤1 described above, can be provided separately for two different sets of co-scheduled cells or for different cells within a set of co-scheduled cells or for different cells across different sets of co-scheduled cells. In another example, same scaling factors apply in such cases.

In one example, the UE expects a same DCI size for MC-DCI formats monitored on two different scheduling cells. Therefore, the UE applies zero padding to the MC-DCI format with smaller size on a first scheduling cell, so that it achieves a same DCI size as a corresponding MC-DCI format with larger size on a second scheduling cell.

In one example, the UE can be indicated that one of the two scheduling cells (e.g., the second scheduling cell that is an SCell) for a set of co-scheduled cells is a deactivated cell or an active DL BWP for the second scheduling cell is a dormant BWP. In such case, for a UE with corresponding UE capability, the UE determines the PDCCH monitoring limits by disabling the scaling parameters 0≤α≤1 or 0≤β≤1 as described above, so that for example the UE applies α=0 for determination of the PDCCH monitoring limits.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving:
first information for a number of sets of cells, and
second information for a first user equipment (UE)-specific search space (USS) set for receptions of first physical downlink control channel (PDCCH) candidates on a scheduling cell, wherein the first USS set:
has a first USS set identity, and
is associated with a first downlink control information (DCI) format for scheduling on more than one cell; and
determining:
a first set of cells, from the number of sets of cells, that is associated with the first USS set, and
a first reference cell from the first set of cells, wherein:
a first size of the first DCI format:
is counted in a number of sizes of DCI formats for scheduling on the first reference cell, and
is not counted in a number of sizes of DCI formats for scheduling on cells, other than the first reference cell, from the first set of cells, and
the first reference cell is the scheduling cell, when:
the scheduling cell is included in the first set of cells, and
the first USS set is the only USS set with the first USS identity among USS sets on cells in the first set of cells.

2. The method of claim 1, wherein:
a number of the first PDCCH candidates and a corresponding number of first non-overlapping control channel elements (CCEs) for the first USS set:
are counted in a number of PDCCH candidates and a corresponding number of non-overlapping CCEs, respectively, for the first reference cell, and
are not counted in a number of PDCCH candidates and a corresponding number of non-overlapping CCEs, respectively, for cells, other than the first reference cell, from the first set of cells.

3. The method of claim 1, further comprising:
receiving third information for a second USS set on a cell in a set of cells, wherein the second USS set has the first USS set identity; and
determining:
the first set of cells to be the set of cells, and
the first reference cell to be the cell.

4. The method of claim 1, further comprising:
receiving:
third information for a second USS set for receptions of second PDCCH candidates on the first reference cell, wherein the second USS set is associated with a second DCI format for scheduling only on the first reference cell,
fourth information for a first indicator value corresponding to the first set of cells, and
fifth information for a second indicator value corresponding to the first reference cell; and
determining:
first control channel elements (CCEs) for receptions of the first PDCCH candidates based on the first USS set and the first indicator value, and
second CCEs for receptions of second PDCCH candidates based on the second USS set and the second indicator value.

5. The method of claim 1, further comprising:
receiving third information for a second USS set for receptions of second PDCCH candidates on the scheduling cell, wherein the second USS set is associated with a second DCI format for scheduling on more than one cell, wherein:
the second USS set is associated with the first set of cells,
the first DCI format is for scheduling receptions of physical downlink shared channels (PDSCHs) on first cells from the first set of cells, and
the second DCI format is for scheduling transmissions of physical uplink shared channels (PUSCHs) on second cells from the first set of cells.

6. The method of claim 1, further comprising:
receiving:
third information for a second USS set for receptions of second PDCCH candidates on the scheduling cell, wherein the second USS set is associated with a second DCI format for scheduling on more than one cells;
fourth information for a first indicator value corresponding to the first set of cells, and
fifth information for a second indicator value corresponding to a second set of cells from the number of sets of cells, wherein the second set of cells is different from the first set of cells; and
determining:
the second USS set to be associated with the second set of cells,
first control channel elements (CCEs) for receptions of the first PDCCH candidates based on the first USS set and the first indicator value, and
second CCEs for receptions of the second PDCCH candidates based on the second USS set and the second indicator value.

7. The method of claim 6, further comprising:
determining a second reference cell, from the second set of cells, wherein a second size of the second DCI format, a number of the second PDCCH candidates, and a corresponding number of second non-overlapping CCEs for the second USS set:
are counted in a number of sizes of DCI formats for scheduling on, a number of PDCCH candidates, and a corresponding number of non-overlapping CCEs, respectively, for the second reference cell, and
are not counted in a number of sizes of DCI formats for scheduling on, a number of PDCCH candidates, and a corresponding number of non-overlapping CCEs, respectively, for cells, other than the second reference cell, from the second set of cells.

8. A user equipment (UE) comprising:
a transceiver configured to receive:
first information for a number of sets of cells, and
second information for a first UE-specific search space (USS) set for receptions of first physical downlink control channel (PDCCH) candidates on a scheduling cell, wherein the first USS set:
has a first USS set identity, and
is associated with a first downlink control information (DCI) format for scheduling on more than one cell; and
a processor operably connected to the transceiver, the processor configured to determine:
a first set of cells, from the number of sets of cells, that is associated with the first USS set, and
a first reference cell from the first set of cells, wherein:
a first size of the first DCI format:
is counted in a number of sizes of DCI formats for scheduling on the first reference cell, and
is not counted in a number of sizes of DCI formats for scheduling on cells, other than the first reference cell, from the first set of cells, and
the first reference cell is the scheduling cell, when:
the scheduling cell is included in the first set of cells, and
the first USS set is the only USS set with the first USS identity among USS sets on cells in the first set of cells.

9. The UE of claim 8, wherein:
a number of the first PDCCH candidates and a corresponding number of first non-overlapping control channel elements (CCEs) for the first USS set:
are counted in a number of PDCCH candidates and a corresponding number of non-overlapping CCEs, respectively, for the first reference cell, and
are not counted in a number of PDCCH candidates and a corresponding number of non-overlapping CCEs, respectively, for cells, other than the first reference cell, from the first set of cells.

10. The UE of claim 8, wherein:
the transceiver is further configured to receive third information for a second USS set on a cell in a set of cells, wherein the second USS set has the first USS set identity; and
the processor is further configured to determine:
the first set of cells to be the set of cells, and
the first reference cell to be the cell.

11. The UE of claim 8, wherein:
the transceiver is further configured to receive:
third information for a second USS set for receptions of second PDCCH candidates on the first reference cell, wherein the second USS set is associated with a second DCI format for scheduling only on the first reference cell,
fourth information for a first indicator value corresponding to the first set of cells, and
fifth information for a second indicator value corresponding to the first reference cell; and
the processor is further configured to determine:
first control channel elements (CCEs) for receptions of the first PDCCH candidates based on the first USS set and the first indicator value, and
second CCEs for receptions of second PDCCH candidates based on the second USS set and the second indicator value.

12. The UE of claim 8, wherein:
the transceiver is further configured to receive third information for a second USS set for receptions of second PDCCH candidates on the scheduling cell,
the second USS set is associated with a second DCI format for scheduling on more than one cell,
the second USS set is associated with the first set of cells,
the first DCI format is for scheduling receptions of physical downlink shared channels (PDSCHs) on first cells from the first set of cells, and
the second DCI format is for scheduling transmissions of physical uplink shared channels (PUSCHs) on second cells from the first set of cells.

13. The UE of claim 8, wherein:
the transceiver is further configured to receive:
third information for a second USS set for receptions of second PDCCH candidates on the scheduling cell, wherein the second USS set is associated with a second DCI format for scheduling on more than one cells;
fourth information for a first indicator value corresponding to the first set of cells, and
fifth information for a second indicator value corresponding to a second set of cells from the number of sets of cells, wherein the second set of cells is different from the first set of cells; and
the processor is further configured to determine:
the second USS set to be associated with the second set of cells,
first control channel elements (CCEs) for receptions of the first PDCCH candidates based on the first USS set and the first indicator value, and
second CCEs for receptions of the second PDCCH candidates based on the second USS set and the second indicator value.

14. The UE of claim 13, wherein:
the processor is further configured to determine a second reference cell, from the second set of cells, a second size of the second DCI format, a number of the second PDCCH candidates, and a corresponding number of second non-overlapping CCEs for the second USS set:
are counted in a number of sizes of DCI formats for scheduling on, a number of PDCCH candidates, and a corresponding number of non-overlapping CCEs, respectively, for the second reference cell, and
are not counted in a number of sizes of DCI formats for scheduling on, a number of PDCCH candidates, and a corresponding number of non-overlapping CCEs, respectively, for cells, other than the second reference cell, from the second set of cells.

15. A base station comprising:
a transceiver configured to transmit:
first information for a number of sets of cells, and
second information for a first user equipment (UE)-specific search space (USS) set for transmissions of first physical downlink control channels (PDCCHs) on a scheduling cell, wherein the first USS set:
has a first USS set identity, and
is associated with a first downlink control information (DCI) format for scheduling on more than one cell; and
a processor operably connected to the transceiver, the processor configured to determine:
a first set of cells, from the number of sets of cells, that is associated with the first USS set, and
a reference cell from the first set of cells, wherein:
a size of the first DCI format:
is counted in a number of sizes of DCI formats for scheduling on the reference cell, and
is not counted in a number of sizes of DCI formats for scheduling on cells, other than the reference cell, from the first set of cells, and
the reference cell is the scheduling cell, when:
the scheduling cell is included in the first set of cells, and
the first USS set is the only USS set with the first USS identity among USS sets on cells in the first set of cells.

16. The base station of claim 15, wherein:
the first USS set is associated with a number of the first PDCCHs and a corresponding number of first non-overlapping control channel elements (CCEs), and
the number of the first PDCCHs and the corresponding number of the first non-overlapping CCEs:
are counted in a number of PDCCHs and a corresponding number of non-overlapping CCEs, respectively, for the reference cell, and
are not counted in a number of PDCCHs and a corresponding number of non-overlapping CCEs, respectively, for cells, other than the reference cell, from the first set of cells.

17. The base station of claim 15, wherein:
the transceiver is further configured to transmit third information for a second USS set on a cell in a set of cells, wherein the second USS set has the first USS set identity; and
the processor is further configured to determine:
the first set of cells to be the set of cells, and
the reference cell to be the cell.

18. The base station of claim 15, wherein:
the transceiver is further configured to transmit:
third information for a second USS set for transmissions of second PDCCHs on the reference cell, wherein the second USS set is associated with a second DCI format for scheduling only on the reference cell,
fourth information for a first indicator value corresponding to the first set of cells, and
fifth information for a second indicator value corresponding to the reference cell; and
the processor is further configured to determine:
first CCEs for transmissions of the first PDCCHs based on the first USS set and the first indicator value, and
second CCEs for transmissions of second PDCCHs based on the second USS set and the second indicator value.

19. The base station of claim 15, wherein:
the transceiver is further configured to transmit third information for a second USS set for transmissions of second PDCCHs on the scheduling cell,
the second USS set is associated with a second DCI format for scheduling on more than one cell,
the second USS set is associated with the first set of cells,
the first DCI format is for scheduling transmissions of physical downlink shared channels (PDSCHs) on first cells from the first set of cells, and
the second DCI format is for scheduling receptions of physical uplink shared channels (PUSCHs) on second cells from the first set of cells.

20. The base station of claim 15, wherein:
the transceiver is further configured to transmit:
third information for a second USS set for transmissions of second PDCCHs on the scheduling cell, wherein the second USS set is associated with a second DCI format for scheduling on more than one cells;
fourth information for a first indicator value corresponding to the first set of cells, and
fifth information for a second indicator value corresponding to a second set of cells from the number of sets of cells, wherein the second set of cells is different from the first set of cells; and
the processor is further configured to determine:
the second USS set to be associated with the second set of cells,
first CCEs for transmissions of the first PDCCHs based on the first USS set and the first indicator value, and
second CCEs for transmissions of the second PDCCHs based on the second USS set and the second indicator value.
